(19) United States
(12) Patent Application Publication
(10) Pub. No.: US 2008/0285133 A1
(43) Pub. Date: Nov. 20, 2008

(54) Antireflection Film, Production Method Thereof, Polarizing Plate Using the Antireflection Film and Image Display Device Using the Antireflection Film or Polarizing Plate

(75) Inventors: Hiroyuki Yoneyama, Kanagawa (JP); Yasuhiro Okamoto, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/886,258

(22) PCT Filed: Mar. 13, 2006
(86) PCT No.: PCT/JP2006/305329

§ 371 Date: Sep. 13, 2007

(30) Foreign Application Priority Data
Mar. 14, 2005 (JP) 2005-071301

(51) Int. Cl. G02B 1/11; B05D 5/06

(52) U.S. Cl. 359/580; 427/457

(57) ABSTRACT

An antireflection film comprises: a support; and at least one low refractive index layer including a first low refractive index layer, the first low refractive index layer being located most distant from the support, wherein the first low refractive index layer comprises: a resin curable upon irradiation with ionizing radiation; and a compound having a polysiloxane partial structure, and wherein the ratio Si₍ₐ₎/Si_{(b)} of a photoelectron spectral intensity {Si₍ₐ₎} of silicon atom on the outermost surface of the first low refractive index layer to a photoelectron spectral intensity {Si_{(b)}} of silicon atom in a deeper position at a depth corresponding to 80% of a thickness of the first low refractive index layer from the outermost surface is 5.0 or more.

### TECHNICAL FIELD

The present invention relates to an antireflection film, a production method thereof, a polarizing plate using the antireflection film, and an image display device using the antireflection film or polarizing plate.

### BACKGROUND ART

In an image display device such as cathode ray tube display device (CRT), plasma display panel (PDP) and liquid crystal display device (LCD), an antireflection film is disposed on the outermost surface of the display so as to reduce the reflectance by utilizing the principle of optical interference and thereby prevent reduction in the contrast due to reflection of outside light or projection of an image.

In the antireflection film, the refractive index of the low refractive index layer must be sufficiently reduced to decrease the reflectance. As for the material of reducing the refractive index, the inorganic material includes magnesium fluoride and calcium fluoride, and the organic material includes a fluorine-containing compound having a large fluorine content. However, these fluorine compounds have no cohesive force and therefor, the scratch resistance is insufficient as the film disposed on the outermost surface of a display.

Also, since the film is disposed on the outermost surface, it is indispensable to impart an antifouling property, but a sufficiently high antifouling property can be hardly obtained only by the technique of a so-called fluorine-containing sol/gel type binder disclosed in JP-A-2002-265866 and JP-A-2002-317152.

In JP-A-2003-329804, a compound having a polysiloxane partial structure is added so as to enhance the antifouling property, but this technique has a problem that when the kind of the binder is changed or an inorganic fine particle is used in combination, a surface state failure such as repelling occurs or the silicone compound is transferred from the coating film to cause contamination in the production process.

Furthermore, JP-A-2002-277604 or Hansha Boshi Maku Tokusei to Saiteki Sekkei-Maku Sakusei Gijutsu (Characteristics of Antireflection Film and Optimal Design-Film Production Technique) discloses to form an antifouling layer on the low refractive index layer and thereby impart an antifouling property. However, this technique has a problem that the fluoroalkyl group-containing organosilane-based compound described in these publications requires a difficulty handleable fluorine-based solvent for dissolving the compound at the preparation of a coating solution or readily causes a coating failure. In addition, the production load increases for newly forming an antifouling layer and the productivity decreases.

As described above, for satisfying reduction of reflectance, satisfactory scratch resistance and antifouling property all at the same time, a so-called low surface free energy compound having a low refractive index, excellent strength and resistance against surface fouling is necessary. However, in many cases, these properties are in the trade-off relationship that when one is improved, the other is worsened. Thus, it has been difficult to satisfy scratch resistance and antifouling property as well as reduction of reflectance.

On the other hand, in the production of the low refractive index layer of an antireflection film, a method of coating and then curing a crosslinking compound is widely employed so as to enhance the strength of the coating film, and many heat-curable or ionizing radiation-curable materials have been proposed.

In the heat curing system, a high temperature is necessary for obtaining sufficiently high strength, but when the support is formed of a resin composition, the temperature can be elevated only to a temperature of not causing deterioration of the support and satisfactory strength cannot be obtained. Furthermore, in such a temperature range, the curing reaction must be allowed to proceed over time and there is a problem in the productivity. In comparison therewith, the photocuring system is known to require a short polymerization reaction time and expected to enable enhancing the productivity.

### DISCLOSURE OF THE INVENTION

An object of the present invention is to provide an antireflection film producible at high productivity and inexpensively and assured of satisfactory antireflection performance and scratch resistance as well as antifouling property.

Another object of the present invention is to provide a method for producing an antireflection film satisfying the above-described performances. Still another object of the present invention is to provide a polarizing plate and an image display device each using this excellent antireflection film.

According to the present invention, an antireflection film, a production method thereof, a polarizing plate and an image display device having the following constitutions are provided, whereby the above-described objects can be attained.

(1) An antireflection film comprising: a support; and at least one low refractive index layer including a first low refractive index layer, the first low refractive index layer being located most distant from the support, wherein the first low refractive index layer comprises: a resin curable upon irradiation with ionizing radiation; and a compound having a polysiloxane partial structure, and wherein the ratio Si₍ₐ₎/Si_{(b)} of a photoelectron spectral intensity {Si₍ₐ₎} of silicon atom on the outermost surface of the first low refractive index layer to a photoelectron spectral intensity {Si_{(b)}} of silicon atom in a deeper position at a depth corresponding to 80% of a thickness of the first low refractive index layer from the outermost surface is 5.0 or more.

(2) The antireflection film as described in (1) above, wherein the compound having a polysiloxane partial structure is represented by formula (1):

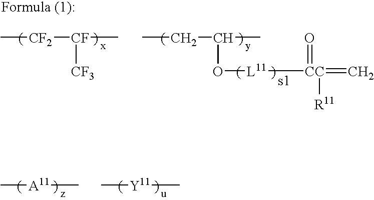

{wherein L¹¹ represents a linking group having a carbon number of 1 to 10, s1 represents 0 or 1, R¹¹ represents a hydrogen atom or a methyl group, A¹¹ represents a repeating unit having a hydroxyl group in the side chain, Y¹¹ represents a constituent component containing a poly-siloxane partial structure in the main chain, x, y and z each represents mol % of respective repeating units based on all repeating units excluding Y¹¹ and each represents a value satisfying 30≦x≦60, 0≦y≦70 and 0≦z≦50, provided that x+y+z=100 (mol %), and u represents mass % of the constituent component Y¹¹ in the copolymer and satisfies 0.01≦u≦20}.

(3) The antireflection film as described in (1) above, wherein the compound having a polysiloxane partial structure is represented by formula (2):

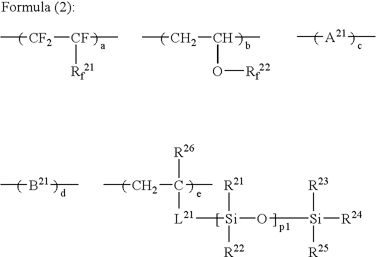

{wherein R_{f}²¹ represents a perfluoroalkyl group having a carbon number of 1 to 5, R_{f}²² represents a fluorine-containing alkyl group having a linear, branched or alicyclic structure having a carbon number of 1 to 30, which may have an ether bond, A²¹ represents a constituent unit having a reactive group capable of participating in a crosslinking reaction, B²¹ represents an arbitrary constituent component, R²¹ and R²², which may be the same or different, each represents an alkyl group or an aryl group, p1 represents an integer of 10 to 500, R²³ to R²⁵ each independently represents a substituted or unsubstituted monovalent organic group or a hydrogen atom, R²⁶ represents a hydrogen atom or a methyl group, L²¹ represents an arbitrary linking group having a carbon number of 1 to 20 or a singe bond, a to d each represents a molar fraction (%) of respective constituent components excluding the polymerization unit containing a polysiloxane and each represents a value satisfying 10≦a+b≦55, 10≦a≦55, 0≦b≦45, 10≦c≦50 and 0≦d≦40, and e represents a mass fraction (%) of the polymerization unit containing a polysiloxane based on the entire mass of other components and satisfies the relationship of 0.01≦e≦20}.

(4) The antireflection film as described in any one of (1) to (3) above, which has a surface free energy on the outermost surface of 25 mN/m or less.

(5) The antireflection film as described in (1) above, further comprising: at least one layer lower than the first low refractive index layer, wherein at least one of said at least one layer lower and the first low refractive index layer comprises at least one of a hydrolysate of an organosilane represented by formula (3) and a partial condensate thereof, the organosilane being produced in the presence of at least one of an acid catalyst and a metal chelate compound:

(R³⁰)ₘ₁Si(X³¹)₄₋ₘ₁ Formula (3)

(wherein R³⁰ represents a substituted or unsubstituted alkyl group or a substituted or unsubstituted aryl group, X³¹ represents a hydroxyl group or a hydrolyzable group, and m1 represents an integer of 1 to 3).

(6) The antireflection film as described in (1) or (5) above, wherein at least one of said at least low refractive index layer comprises an inorganic fine particle having a refractive index of 1.15 to 1.40.

(7) The antireflection film as described in (1) above, wherein at least one of said at least low refractive index layer comprises a photopolymerization initiator having a molecular weight of 250 or more.

(8) The antireflection film as described in (1) above, further comprising at least one thin film layer between the first low refractive index layer and the support, wherein the thin film layer comprises a surface state improving agent.

(9) A method for producing an antireflection film comprising a support and at least one low refractive index layer including a first low refractive index layer, the first low refractive index layer being located most distant from the support, wherein the method comprises: coating a coating composition for the first low refractive index layer comprising a resin curable upon irradiation with ionizing radiation and a compound having a polysiloxane partial structure or a fluoroalkyl group on a support directly or via at least one layer; and curing the composition by combining irradiation of ionizing radiation and a heat treatment before, simultaneous with or after the irradiation so that the ratio Si₍ₐ₎/Si_{(b)} of a photoelectron spectral intensity {Si₍ₐ₎} of silicon atom on the outermost surface of the first low refractive index layer of the antireflection film to a photoelectron spectral intensity {Si_{(b)}} of silicon atom in a deeper portion at a depth corresponding to 80% of a thickness of the first low refractive index layer from the outermost surface can be 5.0 or more.

(10) A polarizing plate comprising, on at least one side thereof, the antireflection film described in any one of (1) to (8) above or the antireflection film obtained by the production method of an antireflection film described in (9) above.

(11) An image display device having disposed therein the antireflection film described in any one of (1) to (8), the antireflection film obtained by the production method of an antireflection film described in (9), or the polarizing plate described in (10).

### BEST MODE FOR CARRYING OUT THE INVENTION

The present invention is described in detail below. Incidentally, the term “from (numerical value 1) to (numerical value 2)” as used in the present invention for expressing a physical value, a characteristic value or the like means “(numerical value 1) or more and (numerical value 2) or less”. Also, the term “(meth)acrylate” as used in the present invention means “at least either acrylate or methacrylate”. The same applies to “(meth)acrylic acid” and the like.

### <Antireflection Film>

### [Low Refractive Index Layer]

The low refractive index layer of the antireflection film of the present invention is described below.

In the present invention, the refractive index of the low refractive index layer is preferably from 1.28 to 1.48, more preferably from 1.34 to 1.44. Furthermore, in view of reducing the reflectance, the low refractive index layer preferably satisfies the following mathematical formula (1):

(m₁λ/4)×0.7<n₁d₁<(m₁λ/4)×1.3 Mathematical formula (1)

wherein m₁ is a positive odd number, n₁ is a refractive index of the low refractive index layer, d₁ is a film thickness (nm) of the low refractive index layer, and λ is a wavelength and is a value in the range from 500 to 550 nm.

When mathematical formula (1) is satisfied, this means that ml (a positive odd number; usually 1) satisfying mathematical formula (1) is present in the above-described wavelength range.

### [Ionizing Radiation-Curable Resin]

In the low refractive index layer of the present invention, a resin curable upon irradiation with ionizing radiation is used. As for such an ionizing radiation-curable resin, a fluorine-containing polymer or a fluorine-containing sol/gel material, where the resin itself has a low refractive index, is preferably used. The fluorine-containing polymer or fluorine-containing sol/gel material is crosslinked by the effect of ionizing radiation and if desired, heat. The surface of the low refractive index layer formed preferably has a dynamic friction coefficient of 0.03 to 0.15 and a contact angle with water of 90 to 120°. A low molecular compound having a polyfunctional reactive group curable upon irradiation with ionizing radiation may also be used.

Examples of the fluorine-containing polymer or fluorine-containing sol/gel material for use in the low refractive index layer include a hydrolysate and a dehydration-condensate of perfluoroalkyl group-containing silane compound {e.g., (heptadecafluoro-1,1,2,2-tetrahydrodecyl)triethoxysilane}, and also include a fluorine-containing copolymer having, as constituent components, a fluorine-containing monomer unit and a constituent unit for imparting crosslinking reactivity.

Specific examples of the fluorine-containing monomer unit include fluoroolefins (e.g., fluoroethylene, vinylidene fluoride, tetrafluoroethylene, hexafluoropropylene, perfluoro-2,2-dimethyl-1,3-dioxol), partially or completely fluorinated alkyl ester derivatives of (meth)acrylic acid [e.g., “BISCOTE 6FM” {produced by Osaka Organic Chemical Industry Ltd.}, “M-2020” {produced by Daikin Industries, Ltd.}], and completely or partially fluorinated vinyl ethers. Among these, perfluoroolefins are preferred and in view of refractive index, solubility, transparency, easy availability and the like, hexafluoropropylene is more preferred.

Main examples of the constituent unit for imparting crosslinking reactivity include the following units (A), (B) and (C):

(A): a constituent unit obtained by the polymerization of a monomer previously having a self-crosslinking functional group within the molecule, such as glycidyl (meth)acrylate and glycidyl vinyl ether;

(B): a constituent unit obtained by the polymerization of a monomer having a carboxyl group, a hydroxy group, an amino group, a sulfo group or the like {such as (meth)acrylic acid, methylol(meth)acrylate, hydroxyalkyl(meth)acrylate, allyl acrylate, hydroxyethyl vinyl ether, hydroxybutyl vinyl ether, maleic acid and crotonic acid}; and

(C): a constituent unit obtained by reacting a compound having a group capable of reacting with the functional group of (A) or (B) and another crosslinking functional group within the molecule and the constituent unit of (A) or (B) (such as constituent unit which can be synthesized, for example, by causing an acrylic acid chloride to act on a hydroxy group).

Particularly, in the present invention, the crosslinking functional group of the constituent unit (C) is preferably a photopolymerizable group.

Examples of the photopolymerizable group include a (meth)acryloyl group, an alkenyl group, a cinnamoyl group, a cinnamylideneacetyl group, a benzalacetophenone group, a styrylpyridine group, an α-phenylmaleimide group, a phenylazide group, a sulfonylazide group, a carbonylazide group, a diazo group, an o-quinonediazido group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group and an azadioxabicyclo group. Not only one of these groups but also two or more thereof may be contained. Among these, a (meth)acryloyl group and a cinnamoyl group are preferred, and a (meth)acryloyl group is more preferred.

### [Compound Having Polysiloxane Partial Structure]

The compound having a polysiloxane partial structure, which can be particularly preferably used in the present invention, is described in detail below.

The compounds which can be preferably used are roughly classified into those containing a polysiloxane partial structure in the polymer main chain as represented by formula (1) and those having a polysiloxane partial structure in the polymer side chain as represented by formula (2).

### (Polymer Having Polysiloxane Partial Structure in Polymer Main Chain)

The polymer having a polysiloxane partial structure in the polymer main chain is preferably a fluorine-containing polymer containing a polysiloxane partial structure and a repeating unit derived from a fluorine-containing vinyl monomer in the main chain and containing a repeating unit having a (meth)acryloyl group and a repeating unit having a hydroxyl group in the side chain. Such a polymer can serve as a resin curable upon irradiation with ionizing radiation and also as a compound having a polysiloxane partial structure. This polymer is preferably represented by the following formula (1):

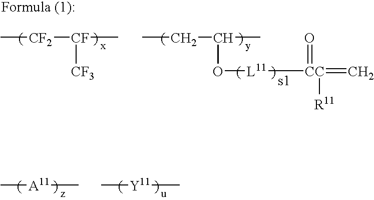

In formula (1), L¹¹ represents a linking group having a carbon number of 1 to 10, preferably a linking group having a carbon number of 1 to 6, more preferably a linking group having a carbon number of 2 to 4, which may be linear or may have a branched or cyclic structure and which may have a heteroatom selected from O, N and S. Preferred examples thereof include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—** and *—CH₂CH₂OCONH(CH₂)₃—O—** (wherein * denotes a linking site on the polymer main chain side and ** denotes a linking site on the (meth)acryloyl group side).

s1 represents 0 or 1.

R¹¹ represents a hydrogen atom or a methyl group and in view of curing reactivity, preferably a hydrogen atom.

A¹¹ represents a repeating unit having a hydroxyl group in the side chain. This repeating unit is not particularly limited as long as it is a constituent component of a monomer copolymerizable with hexafluoropropylene, and may be appropriately selected by taking account of various points such as adhesion to substrate, Tg of polymer (contributing to film hardness), solubility in solvent, transparency, slipperiness, dust protection and antifouling property. The repeating unit may comprise a single vinyl monomer or a plurality of vinyl monomers according to the purpose.

Preferred examples of the vinyl monomer constituting A¹¹ include vinyl ethers such as methyl vinyl ether, ethyl vinyl ether, tert-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate; (meth)acrylates such as methyl(meth)acrylate, ethyl(meth)acrylate, hydroxyethyl (meth)acrylate, glycidyl methacrylate, allyl(meth)acrylate and (meth)acryloyloxypropyltrimethoxysilane; styrene derivatives such as styrene and p-hydroxymethylstyrene; an unsaturated carboxylic acid and a derivative thereof, such as crotonic acid, maleic acid and itaconic acid. Among these, more preferred are a vinyl ether derivative and a vinyl ester derivative, still more preferred is a vinyl ether derivative. In view of unsusceptibility to oxygen at the curing, a monomer containing a glycidyl group is preferred.

Y¹¹ represents a constituent component containing a polysiloxane partial structure in the main chain.

The method for introducing a polysiloxane partial structure into the main chain is not particularly limited and examples thereof include a method using a polymer-type initiator such as azo group-containing polysiloxane amide (as the commercially available product, VPS-0501 and VPS-1001 (trade names, produced by Wako Pure Chemicals Industries, Ltd.)) described in JP-A-6-93100, a method of introducing a polymerization initiator and a reactive group (e.g., mercapto group, carboxyl group, hydroxyl group) originated in the chain transfer agent into the polymer terminal and reacting the reactive group with a reactive group (e.g., epoxy group, isocyanate group) at one terminal or both thermals, and a method of copolymerizing a cyclic cyclohexane polymer such as hexamethylcyclotrisiloxane by anionic ring-opening polymerization. Among these, a method using an initiator having a polysiloxane partial structure is easy and preferred. x, y and z each represents mol % of respective repeating units based on all repeating units excluding Y¹¹ and each represents a value satisfying 30≦x≦60, 0≦y≦70 and 0≦z≦50, preferably 35≦x≦55, 30≦y≦60 and 0≦z≦35, provided that x+y+z=100 (mol %). u represents mass % of the constituent component Y¹¹ in the copolymer and satisfies 0.01≦u≦20.

Among these polymers, a particularly preferred polymer is represented by the following formula (1-2):

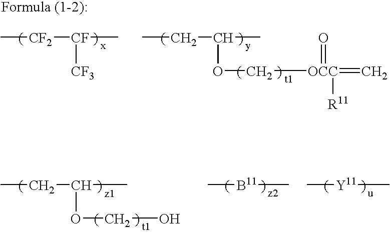

In formula (1-2), R¹¹, Y¹¹, x, y and u have the same meanings as in formula (1), and the preferred ranges are also the same.

B¹¹ represents a repeating unit derived from an arbitrary vinyl monomer and may comprise a single component or a plurality of components. Examples thereof include those described above as examples of A¹¹ in formula (1).

z1 and z2 each represents mol % of respective repeating units based on all repeating units excluding Y¹¹ and each represents a value satisfying 0≦z1≦40 and 0≦z2≦40, preferably 0≦z1≦30 and 0≦z2≦10, more preferably 0≦z1≦10 and 0≦z2≦5, provided that x+y+z1+z2=100 (mol %). t1 represents an integer satisfying 2≦t1≦10 and is preferably 2≦t1≦6, more preferably 2≦t1≦4. The copolymer represented by formula (1-2) is more preferably a copolymer satisfying 40≦x≦60, 40≦y≦60 and z2=0.

The polysiloxane partial structure introduced into the copolymer of the present invention is preferably a structure represented by the following formula (1-3):

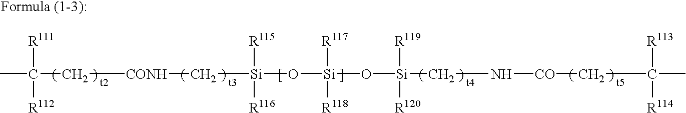

In formula (I-3), R¹¹¹, R¹¹², R¹¹³ and R¹¹⁴ each independently represents a hydrogen atom, an alkyl group (preferably having a carbon number of 1 to 5, e.g., methyl, ethyl), an aryl group (preferably having a carbon number of 6 to 10, e.g., phenyl, naphthyl), an alkoxycarbonyl group (preferably having a carbon number of 2 to 5, e.g., methoxycarbonyl, ethoxycarbonyl) or a cyano group, preferably an alkyl group or a cyano group, more preferably a methyl group or a cyano group.

R¹¹⁵ to R¹²⁰ each independently represents a hydrogen atom, an alkyl group (preferably having a carbon number of 1 to 5, e.g., methyl, ethyl), a haloalkyl group (preferably a fluorinated alkyl group having a carbon number of 1 to 5, e.g., trifluoromethyl, pentafluoroethyl) or a phenyl group, preferably a methyl group or a phenyl group, more preferably a methyl group.

t2 and t5 each independently represents an integer of 1 to 10, preferably an integer of 1 to 6, more preferably an integer of 2 to 4. t3 and t4 each independently represents an integer of 0 to 10, preferably an integer of 1 to 6, more preferably an integer of 2 to 4. p2 represents an integer of 10 to 1,000, preferably an integer of 20 to 500, more preferably an integer of 50 to 200.

The polysiloxane partial structure represented by formula (I-3) is preferably introduced at a proportion of 0.01 to 20 mass %, more preferably from 0.05 to 10 mass %, still more preferably from 0.5 to 5 mass %, based on the polymer for use in the present invention.

By virtue of introducing the above-described polysiloxane partial structure, not only an antifouling property and a dust protection are imparted to the film but also slipperiness is imparted to the film surface and this is advantageous in view of scratch resistance.

In the polymer useful for the present invention, other than the repeating unit derived from a fluorine-containing monomer and the repeating unit having a (meth)acryloyl group in the side chain, other vinyl polymers may be appropriately copolymerized by taking account of various points such as adhesion to substrate, Tg of polymer (contributing to film hardness), solubility in solvent, transparency, transparency, dust protection and antifouling property. A plurality of these vinyl monomers may be used in combination according to the purpose, and these monomers are preferably introduced at a total proportion of 0 to 40 mol %, more preferably from 0 to 30 mol %, still more preferably from 0 to 20 mol %, based on the copolymer.

The vinyl monomer which can be used in combination is not particularly limited, and examples thereof include olefins (e.g., ethylene, propylene, isoprene, vinyl chloride, vinylidene chloride), acrylic acid esters (e.g., methyl acrylate, methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene derivatives (e.g., styrene, p-hydroxymethylstyrene, p-methoxystyrene), vinyl ethers (e.g., methyl vinyl ether, ethyl vinyl ether, cyclohexyl vinyl ether, hydroxyethyl vinyl ether, hydroxybutyl vinyl ether), vinyl esters (e.g., vinyl acetate, vinyl propionate, vinyl cinnamate), unsaturated carboxylic acids (e.g., acrylic acid, methacrylic acid, crotonic acid, maleic acid, itaconic acid), acrylamides (e.g., N,N-dimethylacrylamide, N-tert-butylacrylamide, N-cyclohexylacrylamide), methacrylamides (e.g., N,N-dimethylmethacrylamide) and an acrylonitrile.

Preferred examples of the polymer useful in the present invention are set forth below, but the present invention is not limited thereto.

TABLE 1

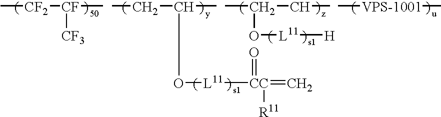

| | x | y | u | s1 | L¹¹ | R¹¹ |
|---|---|---|---|---|---|---|
| P-1 | 50 | 0 | 2 | 1 | *—CH₂CH₂O—** | H |
| P-2 | 50 | 0 | 2 | 1 | *—CH₂CH₂O—** | CH₃ |
| P-3 | 45 | 5 | 2 | 1 | *—CH₂CH₂O—** | H |
| P-4 | 40 | 10 | 2 | 1 | *—CH₂CH₂O—** | H |
| P-5 | 30 | 20 | 2 | 1 | *—CH₂CH₂O—** | H |
| P-6 | 50 | 0 | 2 | 0 | — | H |
| P-7 | 50 | 0 | 2 | 1 | *—C₄H₈O—** | H |
| P-8 | 50 | 0 | 2 | 1 | 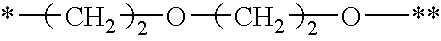 | H |
| P-9 | 50 | 0 | 2 | 1 | 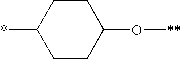 | H |
| P-10 | 50 | 0 | 2 | 1 | *—CH₂CH₂NH—** | H |
| P-11 | 50 | 0 | 3 | 1 | 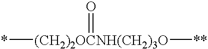 | H |
| P-12 | 50 | 0 | 3 | 1 | 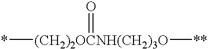 | CH₃ |
| P-13 | 50 | 0 | 3 | 1 | 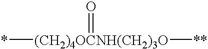 | CH₃ |
| P-14 | 50 | 0 | 3 | 1 | 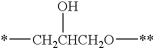 | H |
| P-15 | 50 | 0 | 3 | 1 | 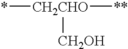 | H |
| P-16 | 50 | 0 | 3 | 1 | 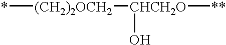 | H |
| P-17 | 50 | 0 | 3 | 1 | 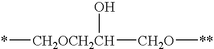 | CH₃ |
| P-18 | 50 | 0 | 3 | 1 | 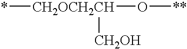 | CH₃ |
| P-19 | 40 | 10 | 2 | 1 | *—CH₂CH₂O—** | CH₃ |

*indicates the polymer main chain side and **indicates the (meth)acryloyl group side.

In Table 1, 501y/z denotes a molar ratio, u denotes mass %, and VPS-1001 denotes a component originated in a polysiloxane-containing macro-azo initiator, “VPS-1001” (trade names), produced by Wako Pure Chemicals Industries, Ltd.) (hereinafter the same).

TABLE 2

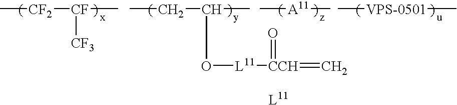

| | x | y | z | u | L¹¹ | A¹¹ |
|---|---|---|---|---|---|---|
| P-20 | 55 | 45 | 0 | 4 | *—CH₂CH₂O—** | — |
| P-21 | 45 | 55 | 0 | 4 | *—CH₂CH₂O—** | — |
| P-22 | 50 | 45 | 5 | 4 | 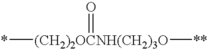 | 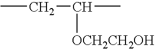 |
| P-23 | 50 | 45 | 5 | 4 | 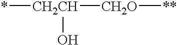 | 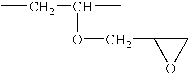 |
| P-24 | 50 | 45 | 5 | 4 | 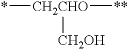 | 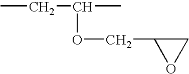 |
| P-25 | 50 | 40 | 10 | 4 | *—CH₂CH₂O—** | 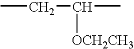 |
| P-26 | 50 | 40 | 10 | 4 | *—CH₂CH₂O—** | 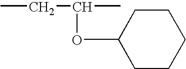 |
| P-27 | 50 | 40 | 10 | 4 | *—CH₂CH₂O—** | 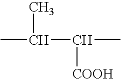 |

*indicates the polymer main chain side and **indicates the (meth)acryloyl group side.

In Table 2, x/y/z denotes a molar ratio, u denotes mass % in the copolymer, and VPS-denotes a component originated in a polysiloxane-containing macro-azo initiator, “VPS0501” (trade names), produced by Wako Pure Chemicals Industries, Ltd.).

TABLE 3

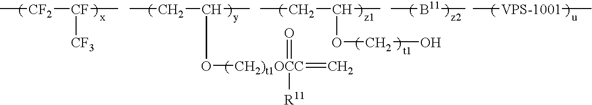

| | x | y | z1 | z2 | u | t1 | R¹¹ | B¹¹ |
|---|---|---|---|---|---|---|---|---|
| P-28 | 50 | 40 | 5 | 5 | 2 | 2 | H | 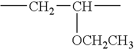 |
| P-29 | 50 | 35 | 5 | 10 | 2 | 2 | H | 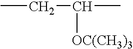 |
| P-30 | 40 | 40 | 10 | 10 | 2 | 4 | CH₃ | 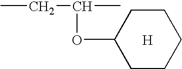 |

TABLE 4

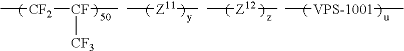

| | y | z | u | Z¹¹ | Z¹² |
|---|---|---|---|---|---|
| P-31 | 45 | 5 | 5 | 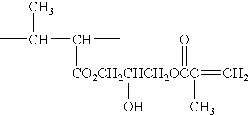 | 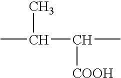 |
| P-32 | 40 | 10 | 10 | 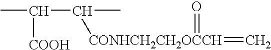 | 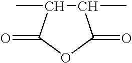 |

In Tables 3 and 4, x/y/z1/z 2 and 50/y/z each denotes a molar ratio, u denotes mass %, and t1 denotes the number of methylene units.

TABLE 5

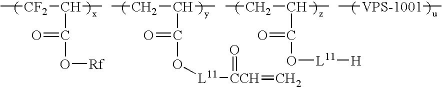

| | x | y | z | u | Rf | L¹¹ |
|---|---|---|---|---|---|---|
| P- | 60 | 40 | 0 | 5 | —CH₂CH₂C₈F₁₇(n) | —CH₂CH₂O— |
| 33 | | | | | | |
| P- | 60 | 30 | 10 | 5 | —CH₂CH₂C₄F₈H(n) | —CH₂CH₂O— |
| 34 | | | | | | |
| P- | 40 | 60 | 0 | 5 | —CH₂CH₂C₆F₁₂H(n) | —CH₂CH₂CH₂CH₂O— |
| 35 | | | | | | |

TABLE 6

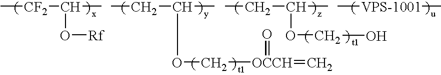

| | x | y | z | u | t1 | Rf |
|---|---|---|---|---|---|---|
| P-36 | 50 | 50 | 0 | 5 | 2 | —CH₂C₄F₈H(n) |
| P-37 | 40 | 55 | 5 | 5 | 2 | —CH₂C₄F₈H(n) |
| P-38 | 30 | 70 | 0 | 5 | 4 | —CH₂C₈F₁₇(n) |
| P-39 | 60 | 40 | 0 | 5 | 2 | —CH₂CH₂C₈F₁₆H(n) |

In Tables 5 and 6, x/y/z denotes a molar ratio, u denotes mass %, and t1 denotes the number of methylene units.

TABLE 7

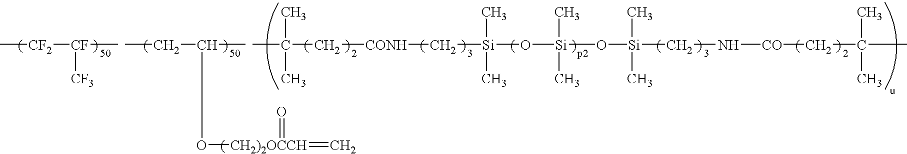

| | u | p2 |
|---|---|---|
| P-40 | 2 | 50 |
| P-41 | 2 | 100 |
| P-42 | 2 | 200 |
| P-43 | 2 | 500 |
| P-44 | 2 | 1000 |
| P-45 | 3 | 100 |
| P-46 | 4 | 100 |
| P-47 | 5 | 100 |
| P-48 | 10 | 100 |
| P-49 | 20 | 100 |

In Table 7, the ratio (50/50) of the components in the vinyl monomer denotes a molar ratio, u denotes mass %, and p2 denotes the number of dimethylcyclohexane partial structures.

### (Polymer Having Polysiloxane Partial Structure in Polymer Side Chain)

The polymer having a polysiloxane partial structure in the polymer side chain is described in detail below.

The mode of the polymer particularly preferred in the present invention is a mode represented by formula (2).

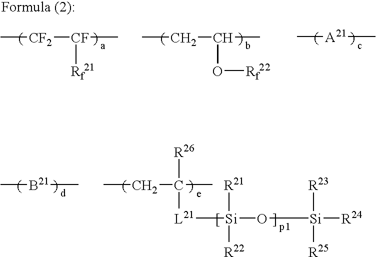

In formula (2), R_{f}²¹ represents a perfluoroalkyl group having a carbon number of 1 to 5, R_{f}²² represents a fluorine-containing alkyl group having a linear, branched or alicyclic structure having a carbon number of 1 to 30, which may have an ether bond, A²¹ represents a constituent unit having a reactive group capable of participating in a crosslinking reaction, B²¹ represents an arbitrary constituent component, R²¹ and R²², which may be the same or different, each represents an alkyl group or an aryl group, p1 represents an integer of 10 to 500, R²³ to R²⁵ each independently represents a substituted or unsubstituted monovalent organic group or a hydrogen atom, R²⁶ represents a hydrogen atom or a methyl group, and L²¹ represents an arbitrary linking group having a carbon number of 1 to 20 or a singe bond.

a to d each represents a molar fraction (%) of respective constituent components excluding the polymerization unit containing a polysiloxane partial structure and each represents a value satisfying the relationships of 10≦a+b≦55, 10≦a≦55 (preferably 40≦a≦55), 0≦b≦45 (preferably 0≦b≦30), 10≦c≦50 (preferably 20≦c≦50) and 0≦d≦40 (preferably 0≦d≦30), and e represents a mass fraction (%) of the polymerization unit containing a polysiloxane partial structure based on the entire mass of other four components and satisfies the relationship of 0.01≦e≦20 (preferably 0.1≦e≦10, more preferably 0.5≦e≦5).

The perfluoroolefin is preferably a perfluoroolefin having a carbon number of 3 to 7 and is preferably perfluoropropylene or perfluorobutylene in view of polymerization reactivity, more preferably perfluoropropylene in view of availability.

The perfluoroolefin content in the polymer is from 10 to 55 mol %. It may be demanded to increase the introduction percentage of the perfluoroolefin for reducing the refractive index of the material, but in view of polymerization reactivity, the introduction percentage on the order of 50 to 70 mol % is the limit in a general solution-based radical polymerization reaction and a higher introduction percentage is difficult to achieve. In the present invention, the perfluoroolefin content is preferably from 10 to 55 mol %, more preferably from 40 to 55 mol %.

### (Fluorine-Containing Vinyl Ether)

In the present invention, a fluorine-containing vinyl ether represented by the following formula (M1) may be copolymerized for reducing the refractive index. This copolymerization component may be introduced into the polymer at a proportion of 0 to 45 mol %, but the content thereof is preferably from 0 to 30 mol %, more preferably from 0 to 20 mol %. Particularly, in the case where the film hardness of the low refractive index needs to be set relatively high (for example, when a large amount of a low refractive index filler is contained in the low refractive index and elevation of the film strength is rather preferred than to decrease the refractive index of the layer by a binder polymer), the introduction percentage of the copolymerization component, that is, the fluorine-containing vinyl ether represented by formula (M1), is preferably 0 mol %, because a polymerization unit having a reactive group capable of participating in a cross-linking reaction described later can be introduced into the side chain in a higher percentage by excluding this copolymerization component.

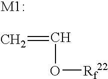

In formula (M1), R_{f}²² represents a fluorine-containing alkyl group having a carbon number of 1 to 30 and is preferably a fluorine-containing alkyl group having a carbon number of 1 to 20, more preferably from 1 to 15, which may be linear {e.g., —CF₂CF₃, —CH₂(CF₂)₄H, —CH₂(CF₂)_{g}CF₃, —CH₂CH₂(CF₂)₄H), may have a branched structure {e.g., CH(CF₃)₂, CH₂CF(CF₃)₂, CH(CH₃)CF₂CF₃, CH(CH₃)(CF₂)₅CF₂H) or an alicyclic structure (preferably a 5- or 6-membered ring, for example, a perfluorocyclohexyl group, a perfluorocyclopentyl group or an alkyl group substituted with such a group), or may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H).

The monomer represented by formula (M1) may be synthesized, for example, by a method of causing a fluorine-containing alcohol to act on a leaving group-substituted alkyl vinyl ether (e.g., vinyloxyalkyl sulfonate, vinyloxyalkyl chloride) in the presence of a base catalyst described in Macromolecules, Vol. 32 (21), page 7122 (1999) and JP-A-2-721; a method of mixing a fluorine-containing alcohol with vinyl ethers (e.g., butyl vinyl ether) in the presence of a palladium catalyst, thereby effecting exchange with a vinyl group described in International Application No. 92/05135, pamphlet; or a method of reacting a fluorine-containing ketone with a dibromoethane in the presence of potassium fluoride catalyst and then performing an HBr-removing reaction with use of an alkali catalyst described in U.S. Pat. No. 3,420,793.

Preferred examples of the constituent component represented by formula (M1) are set forth below.

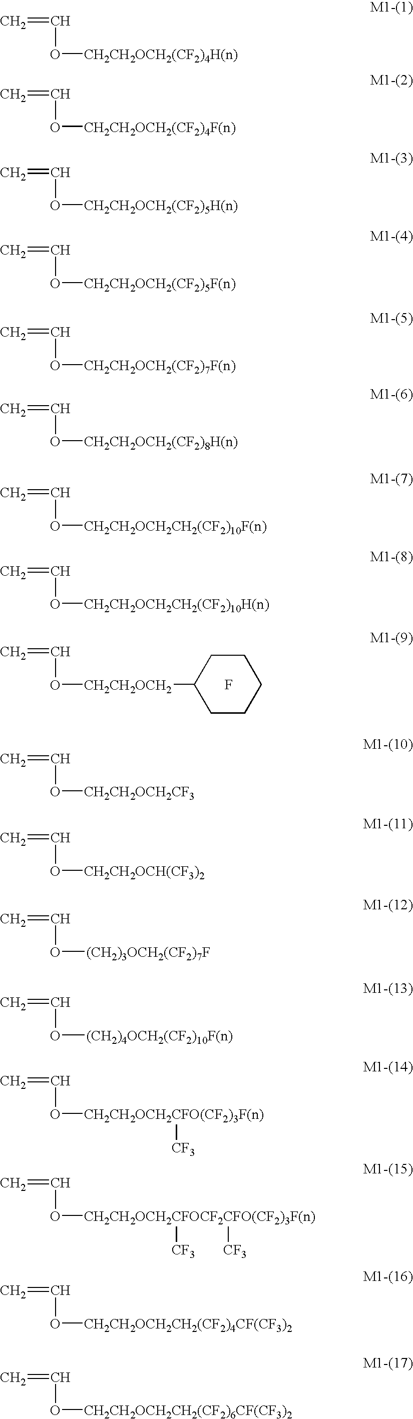

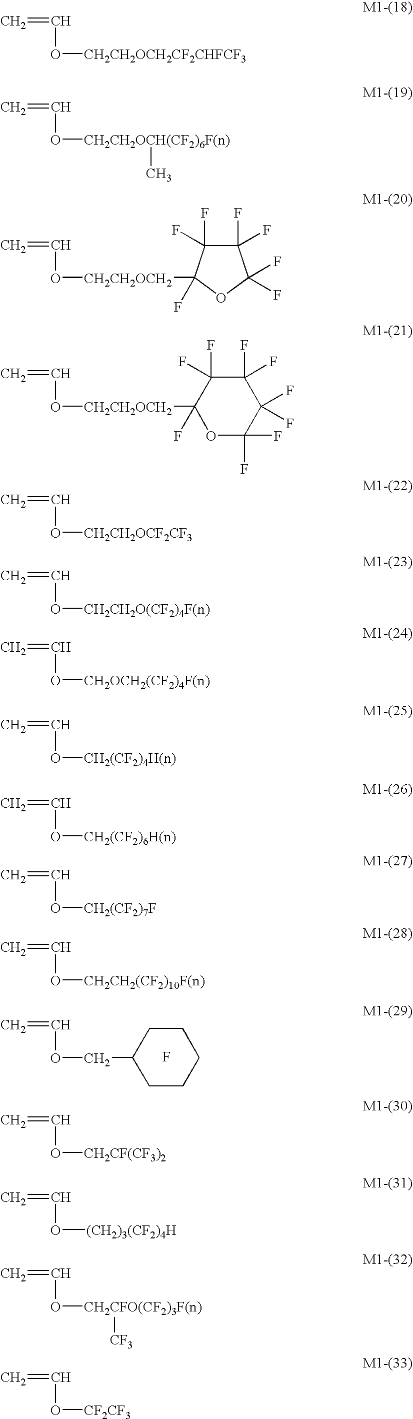

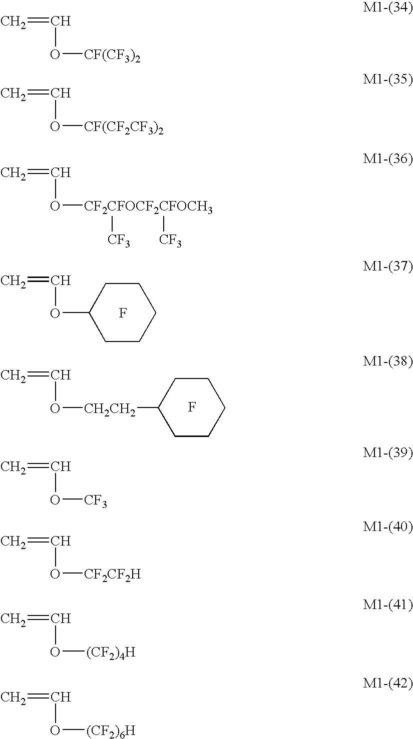

### (Constituent Unit Having Reactive Group Capable of Participating in Crosslinking Reaction)

In the present invention, the constituent unit having a reactive group capable of participating in a crosslinking reaction (hereinafter sometimes referred to as a “crosslinking reactive group”) contained in the fluorine-containing polymer constituting the low refractive index layer is not particularly limited in its structure but in view of polymerization reactivity with a fluorine-containing olefin, a compound having a vinyl group is preferred, and vinyl ethers or vinyl esters are more preferred.

Examples of the crosslinking reactive group include a group having an active hydrogen atom, such as hydroxyl group, amino group, carbamoyl group, mercapto group, β-ketoester group, hydrosilyl group and silanol group; a cationic polymerizable group (e.g., epoxy group, oxetanyl group, oxazolyl group, vinyloxy group); a group having an unsaturated double bond capable of addition or polymerization by an acid anhydride or a radical species, such as acryloyl group, methacryloyl group and allyl group; a hydrolyzable silyl group (e.g., alkoxysilyl group, acyloxysilyl group); and a group capable of being substituted by a nucleophilic reagent, such as active halogen atom and sulfonic acid ester.

Among these, the group having an unsaturated double bond may be formed by a usual method such as a method of synthesizing a polymer having a hydroxyl group and causing an acid halide (e.g., (meth)acrylic acid chloride), an acid anhydride (e.g., (meth)acrylic anhydride) or a (meth)acrylic acid to act thereon; and a method of polymerizing a vinyl monomer having a 3-chloropropionic acid ester site and then performing dehydrochlorination. Also, other functional groups may be introduced from the monomer stage or may be introduced after the synthesis of a polymer having a reactive group such as hydroxyl group.

Among those crosslinking reactive groups, a hydroxyl group, an epoxy group, a (meth)acryloyl group and a hydrolyzable silyl group are preferred, an epoxy group and a (meth)acryloyl group are more preferred, and a (meth)acryloyl group is most preferred. The amount introduced of the copolymerization component having such a crosslinking reactive group is from 10 to 50 mol %, preferably from 20 to 50 mol %, more preferably from 25 to 50 mol %.

Preferred examples of the polymerization unit capable of participating in a crosslinking reaction are set forth below, but the present invention is not limited thereto.

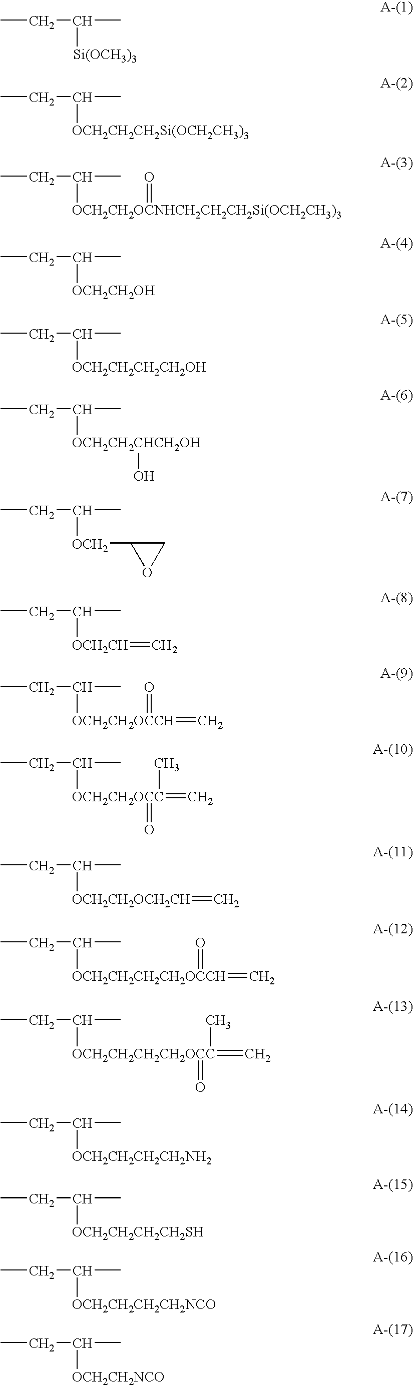

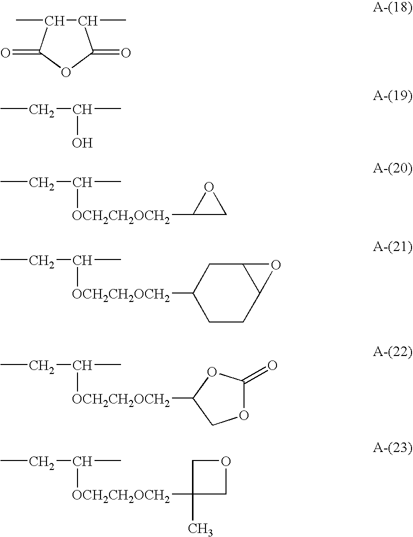

### (Polysiloxane Partial Structure)

The polysiloxane partial structure in the polymer having a polysiloxane partial structure in the side chain, which is used in the present invention, is described below. The polysiloxane partial structure generally has a repeating siloxane moiety of the following formula (2-1):

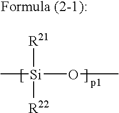

In formula (2-1), R²¹ and R²², which may be the same or different, each represents an alkyl group or an aryl group. The alkyl group is preferably an alkyl group having a carbon number of 1 to 4, and examples thereof include a methyl group, a trifluoromethyl group and an ethyl group. The aryl group is preferably an aryl group having a carbon number of 6 to 20, and examples thereof include a phenyl group and a naphthyl group. Among these, a methyl group and a phenyl group are preferred, and a methyl group is more preferred. p1 represents an integer of 10 to 500, preferably from 10 to 350, more preferably from 10 to 250.

The polymer having a polysiloxane structure represented by formula (2-1) in the side chain may be synthesized by a method of introducing a polysiloxane [for example, “Silaplane” Series {produced by Chisso Corp.}] having, at one terminal, a reactive group (for example, an amino group, a mercapto group, a carboxyl group or a hydroxyl group for an epoxy group or an acid anhydride group) reactive with a polymer having a reactive group such as epoxy group, hydroxyl group, carboxyl group or acid anhydride group, by a polymer reaction described in J. A. Appl. Polym. Sci., Vol. 2000, page 78 (1955) and JP-A-56-28219; or a method of polymerizing a polysiloxane-containing silicon macromer. Either method may be preferably used. In the present invention, a method of introducing the structure by the polymerization of a silicon macromer is more preferred.

The polymerization unit containing a repeating siloxane moiety in the side chain preferably occupies from 0.01 to 20 mass %, more preferably from 0.1 to 10 mass %, still more preferably from 0.5 to 5%, in the copolymer.

Preferred examples of the polymerization unit containing a repeating siloxane moiety in the side chain, which is useful in the present invention, are set forth below, but the present invention is not limited thereto.

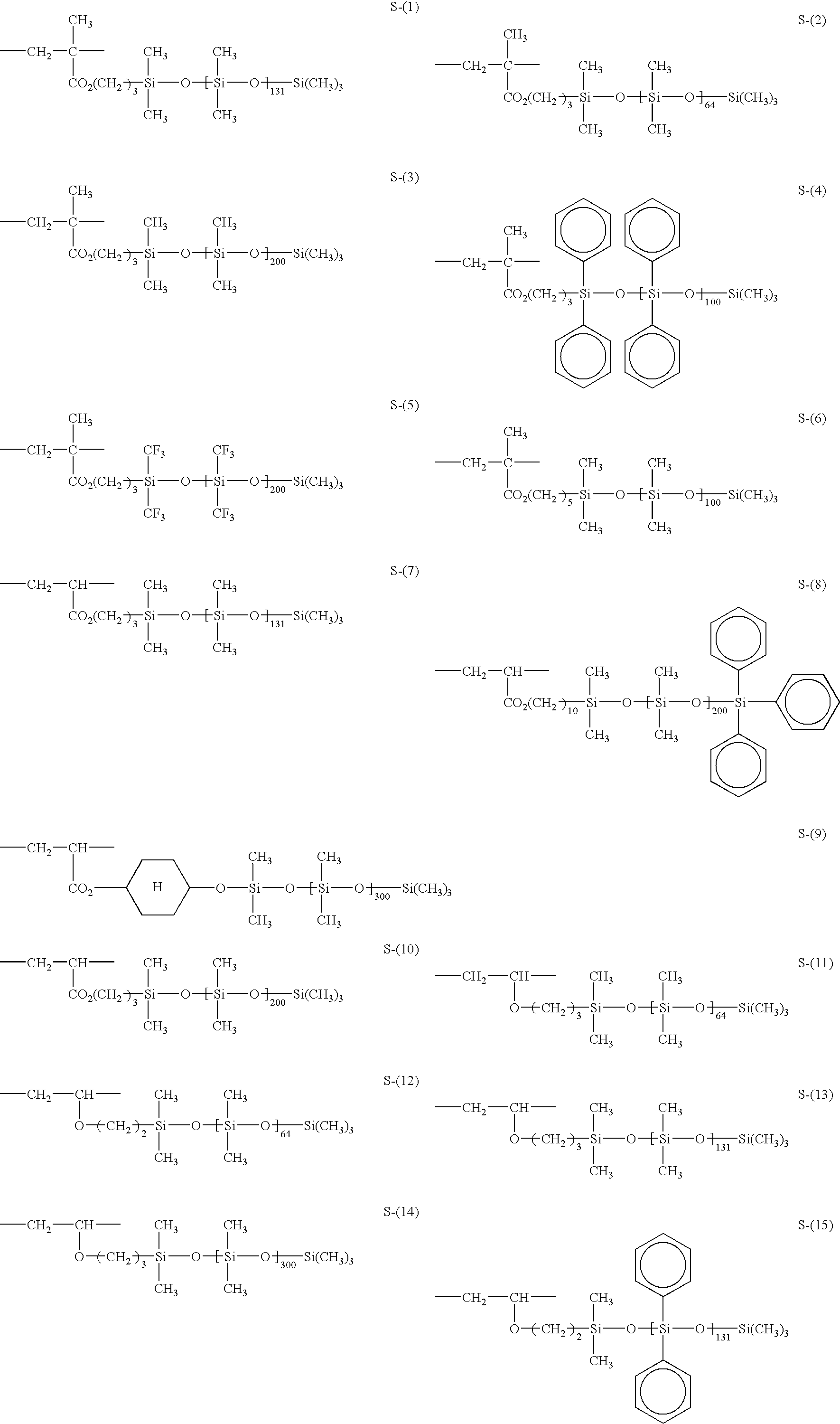

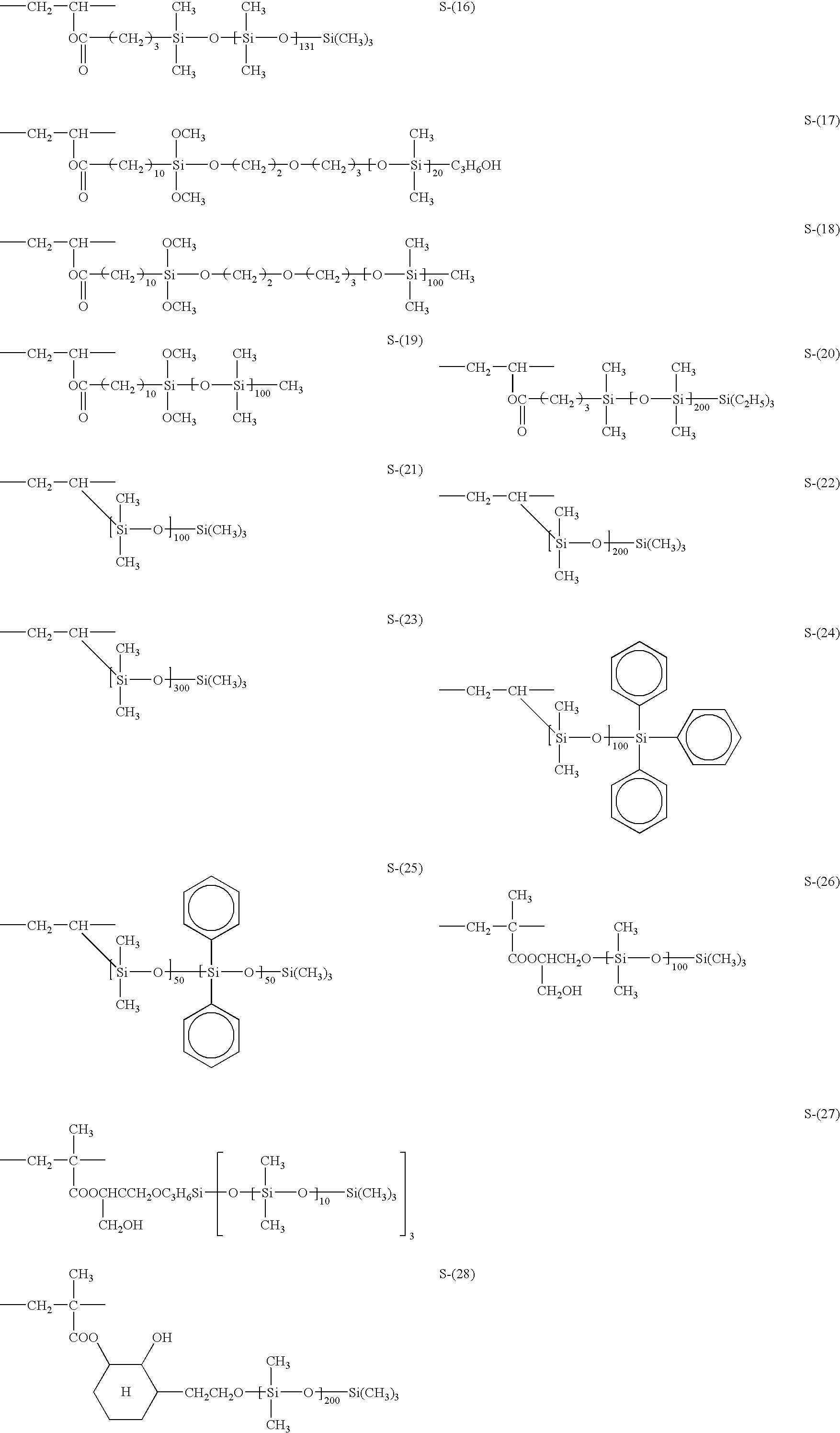

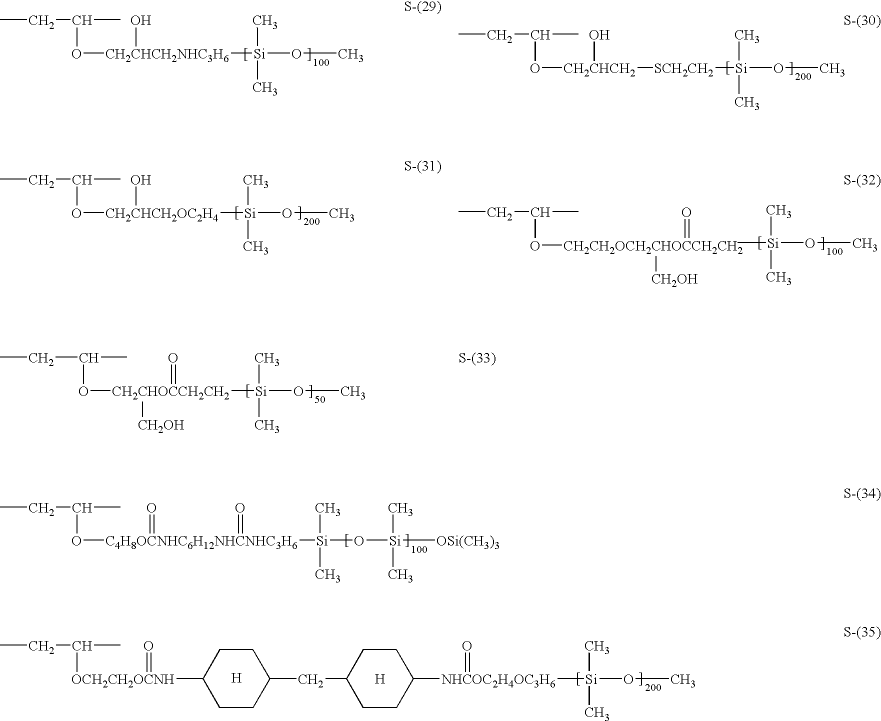

Other than these, as described above, a polymerization unit formed by a polymer reaction of a polysiloxane having, at one terminal, a reactive group reactive with a reactive group of another polymerization unit may also be used as the polymerization unit containing a repeating siloxane moiety in the side chain. Examples of the commercially available polysiloxane include the followings:

S-(36): “Silaplane FM0711” (produced by Chisso Corp.)
S-(37): “Silaplane FM0721” (produced by Chisso Corp.)
S-(38): “Silaplane FM0725” (produced by Chisso Corp.)

### (Other Copolymerization Component)

A copolymerization component other than those described above may also be appropriately selected in view of various points such as hardness, adhesion to substrate, solubility in solvent and transparency.

Examples of this copolymerization unit include vinyl ethers such as methyl vinyl ether, ethyl vinyl ether, tert-butyl vinyl ether, n-butyl vinyl ether, cyclohexyl vinyl ether and isopropyl vinyl ether; and vinyl esters such as vinyl acetate, vinyl propionate, vinyl butyrate and vinyl cyclohexanecarboxylate. The amount introduced of such a copolymerization component is from 0 to 40 mol %, preferably from 0 to 30 mol %, more preferably from 1 to 20 mol %.

Specific examples of the polymer useful in the present invention are shown in Tables 8 and 9 below, but the present invention is not limited thereto. In Tables 8 and 9, the polymer is denoted by a combination of polymerization units. A molar fraction in the components excluding a silicone-containing polymerization unit and a mass fraction of the silicone-containing polymerization unit are shown.

TABLE 8
Fluorine Containing Polymer

| | | | | | | | | Constituent Unit Having | | |
|---|---|---|---|---|---|---|---|---|---|---|
| | Basic Constitution [molar fraction (%)] | | | | | | | Polysiloxane Partial | | Mass Average |
| | | Fluorine-Containing | | Constituent Unit Having | | Other Copolymerization | | Structure [mass fraction | | Molecular |
| | Hexafluoro- | Vinyl Ether | | Crosslinking Reactive Group | | Component | | (%)] | | Weight |
| No. | propylene | Kind | Amount | Kind | Amount | Kind* | Amount | Kind | Amount | (×10³) |
| PP-1 | 50 | — | — | A-(4)/A-(9) | 5/45 | — | — | S-(36) | 2 | 1.9 |
| PP-2 | 50 | — | — | A-(4)/A-(9) | 10/40 | — | — | S-(37) | 2 | 3.1 |
| PP-3 | 50 | — | — | A-(4)/A-(9) | 15/35 | — | — | S-(38) | 1 | 3.3 |
| PP-4 | 50 | — | — | A-(4)/A-(10) | 5/45 | — | — | S-(38) | 1 | 4.5 |
| PP-5 | 50 | — | — | A-(4)/A-(10) | 10/40 | — | — | S-(36) | 2 | 2.5 |
| PP-6 | 50 | — | — | A-(4)/A-(10) | 15/35 | — | — | S-(37) | 2 | 5.1 |
| PP-7 | 50 | — | — | A-(5)/A-(12) | 5/45 | — | — | S-(11) | 1 | 3.5 |
| PP-8 | 50 | — | — | A-(5)/A-(12) | 10/40 | — | — | S-(16) | 2 | 2.8 |
| PP-9 | 50 | — | — | A-(5)/A-(12) | 5/45 | — | — | S-(17) | 1 | 4.5 |
| PP-10 | 50 | — | — | A-(5)/A-(12) | 10/40 | — | — | S-(37) | 2 | 4.2 |
| PP-11 | 50 | — | — | A-(9) | 50 | — | — | S-(37) | 2 | 3.2 |
| PP-12 | 50 | — | — | A-(10) | 50 | — | — | S-(36) | 2 | 3.7 |
| PP-13 | 50 | — | — | A-(12) | 50 | — | — | S-(38) | 1 | 2.8 |
| PP-14 | 50 | — | — | A-(13) | 50 | — | — | S-(37) | 1 | 3.1 |
| PP-15 | 50 | M1-(1) | 10 | A-(9) | 40 | — | — | S-(36) | 2 | 7.1 |
| PP-16 | 50 | M1-(1) | 10 | A-(4)/A-(9) | 5/35 | — | — | S-(37) | 1 | 6.3 |
| PP-17 | 50 | M1-(5) | 10 | A-(4)/A-(10) | 5/35 | — | — | S-(37) | 2 | 4.1 |
| PP-18 | 50 | M1-(5) | 10 | A-(5)/A-(12) | 5/35 | — | — | S-(38) | 1 | 3.5 |
| PP-19 | 50 | — | — | A-(4)/A-(9) | 5/35 | EVE | 10 | S-(11) | 1 | 4.8 |
| PP-20 | 50 | — | — | A-(9) | 35 | EVE | 15 | S-(17) | 1 | 1.6 |

Kind* EVE: ethyl vinyl ether

TABLE 9
Fluorine Containing Polymer

| | | | | | | | | Constituent Unit Having | | |
|---|---|---|---|---|---|---|---|---|---|---|
| | Basic Constitution [molar fraction (%)] | | | | | | | Polysiloxane Partial | | Mass Average |
| | | Fluorine-Containing | | Constituent Unit Having | | Other Copolymerization | | Structure [mass fraction | | Molecular |
| | Hexafluoro- | Vinyl Ether | | Crosslinking Reactive Group | | Component | | (%)] | | Weight |
| No. | propylene | Kind | Amount | Kind | Amount | Kind* | Amount | Kind | Amount | (×10³) |
| PP-21 | 50 | — | — | A-(4)/A-(8) | 5/45 | — | — | S-(36) | 3 | 1.6 |
| PP-22 | 50 | — | — | A-(8) | 40 | EVE | 10 | S-(5) | 2 | 3.5 |
| PP-23 | 50 | M1-(1) | 10 | A-(8) | 40 | — | — | S-(37) | 3 | 3.0 |
| PP-24 | 50 | M1-(5) | 10 | A-(8) | 40 | — | — | S-(38) | 2 | 4.6 |
| PP-25 | 50 | — | — | A-(8)/A-(9) | 10/40 | — | — | S-(36) | 2 | 2.6 |
| PP-26 | 50 | — | — | A-(8)/A-(12) | 10/40 | — | — | S-(36) | 1 | 6.8 |
| PP-27 | 50 | — | — | A-(2)/A-(9) | 10/40 | — | — | S-(37) | 2 | 2.7 |
| PP-28 | 50 | — | — | A-(2)/A-(10) | 10/40 | — | — | S-(38) | 1 | 9.1 |
| PP-29 | 50 | — | — | A-(6)/A-(8) | 5/45 | — | — | S-(11) | 1 | 2.6 |
| PP-30 | 50 | — | — | A-(6)/A-(8) | 10/40 | — | — | S-(17) | 1 | 3.6 |
| PP-31 | 50 | — | — | A-(4)/A-(9) | 5/35 | tBVE | 10 | S-(16) | 1 | 1.9 |
| PP-32 | 50 | — | — | A-(5)/A-(12) | 5/40 | tBVE | 5 | S-(5) | 1 | 2.4 |
| PP-33 | 50 | — | — | A-(9)/A-(10) | 25/25 | — | — | S-(36) | 2 | 3.3 |
| PP-34 | 50 | — | — | A-(7) | 50 | — | — | S-(37) | 2 | 4.1 |
| PP-35 | 50 | M1-(1) | 10 | A-(7) | 40 | — | — | S-(38) | 1 | 2.2 |
| PP-36 | 50 | M1-(5) | 5 | A-(6)/A-(7) | 5/40 | — | — | S-(11) | 2 | 3.5 |
| PP-37 | 50 | — | — | A-(2)/A-(7) | 10/40 | — | — | S-(37) | 2 | 4.3 |
| PP-38 | 50 | — | — | A-(2)/A-(6) | 30/10 | EVE | 10 | S-(17) | 2 | 4.6 |
| PP-39 | 50 | — | — | A-(2)/A-(5) | 40/10 | — | — | S-(16) | 2 | 2.2 |
| PP-40 | 50 | M1-(5) | 10 | A-(2) | 40 | — | — | S-(38) | 1 | 1.9 |

Kind* EVE: ethyl vinyl ether, tBVE: tert-butyl vinyl ether

The polymer having a polysiloxane structure in the main or side chain, which is a compound having a polysiloxane partial structure for use in the present invention, preferably has a polystyrene-reduced number average molecular weight of 5,000 to 500,000, more preferably from 5,000 to 300,000, as measured by gel permeation chromatography.

The synthesis of the polymer having a polysiloxane structure in the main or side chain may be performed by synthesizing a precursor such as hydroxyl group-containing polymer according to various polymerization methods (e.g., solution polymerization, sedimentation polymerization, suspension polymerization, precipitation polymerization, bulk polymerization, emulsion polymerization), and then introducing a (meth)acryloyl group through the above-described polymer reaction. The polymerization reaction may be performed by an arbitrary operation such as batch system, semi-continuous system or continuous system.

The polymerization initiating method includes a method using a radical initiator, a method of irradiating light or radiation, and the like. These polymerization methods and polymerization initiating methods are described, for example, in Teiji Tsuruta, Kobunshi Gosei Hoho (Polymer Synthesis Method), revised edition, Nikkan Kogyo Shinbun Sha (1971), and Takayuki Ohtsu and Masaetsu Kinoshita, Kobunshi Gosei no Jikken Ho (Test Method of Polymer Synthesis), pp. 124-154, Kagaku Dojin (1972).

Among those polymerization methods, a solution polymerization method using a radical initiator is preferred. Examples of the solvent for use in the solution polymerization include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol and 1-butanol. One of these solvents may be used alone, or a mixture of two or more thereof may be used. A mixed solvent with water may also be used.

The polymerization temperature needs to be set according to the molecular weight of polymer, the kind of initiator, and the like, and a polymerization temperature from 0° C. or less to 100° C. or more may be used, but the polymerization is preferably performed in the range from 50 to 100° C.

The reaction pressure may be appropriately selected but is usually from 1 to 100 kg/cm², preferably on the order of 1 to 30 kg/cm². The reaction time is approximately from 5 to 30 hours.

The reprecipitation solvent for the polymer obtained is preferably isopropanol, hexane, methanol or the like.

### (Combination Use of Polyfunctional Compound)

In view of enhancement of film strength, improvement of coated surface state and surface state stability at the addition of a fine particle, a compound having two or more polymerizable or condensable functional groups within one molecule may also be used for the polymer of the present invention. Preferred examples thereof include a compound having ethylenically unsaturated groups and a compound having cationic polymerizable groups.

The compound containing ethylenically unsaturated groups is described below.

### (Combination Use of Polyfunctional Compound)

A compound having two or more ethylenically unsaturated groups is preferably used in combination for the polymer of the present invention. Examples of the compound having two or more ethylenically unsaturated groups include an ester of polyhydric alcohol and (meth)acrylic acid, such as ethylene glycol di(meth)acrylate, 1,4-dichlorohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, pentaerythritol hexa(meth)acrylate, 1,2,3-cyclohexane tetramethacrylate, polyurethane polyacrylate, polyester polyacrylate; a vinylbenzene and its derivative, such as 1,4-divinylbenzene, 2-acryloylethyl 4-vinylbenzoate, 1,4-divinylcyclohexanone; a vinylsulfone (e.g., divinylsulfone); an acrylamide derivative (e.g., methylenebisacrylamide); and a methacrylamide derivative. The compound may be used in combination of two or more thereof

### (Compound Having Cationic Polymerizable Groups)

Examples of the cationic polymerizable group include an epoxy group, an oxetanyl group, an oxazolyl group and a vinyloxy group. The cationic polymerizable group is preferably a ring-opening polymerizable group, more preferably an epoxy group or an oxetanyl group, still more preferably an epoxy group. These groups each may have a substituent at the position to which the substituent can be substituted.

A plurality of these cationic polymerizable groups are preferably introduced per molecule of the compound having cationic polymerizable groups. The number of cationic polymerizable groups introduced per molecule is preferably from 2 to 20, more preferably from 3 to 10.

Examples of the compound suitably used in the present invention include, as a commercially available product, Denacol EX314, Denacol Ex411, Denacol Ex421, Denacol Ex521, Denacol Ex611 and Denacol Ex612 (all produced by Nagase Chemicals Ltd.); and Celoxide GT301 and Celoxide GT401 (both produced by Daicel Chemical Industries, Ltd.).

Other than these, examples of the polyfunctional compound useful in the present invention are set forth below.

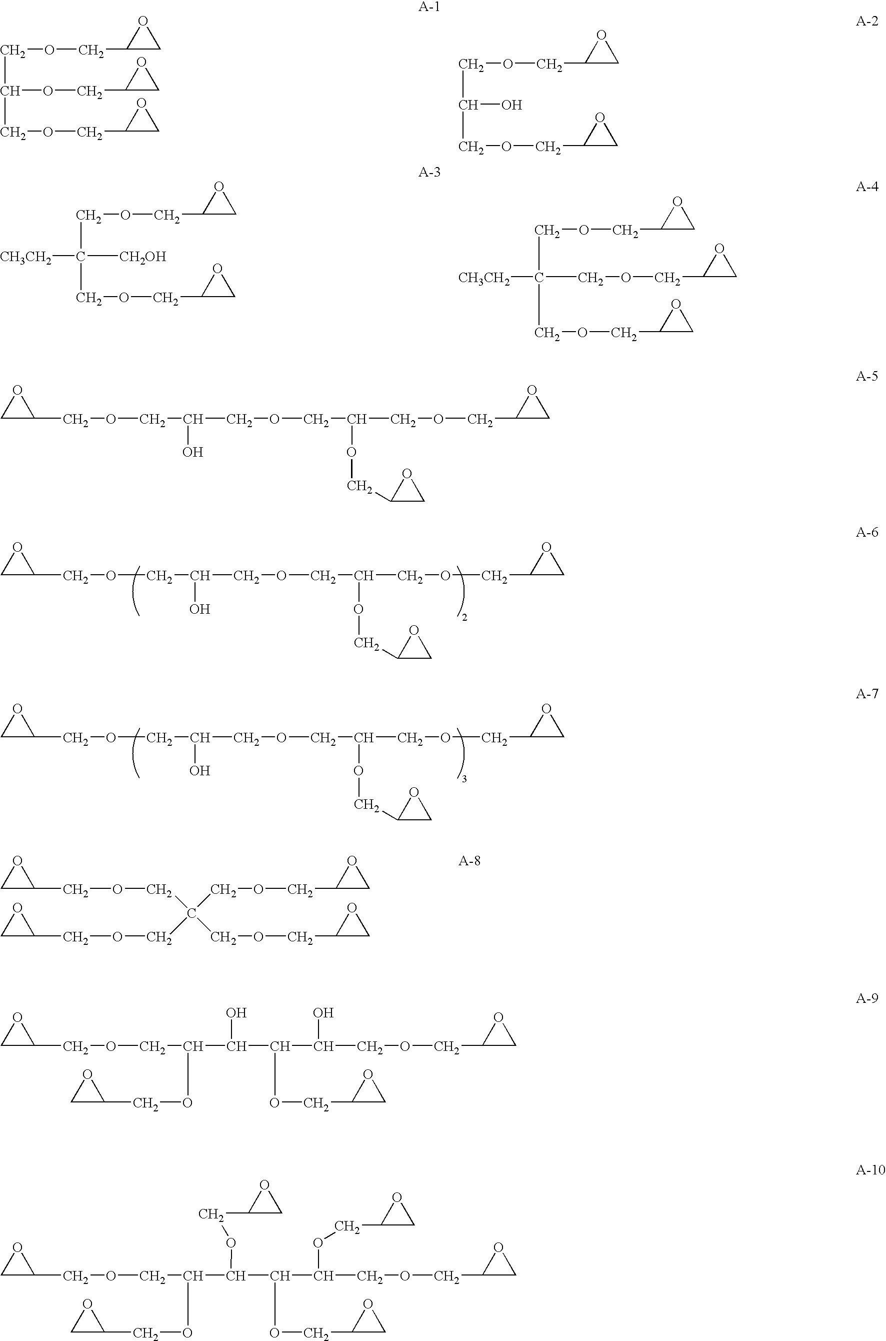

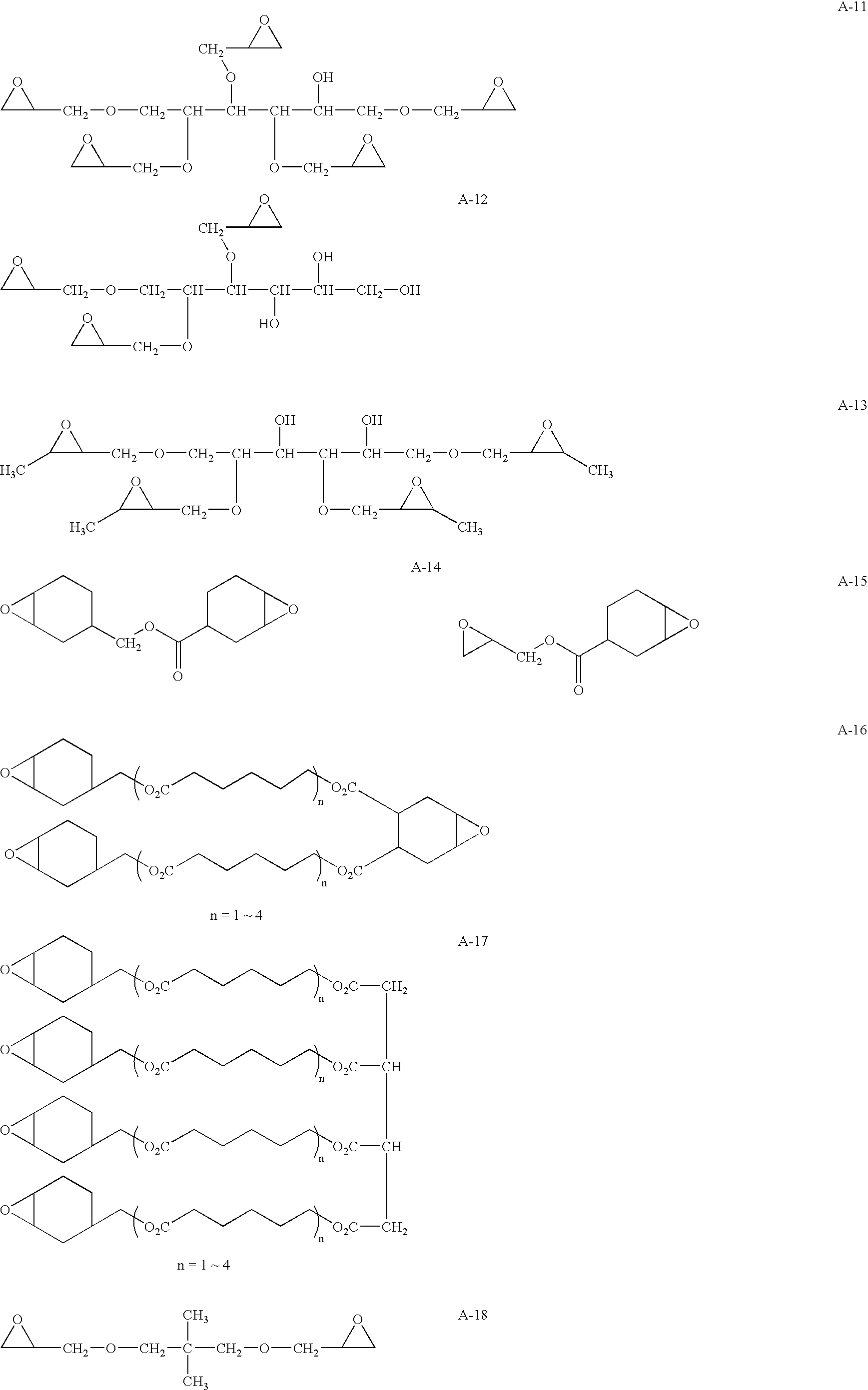

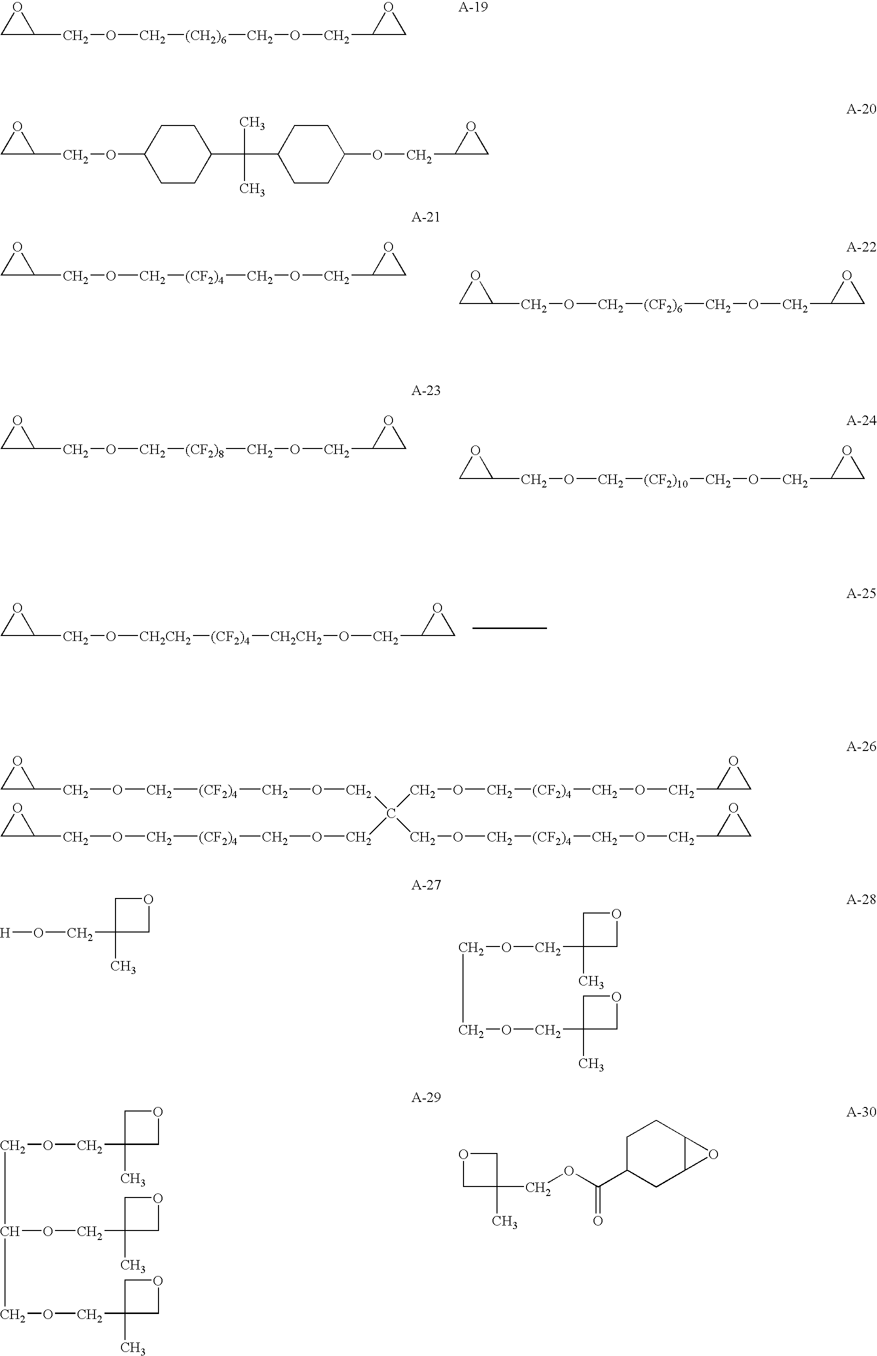

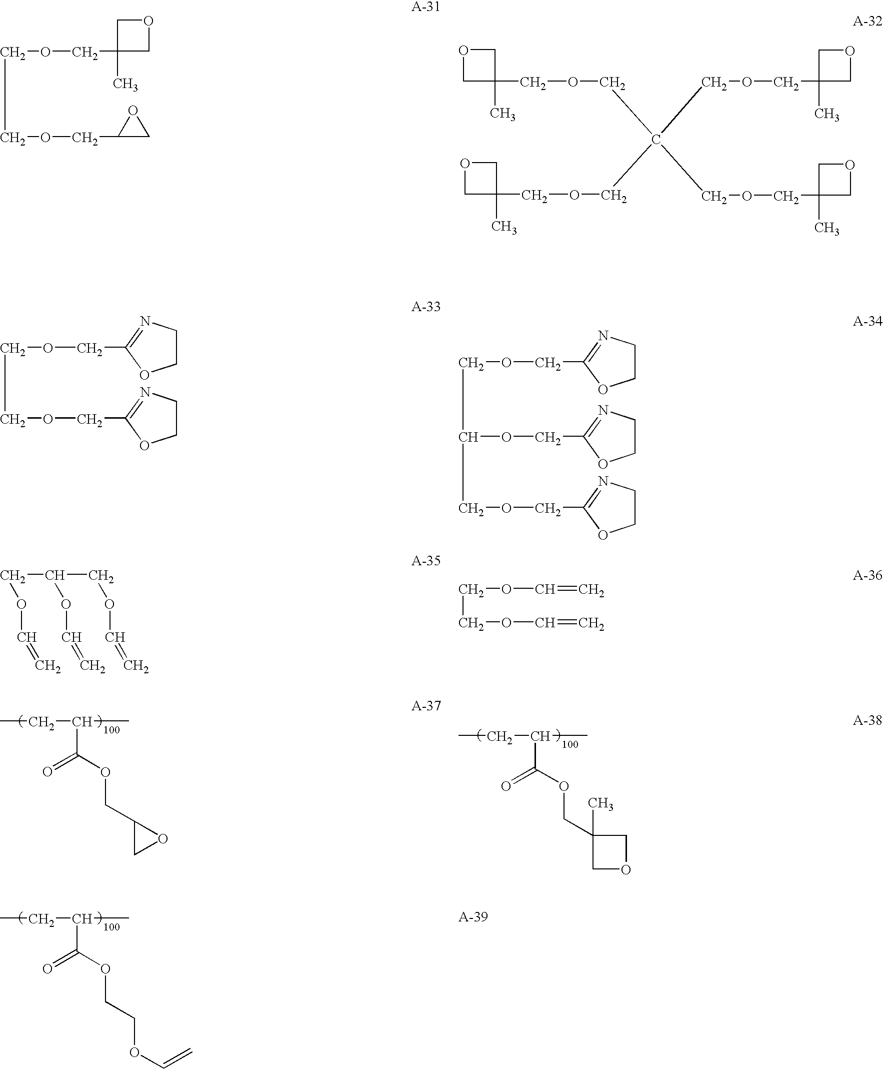

### (Amount Used of Polyfunctional Compound)

The molecular weight of this compound is not particularly limited but is preferably from 200 to 10,000, more preferably from 200 to 3,000, still more preferably from 400 to 1,500. If the molecular weight is too small, there arises a problem of volatilization in the process of forming the film, whereas if the molecular weight is excessively large, the compatibility with the fluorine-containing polymer becomes bad.

The amount added of the polyfunctional compound is preferably from 0.1 to 50 mass %, more preferably from 1 to 30 mass %, still more preferably from 3 to 20 mass %, based on the solid content forming the film.

In the film of the present invention, particularly, in the uppermost layer of the film, for example, an appropriate slipping agent such as polysiloxane-based compound can be added for the purpose of imparting properties such as water resistance, chemical resistance and slipperiness.

In the case of adding such an additive, the additive is preferably added in an amount of 0.01 to 20 mass %, more preferably from 0.05 to 10 mass %, still more preferably from 0.1 to 5 mass %, based on the entire solid content of the low refractive index layer.

### [Compound Having Polysiloxane Structure]

In the present invention, a compound having a polysiloxane structure may be used for the purpose of imparting slipperiness to thereby enhance the scratch resistance.

Preferred examples of such a compound include those containing a plurality of dimethylsilyloxy units as the repeating unit and having a substituent at the chain terminal and/or in the side chain. In the chain of the compound containing dimethylsilyloxy as the repeating unit, a structural unit other than dimethylsilyloxy may be contained. A plurality of substituents, which may be the same or different, are preferably substituted. Preferred examples of the substituent include a group containing an acryloyl group, a methacryloyl group, a vinyl group, an aryl group, a cinnamoyl group, an oxetanyl group, a fluoroalkyl group, a polyoxyalkylene group, a carboxyl group or an amino group. The molecular weight is not particularly limited but is preferably 100,000 or less, more preferably 50,000 or less, still more preferably from 3,000 to 30,000, and most preferably from 10,000 to 20,000. The silicone atom content of the silicone-based compound is not particularly limited but is preferably 18.0 mass % or more, more preferably from 25.0 to 37.0 mass %, and most preferably from 30.0 to 37.0 mass %.

Preferred examples of the silicone-based compound include, but are not limited to, X-22-160AS, X-22-162C, X-22-163C, X-22-164B, X-22-164C, X-22-170DX, X-22-173DX, X-22-174DX, X-22-176D, X-22-176DX X-22-176F, X-22-1821, X-22-2426, KF-105, KF-6001, KF-2002 and KF-6003 (all trade names), produced by Shin-Etsu Chemical Co., Ltd.; FM-0411, FM-0421, FM-0425, FM-0725, FM-1121, FM-4411, FM-4421, FM-4425, FM-5511, FM-5521, FM-5525, FM-6611, FM-6621, FM-6625, FM-7725, FM-DA11, FM-DA21 and FM-DA25 (all trade names), produced by Chisso Corporation; and CMS-626, CMS-222, DMS-U22, RMS-033, RMS-083, UMS-182, DMS-H21, DMS-H31, HMS-301, FMS121, FMS123, FMS131, FMS141 and FMS221 (all trade names), produced by Gelest.

In the present invention, a fluorine-based compound can be used in the light of improving coating properties. As for the compound, a compound having a fluoroalkyl group is preferred. The fluoroalkyl group preferably has a carbon number of 1 to 20, more preferably from 1 to 10, and may be linear (e.g., —CF₂CF₃, —CH₂(CF₂)₄H, —CH₂(CF₂)₈CF₃, —CH₂CH₂(CF₂)₄H), may have a branched structure (e.g., CH(CF₃)₂, CH₂CF(CF₃)₂, CH(CH₃)CF₂CF₃, CH(CH₃)(CF₂)₅CF₂H) or an alicyclic structure (preferably a 5- or 6-membered ring, for example, a perfluorocyclohexyl group, a perfluorocyclopentyl group or an alkyl group substituted by such a group), or may have an ether bond (e.g., CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H). A plurality of fluoroalkyl groups may be contained within the same molecule.

The fluorine-based compound preferably further has a substituent which contributes to the bond formation or compatibility with the low refractive index layer film. A plurality of substituents, which may be the same or different, are preferably present. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine-based compound may be a polymer or oligomer with a compound not containing a fluorine atom, and the molecular weight is not particularly limited. The fluorine atom content of the fluorine-based compound is not particularly limited but is preferably 20 mass % or more, more preferably from 30 to 70 mass %, and most preferably from 40 to 70 mass %. Preferred examples of the fluorine-based compound include, but are not limited to, R-2020, M-2020, R-3833 and M-3833 (all trade names), produced by Daikin Kogyo Co., Ltd.; and Megafac F-171, F-172, F-179A and DYFENSA MCF-300 (all trade names), produced by Dai-Nippon Ink & Chemicals, Inc.

For the purpose of imparting properties such as dust protection and antistatic property, a known cationic surfactant or polyoxyalkylene-based compound may be appropriately added as a dust inhibitor, an antistatic agent or the like. A structural unit of such a dust inhibitor or antistatic agent may be contained as a part of the function in the above-described silicone-based compound or fluorine-based compound. In the case of adding such an additive, the additive is preferably added in an amount of 0.01 to 20 mass %, more preferably from 0.05 to 10 mass %, still more preferably from 0.1 to 5 mass %, based on the entire solid content of the low refractive index layer. Preferred examples of the compound include, but are not limited to, Megafac F-150 (trade name), produced by Dai-Nippon Ink & Chemicals, Inc.; and SH-3748 (trade name), produced by Toray Dow Corning.

### [Various Evaluations of Low Refractive Index Layer]

### (Evaluation of Surface Segregation Degree of Silicon Atom)

The method for measuring the segregation of silicon atom on the surface of the low refractive index layer is described below.

Using each antireflection film, the photoelectron spectra of Si₂ₚ and C₁ₛ on the outermost surface are measured by “ESCA-3400” manufactured by Shimadzu Corporation (vacuum degree: 1×10⁻⁵ Pa, X-ray source: target Mg, voltage: 12 kV, current: 20 mA). The signal intensity ratio Si₂ₚ/C₁ₛ thereof is defined as Si(a) on the outermost surface.

The low refractive index layer is etched by the associated ion etching device (ion gun, voltage: 2 kV, current 20 mA) of “ESCA-3400”, the photoelectron spectra of a deeper portion at a depth corresponding to 80% of the thickness of the low refractive index from the surface are measured, and the intensity ratio Si₂ₚ/C₁ₛ is calculated. This value is defined as Si_{(b)}.

A preliminary test of gradually shaving down the low refractive index layer surface under various etching conditions is performed in advance and based on the etching conditions necessary for reaching a lower layer, the condition of giving a depth of 80% from the surface is determined and the spectra are measured.

The antireflection film of the present invention is characterized in that the Si₍ₐ₎/Si_{(b)} value in the low refractive index layer is 5.0 or more. The Si₍ₐ₎/Si_{(b)} value is preferably 6.0 or more and most preferably 7.0 or more. When silicon atom is not present in the deeper portion at a depth corresponding to 80% of the thickness of the low refractive index layer from the surface thereof, the Si(a/Si(b) value becomes infinity. When the value is large, this reveals that silicone is present on the surface. By specifying this value to the above-described range, a desired antifouling property is obtained. Furthermore, the low refractive index layer can also serve as an antifouling layer without further providing an antifouling layer on the low refractive index layer. Incidentally, as for C₁ₛ, the intensity is determined at each peak position of the photoelectron spectrum and as for Si₂ₚ, the intensity at the peak position originated in silicon atom of the silicone (polydimethylsiloxane) (where the binding energy is in the vicinity of 105 eV) is used and distinguished from the Si atom originated in an inorganic silica particle. As described in [Curing Method of Low Refractive Index Layer] later, Si₍ₐ₎/Si_{(b)} is effectively set in the above-mentioned range by combining irradiation of ionizing radiation and a heat treatment.

### (Surface Free Energy)

The surface free energy (γₛᵥ, unit: mN/m) of the antireflection film of the present invention is defined as the surface tension of the antireflection film, which is calculated as a value γₛᵥ (=γ_{sd}+γₛₕ), that is, a sum of γ_{sd} and γₛₕ determined according to the following simultaneous equations (1) and (2) from respective contact angles θ_{H2O} and θ_{CH2I2} with pure water H₂O and methylene iodide CH₂I₂ experimentally determined on the antireflection film by referring to D. K. Owens, J. Appl. Polym. Sci., Vol. 13, page 1741 (1969). As the γₛᵥ is smaller and the surface free energy is lower, the repelling property on the surface is higher and the antifouling property is generally more excellent. The surface free energy of the antireflection film is preferably 25 mN/m or less, more preferably 20 mN/m or less.

1+cos θ_{H2O}=2√γ_{sd}(√γ_{H2Od}/γ_{H2Ov})+2γₛₕ(√γ_{H2Oh}/γ_{H2Ov}) (1)

1+cos θ_{CH2I2}=2√γ_{sd}(√γ_{CH2I2d}/γ_{CH2I2v})+2√γₛₕ(√γ_{CH2I2h}/γ_{CH2I2v}) (2)

γ_{H2Od}=21.8, γ_{H2Oh}=51.0 γ_{H2Ov}=72.8, γ_{CH2I2d}=49.5, γ_{CH2I2h}=1.3 and γ_{CH2I2v}=50.8, and the contact angle is measured under the conditions of 25° C. and 60% RH after moisture conditioning of the antireflection film with the same conditions for 1 hour or more.

### [Fine Particle]

The inorganic fine particle which can be preferably used in the low refractive index layer of the present invention is described below.

The amount coated of the inorganic fine particle is preferably from 1 to 100 mg/m², more preferably from 5 to 80 mg/m², still more preferably from 10 to 60 mg/m². When the amount coated of the fine particle is the above-described lower limit or more, the scratch resistance is remarkably improved, and when the coated amount is the upper limit or less, this advantageously ensures that fine irregularities are not generated on the low refractive index layer surface and the appearance (e.g., real black) or integrated reflectance is not worsened. This fine particle is contained in the low refractive index layer and therefore, preferably has a low reflective index.

The fine particle is preferably an inorganic oxide particle and in view of colorlessness of the obtained low refractive index layer, the inorganic oxide fine particle is preferably an oxide particle of at least one element selected from the group consisting of silicon, aluminum, zirconium, titanium, zinc, germanium, indium, tin, antimony and cerium.

Examples of the inorganic fine particle include an oxide particle such as silica, magnesium fluoride, alumina, zirconia, titanium oxide, zinc oxide, germanium oxide, indium oxide, tin oxide, antimony-doped tin oxide (ATO) tin-doped indium oxide (ITO), antimony oxide and cerium oxide. Among these, particles of silica, alumina, zirconia and antimony oxide are preferred in view of high hardness. One of these inorganic fine particles may be used alone or two or more thereof may be used in combination.

Furthermore, the inorganic fine particle is preferably used as an organic solvent dispersion. In the case of using the inorganic fine particle as an organic solvent dispersion, the dispersion medium is preferably an organic solvent in view of compatibility with other components and dispersibility.

Examples of such an organic solvent include alcohols such as methanol, ethanol, isopropanol, butanol and octanol; ketones such as acetone, methyl ethyl ketone, methyl isobutyl ketone and cyclohexanone; esters such as ethyl acetate, butyl acetate, ethyl lactate, γ-butyrolactone, propylene glycol monomethyl ether acetate and propylene glycol monoethyl ether acetate; ethers such as ethylene glycol monomethyl ether and diethylene glycol monobutyl ether; aromatic hydrocarbons such as benzene, toluene and xylene; and amides such as dimethylformamide, dimethylacetamide and N-methylpyrrolidone. Among these, preferred are methanol, isopropanol, butanol, methyl ethyl ketone, methyl isobutyl ketone, ethyl acetate, butyl acetate, toluene and xylene.

The number average particle diameter of the oxide particle is preferably from 1 to 200 nm, more preferably from 3 to 150 nm, still more preferably from 5 to 100 nm. When the number average particle diameter is 200 nm or less, this advantageously ensures no occurrence of a trouble such as reduction in the transparency when a cured product is produced or deterioration in the surface state when a coat is formed. In order to improve the dispersibility of particles, various surfactants or amines may also be added.

Examples of the commercial product available as a liquid dispersion of the silicon oxide particle (e.g., silica particle) include, as a colloidal silica, a silica sol such as “MA-ST-MS”, “IPA-ST”, “IPA-ST-MS”, ““PA-ST-L”, “IPA-ST-ZL”, “IPA-ST-UP”, “EG-ST”, “NPC-ST-30”, “MEK-ST”, “MEK-ST-L”, “MIBK-ST”, “NBA-ST”, “XBA-ST”, “DMAC-ST”, “ST-UP”, “ST-OUP”, “ST-20”, “ST-40”, “ST-C”, “ST-N”, “ST-O”, “ST-50” and “ST-OL” produced by Nissan Chemical Industries, Ltd.; and a hollow silica such as “CS60-IPA” produced by Catalysts & Chemicals Industries Co., Ltd. Other examples include, as a powder silica, “Aerosil 130”, “Aerosil 300”, “Aerosil 380”, “Aerosil TT600” and “Aerosil OX50” produced by Nippon Aerosil Co., Ltd.; “Sildex H31, H32, H51, H52, H121 and H122” produced by Asahi Glass Co., Ltd.; “E220A”, “E220”, “SS-50”, “SS50A” and “SS-50F” produced by Nippon Silica Kogyo K.K.; “SYLYSIA 470” produced by Fuji Silysia Chemical Ltd.; and “SG Flake” produced by Nippon Sheet Glass Co., Ltd.

Still other examples include, as a water dispersion of alumina, “Alumina Sol-100, -200 and -520” produced by Nissan Chemical Industries, Ltd.; as an isopropanol dispersion of alumina, “AS-150I” produced by Sumitomo Osaka Cement Co., Ltd.; as a toluene dispersion of alumina, “AS-150T” produced by Sumitomo Osaka Cement Co., Ltd.; as a toluene dispersion of zirconia, “HXU-110JC” produced by Sumitomo Osaka Cement Co., Ltd.; as a water dispersion of zinc antimonate powder, “Celnax” produced by Nissan Chemical Industries, Ltd.; as a powder or solvent dispersion of alumina, titanium oxide, tin oxide, indium oxide or zinc oxide, “NanoTek” produced by C.I. Kasei Co., Ltd.; as a water dispersion sol of ATO, “SN-100D” produced by Ishihara Sangyo Kaisha, Ltd.; as an ITO powder, a product produced by Mitsubishi Materials Corp.; and as a water dispersion of cerium oxide, Needral produced by Taki Chemical Co., Ltd.

The shape of the oxide particle is spherical, hollow, porous, bar-like, plate-like, fibrous, chain-like, pearl necklace-like or amorphous, preferably spherical or hollow. The hollow silica particle is described later. The specific surface area of the inorganic fine particle (as measured by the BET specific surface area measuring method using nitrogen) is preferably from 10 to 1,000 m²/g, more preferably from 20 to 500 m²/g, and most preferably from 50 to 300 m²/g. This inorganic oxide particle may be used by dispersing its powder in the dry state in an organic solvent but, for example, a liquid dispersion of fine particulate oxide particle, known in the art as a solvent dispersion sol of the above-described oxide, may be used directly.

### (Hollow Silica Particle)

In the low refractive index layer of the antireflection film of the present invention, a hollow inorganic fine particle having a low refractive index layer is preferably used. The hollow silica particle is described below.

The hollow silica fine particle preferably has a refractive index of 1.15 to 1.40, more preferably from 1.15 to 1.35, and most preferably from 1.17 to 1.30. The refractive index as used herein indicates a refractive index of the particle as a whole and does not indicate a refractive index of only the outer shell silica forming the hollow silica particle. At this time, assuming that the radius of the cavity inside the particle is rᵢ and the radius of the outer shell of the particle is rₒ, the porosity x is represented by the following mathematical formula (1). The porosity x of the hollow silica particle is preferably from 10 to 60%, more preferably from 20 to 60%, and most preferably from 30 to 60%.

x=(rᵢ/rₒ)³×100 Mathematical formula (1)

The average particle diameter of the hollow silica fine particle can be measured from an electron microphotograph.

If the hollow silica fine particle is rendered to have a lower refractive index and a larger porosity, the thickness of the outer shell becomes small and the strength as a particle decreases. Therefore, in view of scratch resistance, the refractive index of the hollow silica particle is usually 1.17 or more.

The production method of the hollow silica particle is described, for example, in JP-A-2001-233611 and JP-A-2002-79616. The hollow silica particle for use in the present invention is preferably a particle having a cavity inside the outer shell, where the pore of the outer shell is closed. Incidentally, the refractive index of such a hollow silica particle can be calculated by the method described in JP-A-2002-79616.

The average particle diameter of the hollow silica is preferably from 30 to 150%, more preferably from 35 to 80%, still more preferably from 40 to 60%, of the thickness of the low refractive index layer. In other words, when the thickness of the low refractive index layer is 100 nm, the particle diameter of the hollow silica is preferably from 30 to 150 nm, more preferably from 35 to 100 nm, still more preferably from 40 to 65 nm. When the particle diameter of the silica fine particle is the above-described lower limit or more, the proportion of the cavity part is appropriate and the refractive index may be advantageously decreased, and when the particle diameter is the upper limit or less, there arises no trouble such as generation of fine irregularities on the low refractive index layer surface to deteriorate the appearance (e.g., real black) or integrated reflectance, and this is preferred. The silica fine particle may be either crystalline or amorphous and is preferably a monodisperse particle. The shape is most preferably spherical but even if amorphous, this causes no problem.

Two or more kinds of hollow silica particles differing in the average particle size may be used in combination. The average particle diameter of the hollow silica can be determined from an electron microphotograph.

In the present invention, the specific surface area of the hollow silica is preferably from 20 to 300 m²/g, more preferably from 30 to 120 m²/g, and most preferably from 40 to 90 m²/g. The specific surface area can be determined by the BET method using nitrogen.

In the present invention, a silica particle not having a cavity may be used in combination with the hollow silica. The particle size of the silica not having a cavity is preferably from 30 to 150 nm, more preferably from 35 to 100 nm, and most preferably from 40 to 80 nm.

### (Silica Fine Particle Having Small Particle Size)

Also, at least one silica fine particle having an average particle diameter of less than 25% of the thickness of the low refractive index layer (this particle is referred to as a “small particle-size silica fine particle”) may be used in combination with the silica fine particle having the above-described particle diameter (this particle is referred to as a “large particle-size silica fine particle”).

The small particle-size silica fine particle can be present in a space between large particle-size silica fine particles and therefore, can contribute as a holding agent for the large particle-size silica fine particle.

The average particle diameter of the small particle-size silica fine particle is preferably from 1 to 20 nm, more preferably from 5 to 15 nm, still more preferably from 10 to 15 nm. Use of such a silica fine particle is preferred in view of the raw material cost and the holding agent effect.

### (Surface Treatment of Inorganic Fine Particle)

The inorganic fine particle which can be used in the low refractive index layer of the present invention may be subjected to a physical surface treatment such as plasma discharge treatment and corona discharge treatment, or a chemical surface treatment with a surfactant, a coupling agent or the like, so as to stabilize the dispersion in a liquid dispersion or a coating solution or to enhance the affinity for or the binding property with a binder component.

The inorganic fine particle is preferably surface-treated with a hydrolysate of an organosilane represented by the following formula (3) and/or a partial condensate thereof and at the treatment, it is preferred to use either one or both of an acid catalyst and a metal chelate compound.

(R³⁰)ₘ₁Si(X³¹)₄₋ₘ₁ Formula (3)

wherein R³⁰ represents a substituted or unsubstituted alkyl group or a substituted or unsubstituted aryl group, X³¹ represents a hydroxyl group or a hydrolyzable group, and m1 represents an integer of 1 to 3.

The dispersibility improving treatment of the inorganic fine particle is performed by contacting an organosilane, an inorganic oxide fine particle and if desired, water in the presence of at least either one of a catalyst having a hydrolysis function and a metal chelate compound having a condensation function. The organosilane may be partially hydrolyzed or partially condensed. The organosilane undergoes partial condensation subsequent to hydrolysis and thereby modifies the surface of the inorganic oxide fine particle, as a result, the dispersibility is enhanced and a stable liquid dispersion of inorganic oxide fine particles is obtained.

### (Metal Chelate Compound)

As for the metal chelate compound, any metal chelate compound may be suitably used without particular limitation as long as an alcohol represented by the following formula (4-1) and a compound represented by the following formula (4-2) are present as ligands and the center metal is a metal selected from Zr, Ti and Al. Within this category, two or more kinds of metal chelate compounds may be used in combination.

R⁴¹OH Formula (4-1)

R⁴²COCH₂COR⁴³ Formula (4-2)

In formulae, R⁴¹ and R⁴², which may be the same or different, each represents an alkyl group having a carbon number of 1 to 10, and R⁴³ represents an alkyl group having a carbon number of 1 to 10 or an alkoxy group having a carbon number of 1 to 10.

### [Organosilane Compound]

In the antireflection film of the present invention, either the low refractive index layer or a layer lower than the low refractive index layer preferably contains at least either a hydrolysate of an organosilane represented by the following formula (3) or a partial condensate thereof, the organosilane being produced in the presence of at least either an acid catalyst or a metal chelate compound. This organosilane compound is described in detail below.

(R³⁰)ₘ₁—Si(X³¹)₄₋ₘₗ Formula (3)

In formula (3), R³⁰ represents a substituted or unsubstituted alkyl group or a substituted or unsubstituted aryl group. Examples of the alkyl group include a methyl group, an ethyl group, a propyl group, an isopropyl group, a hexyl group, a hexyl group, a tert-butyl group, a sec-butyl group, a hexyl group, a decyl group and a hexadecyl group. The alkyl group is preferably an alkyl group having a carbon number of 1 to 30, more preferably from 1 to 16, still more preferably 1 to 6. Examples of the aryl group include a phenyl group and a naphthyl group, with a phenyl group being preferred.

X³¹ represents a hydroxyl group or a hydrolyzable group. Examples of the hydrolyzable group include an alkoxy group (preferably an alkoxy group having a carbon number of 1 to 5, such as methoxy group and ethoxy group), a halogen atom (e.g., Cl, Br, I) and a R³²COO group (wherein R³² is preferably a hydrogen atom or an alkyl group having a carbon number of 1 to 5; such as CH₃COO and C₂H₅COO). Among these, an alkoxy group is preferred, and a methoxy group and an ethoxy group are more preferred.

m1 represents an integer of 1 to 3. When a plurality of R³⁰'s or X³¹'s are present, the plurality of R³⁰'s or X³¹'s may be the same or different. m1 is preferably 1 or 2, more preferably 1.

The substituent contained in R³⁰ is not particularly limited, but examples thereof include a halogen atom (e.g., fluorine, chlorine, bromine), a hydroxyl group, a mercapto group, a carboxyl group, an epoxy group, an alkyl group (e.g., methyl, ethyl, i-propyl, propyl, tert-butyl), an aryl group (e.g., phenyl, naphthyl), an aromatic heterocyclic group (e.g., furyl, pyrazolyl, pyridyl), an alkoxy group (e.g., methoxy, ethoxy, i-propoxy, hexyloxy), an aryloxy group (e.g., phenoxy), an alkylthio group (e.g., methylthio, ethylthio), an arylthio group (e.g., phenylthio), an alkenyl group (e.g., vinyl, 1-propenyl), an acyloxy group (e.g., acetoxy, acryloyloxy, methacryloyloxy), an alkoxycarbonyl group (e.g., methoxycarbonyl, ethoxy-carbonyl), an aryloxycarbonyl group (e.g., phenoxycarbonyl), a carbamoyl group (e.g., carbamoyl, N-methylcarbamoyl, N,N-dimethylcarbamoyl, N-methyl-N-octylcarbamoyl) and an acylamino group (e.g., acetylamino, benzoylamino, acrylamino, methacrylamino). These substituents each may be further substituted. Incidentally, in the present invention, even when the hydrogen atom is substituted by a single atom, for the sake of convenience, this is referred to as a substituent.

When a plurality of R³⁰'s are present, at least one is preferably a substituted alkyl group or a substituted aryl group. Particularly, the substituted alkyl group or substituted aryl group preferably further has a vinyl polymerizable group and in this case, the compound represented by formula (3) can be expressed as an organosilane compound having a vinyl polymerizable substituent represented by the following formula (3-1):

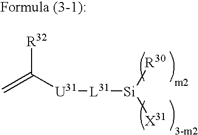

In formula (3-1), R³² represents a hydrogen atom, a methyl group, a methoxy group, an alkoxycarbonyl group, a cyano group, a fluorine atom or a chlorine atom. Examples of the alkoxycarbonyl group include a methoxycarbonyl group and an ethoxycarbonyl group. R³² is preferably a hydrogen atom, a methyl group, a methoxy group, a methoxycarbonyl group, a cyano group, a fluorine atom or a chlorine atom, more preferably a hydrogen atom, a methyl group, a methoxycarbonyl group, a fluorine atom or a chlorine atom, still more preferably a hydrogen atom or a methyl group.

U³¹ represents a single bond, an ester group, an amido group, an ether group or a urea group. U³¹ is preferably a single bond, an ester group or an amido group, more preferably a single bond or an ester group, still more preferably an ester group.

L³¹ represents a divalent linking chain. Specific examples thereof include a substituted or unsubstituted alkylene group, a substituted or unsubstituted arylene group, a substituted or unsubstituted alkylene group having in the inside thereof a linking group (e.g., ether, ester, amido), and a substituted or unsubstituted arylene group having in the inside thereof a linking group. L³¹ is preferably a substituted or unsubstituted alkylene group having a carbon number of 2 to 10, a substituted or unsubstituted arylene group having a carbon number of 6 to 20, or a substituted or unsubstituted alkylene group having in the inside thereof a linking group and having a carbon number of 3 to 10, more preferably an unsubstituted alkylene group, an unsubstituted arylene group or an alkylene group having in the inside thereof an ether or ester linking group, still more preferably an unsubstituted alkylene group or an alkylene group having in the inside thereof an ether or ester linking group. Examples of the substituent include a halogen, a hydroxyl group, a mercapto group, a carboxyl group, an epoxy group, an alkyl group and an aryl group. These substituents each may be further substituted.

m2 represents 0 or 1. When a plurality of X³¹'s are present, the plurality of X³¹'s may be the same or different. m2 is preferably 0.

R³⁰ has the same meaning as R³¹ in formula (3) and is preferably a substituted or unsubstituted alkyl group or an unsubstituted aryl group, more preferably an unsubstituted alkyl group or an unsubstituted aryl group.

X³¹ has the same meaning as X³¹ in formula (3) and is preferably a halogen, a hydroxyl group or an unsubstituted alkoxy group, more preferably chlorine, a hydroxyl group or an unsubstituted alkoxy group having a carbon number of 1 to 6, still more preferably a hydroxyl group or an alkoxy having a carbon number of 1 to 3, yet still more preferably a methoxy group.

The organosilane compound for use in the present invention is preferably represented by the following formula (3-2):

(R_{f}³¹-L³²)ₘ₃-Si(R³³)ₘ₃₋₄ Formula (3-2)

In formula (3-2), R_{f}³¹ represents a linear, branched or cyclic fluorine-containing alkyl group having a carbon number of 1 to 20 or a fluorine-containing aromatic group having a carbon number of 6 to 14. R_{f}³¹ is preferably a linear, branched or cyclic fluoroalkyl group having a carbon number of 3 to 10, more preferably a linear fluoroalkyl group having a carbon number of 4 to 8. L³² represents a divalent linking group having a carbon number of 10 or less, preferably an alkylene group having a carbon number of 1 to 10, more preferably an alkylene group having a carbon number of 1 to 5. The alkylene group is a linear or branched, substituted or unsubstituted alkylene group which may have in the inside thereof a linking group (e.g., ether, ester, amido). The alkylene group may have a substituent and in this case, preferred examples of the substituent include a halogen atom, a hydroxyl group, a mercapto group, a carboxyl group, an epoxy group, an alkyl group and an aryl group. R³³ represents a hydroxyl group or a hydrolyzable group, preferably an alkoxy group having a carbon number of 1 to 5 or a halogen atom, more preferably a methoxy group, an ethoxy group or a chlorine atom. m3 represents an integer of 1 to 3.

In particular, the fluorine-containing organosilane compound represented by formula (3-2) is preferably a fluorine-containing organosilane compound represented by the following formula (3-3):

CₙF₂ₙ₊₁—(CH₂)ₜ₆—Si(R³⁴)₃ Formula (3-3)

In formula (3-3), n represents an integer of 1 to 10, t6 represents an integer of 1 to 5, and R³⁴ represents an alkoxy group having a carbon number of 1 to 5 or a halogen atom. n is preferably an integer of 4 to 10, t6 is preferably an integer of 1 to 3, and R³⁴ is preferably a methoxy group, an ethoxy group or a chlorine atom.

Two or more kinds of the compounds represented by formulae (3) may be used in combination. Specific examples of the compound represented by formula (3) are set forth below, but the present invention is not limited thereto.

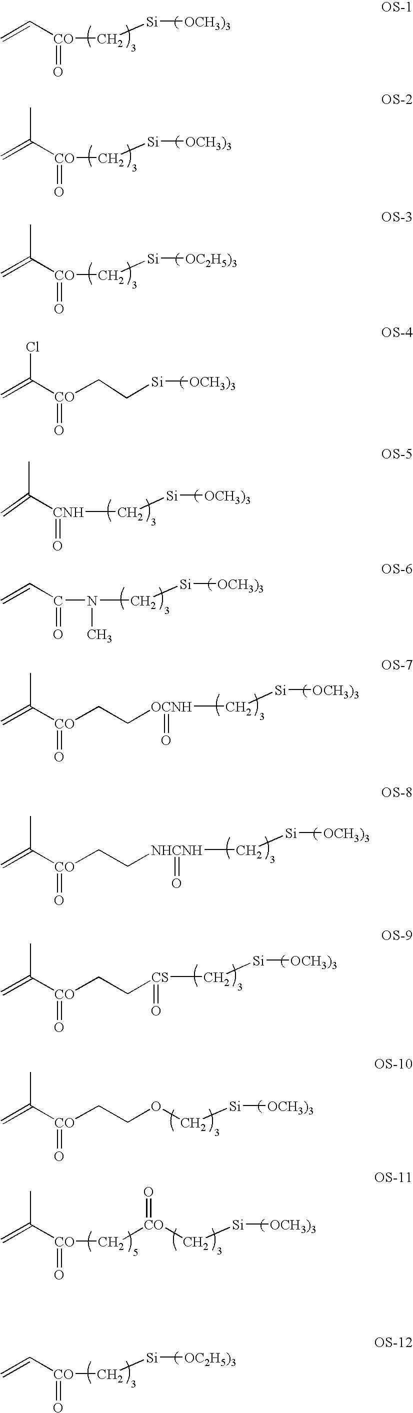

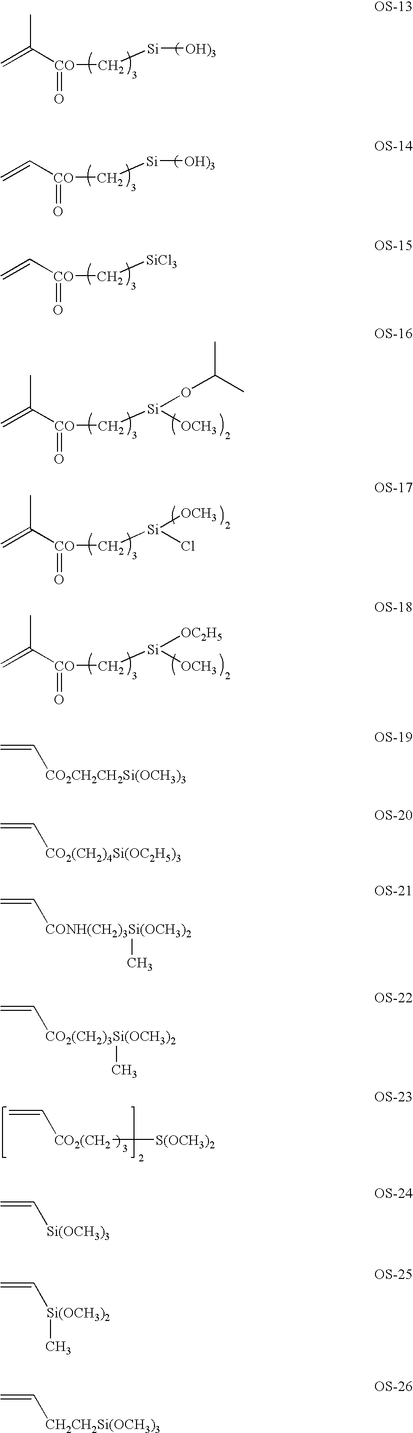

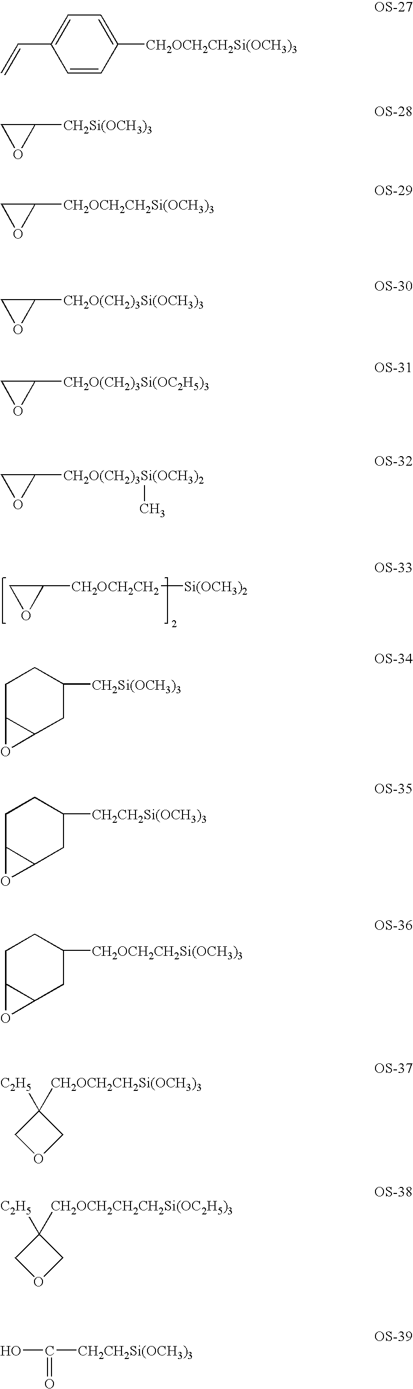

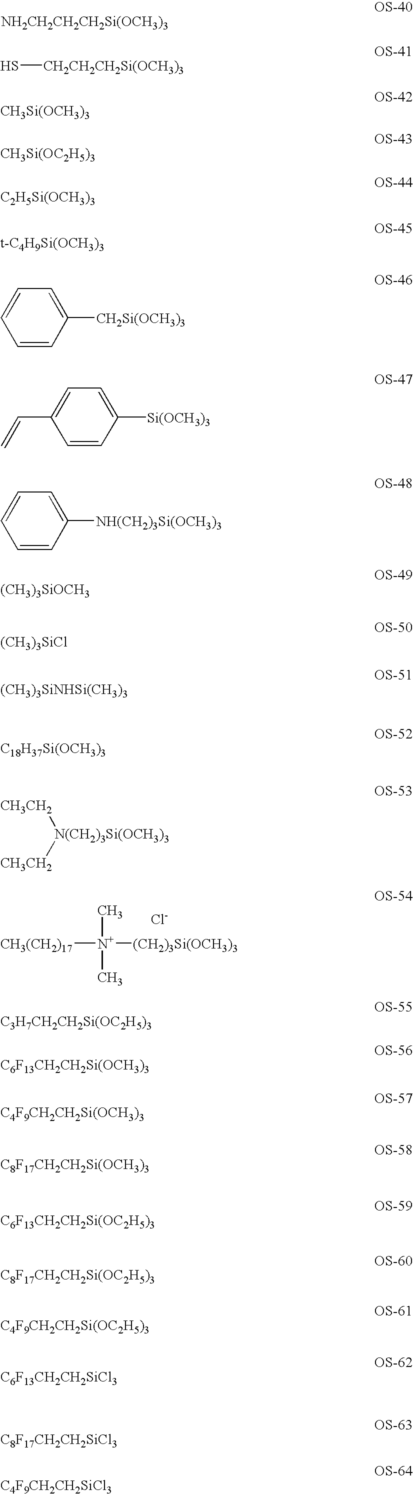

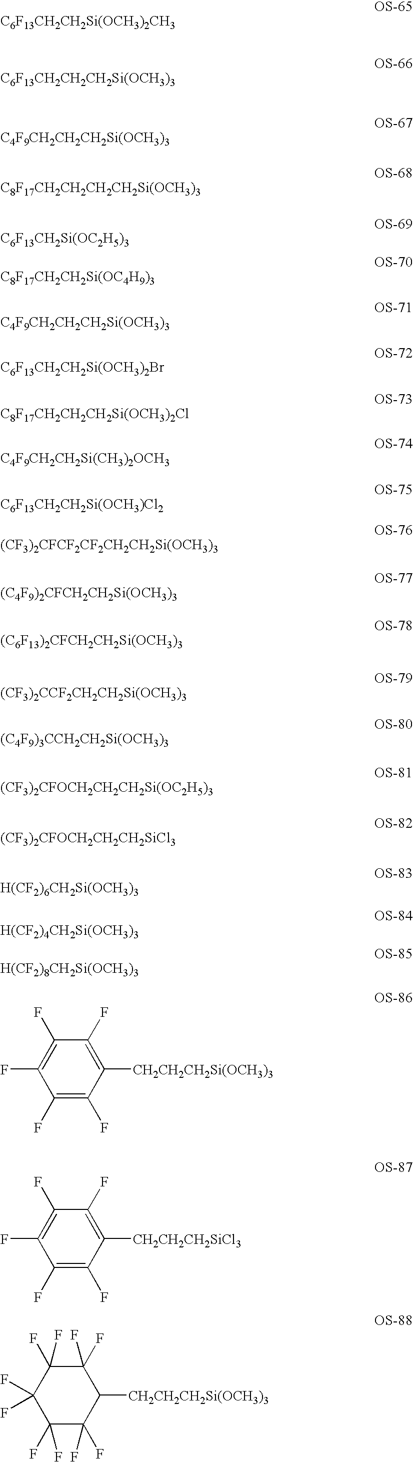

Among these specific examples, (OS-1), (OS-2), (OS-56) and (OS-57) are preferred. In addition, Compounds A, B and C described as reference examples in Japanese Patent No. 3,474,330 are also preferred because of excellent dispersion stability.

In the present invention, the amount used of the organosilane compound represented by formula (3) is not particularly limited but is preferably from 1 to 300 mass %, more preferably from 3 to 100 mass %, most preferably from 5 to 50 mass %, per the inorganic fine particle, and is preferably from 1 to 300 mol %, more preferably from 5 to 300 mol %, most preferably from 10 to 200 mol %, per the normal concentration (formol) based on the hydroxyl group on the inorganic oxide surface. When the amount used of the organosilane compound is in this range, a sufficiently high effect of stabilizing the liquid dispersion can be obtained and the film strength is also increased at the formation of coating film.

Use of plural kinds of organosilane compounds in combination is also preferred, and the plural kinds of compounds may be simultaneously added or may be reacted by adding these at different timings. Furthermore, when plural kinds of compounds are previously formed into a partial condensate and then added, the control of reaction is easy and this is preferred.

(Layer where Organosilane Compound is Used)

In the present invention, at least either the above-described organosilane or a hydrolysate or hydrolysis condensate thereof is preferably used in at least either the low refractive index layer or a layer lower than the low refractive index layer. As for the hydrolysis of the organosilane compound and the condensation thereof, an acid catalyst and/or a metal chelate compound described above regarding the inorganic fine particle are preferably used.

In the case of using the organosilane compound in the low refractive index, the amount used thereof is preferably from 1 to 95 mass %, more preferably from 2 to 70 mass %, most preferably from 2 to 45%, per the solid content constituting the low refractive index. In the case of using the organosilane compound in a layer adjacent to the low refractive index layer, the amount used thereof is preferably from 0.1 to 70 mass %, more preferably from 0.2 to 50 mass %, most preferably from 1 to 30%, per the solid content constituting the layer adjacent to the low refractive index layer.

### [Curing Method of Low Refractive Index Layer]

In the method for producing an antireflection film of the present invention, after a coating composition for the formation of a low refractive index layer comprising a resin curable upon irradiation with ionizing radiation and a compound having a polysiloxane partial structure or a fluoroalkyl group is coated on a support, the coating is cured by combining irradiation of ionizing radiation and a heat treatment before, simultaneous with or after the irradiation, thereby effectively set Si(a)/Si(b) in the above-mentioned range. Several patterns of the production process are shown below, but the present invention is not limited thereto.
Before Irradiation→Simultaneous with Irradiation→After Irradiation (“-” means that a heat treatment is not performed.)
   (1) heat treatment→ionizing radiation curing→
   (2) heat treatment→ionizing radiation curing→heat treatment
   (3) -→ionizing radiation curing→heat treatment

Other than these, a process of performing a heat treatment simultaneously with the ionizing radiation curing is also preferred.

### (Heat Treatment)

In the present invention, as described above, a heat treatment is preferably performed in combination with the irradiation of ionizing radiation. The heat treatment is not particularly limited as long as the status of various components present in the region from the interface between the low refractive index layer and a layer lower than that to the surface of the low refractive index is changed, but is preferably performed at 60 to 200° C., more preferably from 80 to 130° C., and most preferably from 80 to 110° C.

In the present invention, by elevating the heat treatment temperature, a polysiloxane-based component or a fluorine-containing component, which decreases the surface free energy, can be promoted to align in the vicinity of the low refractive index layer surface. Each component is not in the fixed state before curing by the irradiation of ionizing radiation and the above-described alignment relatively swiftly proceeds, but after curing by the irradiation of ionizing radiation, each component is fixed and the alignment takes place only partially. The time period necessary for the heat treatment varies depending on, for example, the molecular weight of the component used, the interaction with other components, or the viscosity, but the heat treatment time is usually from 30 seconds to 24 hours, preferably from 60 seconds to 5 hours, and most preferably from 3 to 30 minutes.

The method for adjusting the film surface temperature to a desired temperature is not particularly limited, but preferred examples thereof include a method of heating a roll and contacting it with the film, a method of blowing heated nitrogen, and irradiation with a far infrared ray or an infrared ray. A method of flowing hot water or vapor to a rotating metal roll, thereby effecting heating, described in Japanese Patent No. 2,523,574 may also be used. On the other hand, at the irradiation of ionizing radiation described below, when the film surface temperature is elevated, a method of cooling a roll and contacting it with the film may be utilized.

### (Irradiation Conditions of Ionizing Radiation)

The film surface temperature at the irradiation of ionizing radiation is not particularly limited but in view of handleability and uniformity of performance in the plane, the film surface temperature is generally from 20 to 200° C., preferably from 30 to 150° C., and most preferably from 40 to 120° C. When the film surface temperature is the above-described upper limit or less, this advantageously ensures no occurrence of a problem that the flowability of a low molecular component in the binder is excessively elevated to worsen the surface state or the support is damaged due to heat. Also, when the film surface temperature is the lower limit or more, satisfactory progress of the curing reaction and good scratch resistance of the film are attained and this is preferred.

The ionizing radiation is not particularly limited in its type and examples thereof include X-ray, electron beam, ultraviolet ray, visible light and infrared ray. An ultraviolet ray is widely used. For example, when the coating film is ultraviolet-curable, each layer is preferably cured by irradiating an ultraviolet ray at an irradiation dose of 10 to 1,000 mJ/cm² from an ultraviolet lamp. At the irradiation, this energy may be applied at a time or may be irradiated in installments. Particularly, from the standpoint of reducing the fluctuation of performance in the plane of the coating film, irradiation approximately in 2 to 8 installments is also preferred.

The time period for which the film after irradiation of ionizing radiation is kept at the above-described temperature is preferably from 0.1 to 300 seconds, more preferably from 0.1 to 10 seconds, after the completion of irradiation of ionizing radiation. If the time period for which the film surface temperature is kept in the above-described temperature range is too short, the reaction of the coating composition for the formation of the low refractive index layer, which is forming a film, cannot be accelerated, whereas if it is too long, there arises a problem in view of production, such as increase in the size of equipment.

### (Oxygen Concentration)

The oxygen concentration at the irradiation of ionizing radiation is preferably 3 vol % or less, more preferably 1 vol % or less, still more preferably 0.1% or less. When a step of keeping the film in an atmosphere having an oxygen concentration of 3 vol % or less is provided immediately before or immediately after the step of irradiating ionizing radiation at an oxygen concentration of 3 vol % or less, this ensures that the curing of film can be satisfactorily promoted and a film excellent in the physical strength and chemical resistance can be formed.

The heat treatment can be conducted at atmospheric pressure, and also the heat treatment is preferably conducted with lowered oxygen concentration at the same as in irradiation of ionizing radiation. In particular, in the case where thermal stability of the polymerization initiator or the polymerizable compound is insufficient, it is possible that the strength of fill after all curing steps is kept strong by conducting the heat treatment with lowered oxygen concentration.

The reduction of oxygen concentration is preferably performed by displacing the atmosphere (nitrogen concentration: about 79 vol %, oxygen concentration: about 21 vol %) with another inactive gas, more preferably with nitrogen (nitrogen purging). When the film is transported in an atmosphere having a low oxygen concentration before the step of irradiating ionizing radiation, the oxygen concentration on the surface and in the inside of the coating film can be effectively decreased and the curing can be accelerated. The oxygen concentration in the transportation step before irradiation of ionizing radiation is preferably 3 vol % or less, more preferably 1 vol % or less, still more preferably 0.1% or less.

### (Polymerization Initiator)

The polymerization of the binder for use in the present invention may be performed by irradiating ionizing radiation or applying heat in the presence of a photoradical initiator or a thermal radical initiator.

### (Photoradical Initiator)

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borates, active esters, active halogens, inorganic complexes and coumarins.

Examples of the acetophenones include 2,2-dimethoxyacetophenone, 2,2-diethoxyacetophenone, p-dimethylacetophenone, 1-hydroxydimethyl phenyl ketone, 1-hydroxydimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, 4-phenoxydichloroacetophenone and 4-tert-butyldichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′,4,4′-tetra(tert-butylperoxycarbonyl)benzophenone.

Examples of the phosphine oxides include 2,4,6-trimethylbenzoyldiphenylphosphine oxide. Examples of the active esters include 1,2-octanedione, 1-[4-(phenylthio)-2-(O-benzoyloxime)], sulfonic acid esters and cyclic active ester compounds. Specifically, Compounds 1 to 21 described in Examples of JP-A-2000-80068 are preferred.

Examples of the onium salts include an aromatic diazonium salt, an aromatic iodonium salt and an aromatic sulfonium salt. Examples of the borate include ion complexes with a cationic coloring matter.

As for the active halogens, an S-triazine compound and an oxathiazole compound are known, and examples thereof include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine and 2-trihalomethyl-5-(p-methoxyphenyl)-1,3,4-oxadiazole. Specific preferred examples thereof include compounds described at pages 14 to 30 of JP-A-58-15503 and at pages 6 to 10 of JP-A-55-77742, Compound Nos. 1 to 8 described at page 287 of JP-B-60-27673 (the term “JP-B” as used herein means an “examined Japanese patent publication”), Compound Nos. 1 to 17 described at pages 443 and 444 of JP-A-60-239736, and Compound Nos. 1 to 19 described in U.S. Pat. No. 4,701,399.

Examples of the inorganic complex include bis-(η⁵-2,4-cyclopentadien-1-yl)-bis[2,6-difluoro-3-(1H-pyrrol-1-yl)-phenyl]titanium. Examples of the coumarins include 3-ketocoumarin.

One of these initiators may be used alone or a mixture thereof may be used.

In the present invention, the compound having a high molecular weight and being difficult to volatilize and dissipate from the coating film is preferably an oligomer-type polymerization initiator. The oligomer-type polymerization initiator is not particularly limited as long as it has a site of generating a photoradical upon irradiation with radiation. Specific examples of the oligomer-type radiation polymerization initiator include an oligo[2-hydroxy-2-methyl-1-{4-(1-methylvinyl)phenyl}propane] represented by the following formula (5).

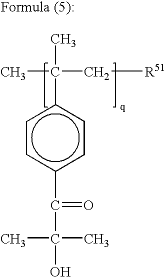

In formula (5), R⁵¹ represents a monovalent group, preferably a monovalent organic group, and q represents an integer of 2 to 45.

Examples of the commercial product of the oligo[2-hydroxy-2-methyl-1-{4-(1-methylvinyl)phenyl}propane] represented by formula (5) include “Esacure KIP150” (CAS-No. 163702-01-0, q=4 to 6), “Esacure KIP65LT” (a mixture of “Esacure KIP150” and tripropylene glycol diacrylate), “Esacure KIP100F” (a mixture of “Esacure KIP150” and 2-hydroxy-2-methyl-1-phenylpropan-1-one), “Esacure KT37”, “Esacure KT55” (both are a mixture of “Esacure KIP150” and a methylbenzophenone derivative), “Esacure KT046” (a mixture of “Esacure KIP150”, a methylbenzophenone and 2,4,6-trimethylbenzoyldiphenylphosphine oxide), “Esacure KIP75/B” (a mixture of “Esacure KIP150” and 2,2-dimethoxy-1,2-diphenylethan-1-one), which all are a trade name and produced by Fratelli Lamberti.

Various examples are also described in Saishin UV Koka Gijutsu (Latest UV Curing Technologies), page 159, Technical Information Institute Co., Ltd. (1991), and Kiyomi Kato, Shigaisen Koka System (Ultraviolet Curing System”, pp. 65-148, Sogo Gijutsu Center (1989), and these are useful in the present invention.

Preferred examples of the commercially available photoradical polymerization initiator of photo-cleavage type include “Irgacure 651”, “Irgacure 184”, “Irgacure 819”, “Irgacure 907”, “Irgacure 1870 (CGI-403/Irg 184 (=7/3) mixed initiator), “Irgacure 500”, “Irgacure 369”, “Irgacure 1173”, “Irgacure 2959”, “Irgacure 4265”, “Irgacure 4263” and “OXE01” produced by Ciba Specialty Chemicals Corp.; “Kayacure DETX-S”, “Kayacure BP-100”, “Kayacure BDMK”, “Kayacure CTX”, “Kayacure BMS”, “Kayacure 2-EAQ”, “Kayacure ABQ”, “Kayacure CPTX”, “Kayacure EPD”, “Kayacure ITX”, “Kayacure QTX”, “Kayacure BTC” and “Kayacure MCA” produced by Nippon Kayaku Co., Ltd.; “Esacure” (KIP100F, KB1, EB3, BP, X33, KT046, KT37, KIP150, TZT) produced by Sartomer Company Inc.; and a mixture thereof.

The photopolymerization initiator is preferably used in an amount of 0.1 to 15 parts by mass, more preferably from 1 to 10 parts by mass, per 100 parts by mass of the binder. For preventing volatilization and dissipation due to a heat treatment, the molecular weight of the polymerization initiator is preferably from 250 to 10,000, more preferably from 300 to 10,000. More preferably, the mass average molecular weight thereof is from 300 to 5,000. When the molecular weight is 300 or more, the volatilizing and dissipating property is advantageously low, and when the mass average molecular weight is 10,000 or less, the cured coating film obtained can have sufficiently high hardness and this is preferred.

In addition to the photopolymerization initiator, a photosensitizer may be used. Specific examples of the photosensitizer include n-butylamine, triethylamine, tri-n-butylphosphine, Michler's ketone and thioxanthone. Furthermore, one or more auxiliary agent such as azide compound, thiourea compound and mercapto compound may be used in combination.

Examples of the commercially available photosensitizer include “Kayacure (DMBI, EPA)” produced by Nippon Kayaku Co., Ltd.

### (Thermal Radical Initiator)

As for the thermal radical initiator, an organic or inorganic peroxide, an organic azo or diazo compound, or the like may be used.

More specifically, examples of the organic peroxide include benzoyl peroxide, halogen benzoyl peroxide, lauroyl peroxide, acetyl peroxide, dibutyl peroxide, cumene hydroperoxide and butyl hydroperoxide; examples of the inorganic peroxide include hydrogen peroxide, ammonium persulfate and potassium persulfate; examples of the azo compound include 2,2′-azobis(isobutyronitrile), 2,2′-azobis(propionitrile) and 1,1′-azobis(cyclohexanecarbonitrile); and examples of the diazo compound include diazoaminobenzene and p-nitrobenzenediazonium.

### (Cationic Polymerization Initiator)

Examples of the cationic polymerization initiator include a protonic acid such as toluenesulfonic acid and methanesulfonic acid, a quaternary ammonium salt such as triethylbenzylammonium chloride, tetramethylammonium chloride, a tertiary amine such as benzyldimethylamine, tributylamine and tris(dimethylamino)methylphenol, an imidazole compound such as 2-methyl-4-ethylimidazole and 2-methylimidazole, a compound of decomposing under heat to generate a protonic acid, such as toluenesulfonic acid cyclohexyl ester and toluenesulfonic acid isopropyl ester, and various compounds described below, which generate an acid catalyst under the action of light.

In the present invention, particularly from the viewpoint of pot life of the film-forming composition, a compound capable of generating an acid under the action of light is preferred.

As for the compound capable of generating an acid under the action of light, various examples thereof are described, for example, in Organic Material Electronics (OME) (compiler), Imaging yo Yuki Zairyo (Organic Materials for Imaging), pp. 187-198, Bunshin Shuppan, and JP-A-10-28264, and these known compounds may be used. Specific examples thereof include various onium salts (e.g., diazonium salt, ammonium salt, phosphonium salt, iodonium alt, sulfonium salt, selenonium salt, arsonium salt) having a counter ion such as RSO₃⁻ (wherein R represents an alkyl group or an aryl group), AsF₆⁻, SbF₆⁻, PF₆⁻ and BF₄⁻; an organohalide such as trihalomethyl group-substituted oxadiazole derivative or S-triazine derivative; and an o-nitrobenzyl ester, benzoin ester, iminoester or disulfone compound of an organic acid. Among these, onium salts are preferred, and sulfonium salts and iodonium salts are more preferred.

In combination with such a compound capable of generating an acid under the action of light, a sensitizing dye may also be preferably used.

In general, the amount added of the compound capable of initiating cationic polymerization under the action of heat or light is used, similarly to the radical initiator, preferably in an amount of 0.1 to 15 mass %, more preferably from 0.5 to 10 mass %, still more preferably from 2 to 5 mass %, based on the entire solid content in the composition for the formation of the low refractive index layer.

### [Layer Construction of Antireflection Film]

The antireflection film of the present invention has, if desired, a hard coat layer described later on a transparent substrate, and layers are stacked thereon by taking account of refractive index, film thickness, number of layers and order of layers so as to reduce the reflectance by the optical interference. In a simplest layer construction of the antireflection film, only a low refractive index layer is provided on a substrate. In order to more reduce the reflectance, the antireflection layer is preferably constituted by combining a high refractive index layer having a refractive index higher than that of the substrate and a low refractive index layer having a refractive index lower than that of the substrate. Examples of the construction include a two-layer construction of high refractive index layer/low refractive index layer from the substrate side, and a construction comprising three layers differing in the refractive index and stacked in the order of a middle refractive index layer (a layer having a refractive index higher than that of the substrate or hard coat layer but lower than that of the high refractive index layer)/a high refractive index layer/a low refractive index layer. Also, a layer construction where a larger number of antireflection layers are stacked has been proposed. In view of durability, optical properties, cost, productivity and the like, a middle refractive index layer/a high refractive index layer/a low refractive index layer are preferably coated in this order on a substrate having thereon a hard coat layer.

Preferred examples of the layer construction for the antireflection film of the present invention are set forth below. In the following constructions, the substrate film indicates a support comprising a film.

Substrate film/low refractive index layer

Substrate film/antistatic layer/low refractive index layer

Substrate film/antiglare layer/low refractive index layer

Substrate film/antiglare layer/antistatic layer/low refractive index layer

Substrate film/hard coat layer/antiglare layer/low refractive index layer

Substrate film/hard coat layer/antiglare layer/antistatic layer/low refractive index layer

Substrate film/hard coat layer/antistatic layer/antiglare layer/low refractive index layer

Substrate film/hard coat layer/high refractive index layer/low refractive index layer

Substrate film/hard coat layer/antistatic layer/high refractive index layer/low refractive index layer

Substrate film/hard coat layer/medium refractive index layer/high refractive index layer/low refractive index layer

Substrate film/antiglare layer/high refractive index layer/low refractive index layer

Substrate film/antiglare layer/medium refractive index layer/high refractive index layer/low refractive index layer

Substrate film/antistatic layer/hard coat layer/medium refractive index layer/high refractive index layer/low refractive index layer

Antistatic layer/substrate film/hard coat layer/medium refractive index layer/high refractive index layer/low refractive index layer

Substrate film/antistatic layer/antiglare layer/medium refractive index layer/high refractive index layer/low refractive index layer

Antistatic layer/substrate film/antiglare layer/medium refractive index layer/high refractive index layer/low refractive index layer

Antistatic layer/substrate film/antiglare layer/high refractive index layer/low refractive index layer/high refractive index layer/low refractive index layer

Insofar as the reflectance can be reduced by the optical interference, the antireflection film of the present invention is not particularly limited only to these layer constructions.

The high refractive index layer may be a light-diffusing layer not having an antiglare property.

The antistatic layer is preferably a layer containing an electrically conducting polymer particle or a metal oxide fine particle (e.g., ATO, ITO) and may be provided, for example, by coating or atmospheric plasma treatment. In the case of providing an antifouling layer, the antifouling layer may be provided as the uppermost layer in the above-described constructions.

### [High Refractive Index Layer]

In the present invention, a high refractive index layer is preferably provided. The high refractive index layer may be formed from a binder, a matting particle for imparting the antiglare function, and an inorganic fine particle for elevating the refractive index, preventing the crosslinking shrinkage and increasing the strength.

### [Matting Particle]

In the high refractive index layer, a matting particle being larger than the inorganic filler particle and having an average particle diameter of 0.1 to 5.0 μm, preferably from 1.5 to 3.5 μm, such as inorganic compound particle or resin particle, may be contained for imparting an antiglare property. The difference in the refractive index between the matting particle and the binder is preferably from 0.02 to 0.20, more preferably from 0.04 to 0.10, from the standpoint of preventing the film from becoming white turbid and achieving a good light-diffusing effect. From the same standpoint as the refractive index, the amount added of the matting particle is preferably from 3 to 30 mass %, more preferably from 5 to 20 mass %, based on the binder.

Specific preferred examples of the matting particle include an inorganic compound particle such as silica particle and TiO₂ particle; and a resin particle such as acryl particle, crosslinked acryl particle, polystyrene particle, crosslinked styrene particle, melamine resin particle and benzoguanamine resin particle. Among these, a crosslinked styrene particle, a crosslinked acryl particle and a silica particle are more preferred.

The shape of the matting particle may be either true spherical or amorphous.

Also, two or more different kinds of matting particles may be used in combination.

In the case of using two or more kinds of matting particles, in order to effectively bring out the refractive index control by virtue of mixing two matting particles, the difference in the refractive index is preferably from 0.02 to 0.10, more preferably from 0.03 to 0.07.

Furthermore, a matting particle having a larger particle diameter can impart an antiglare property, while a matting particle having a smaller particle diameter imparts another optical property. For example, the antireflection film laminated on a high definition display of 133 ppi or more is required to be free from an optical performance defect called glaring. The glaring is ascribable to loss of brightness uniformity resulting from enlargement or shrinkage of a pixel due to irregularities (contributing to the antiglare property) present on the film surface, but this can be greatly improved by using together a matting particle having a particle diameter smaller than that of the matting particle used for imparting the antiglare property and having a refractive index differing from that of the binder.

The particle diameter distribution of this matting particle is most preferably monodisperse, and individual particles preferably have the same particle diameter as much as possible. For example, when a particle having a particle diameter 20% or more larger than the average particle diameter is defined as a “coarse particle”, the proportion of this coarse particle is preferably 1% or less, more preferably 0.1% or less, still more preferably 0.01% or less, based on the number of all particles. The matting particle having such a particle diameter distribution is obtained by classifying the particles after a normal synthesis reaction, and when the number of classifications is increased or the level of classification is elevated, a matting agent having a more preferred distribution can be obtained.

The matting particle is preferably contained in the high refractive index layer such that the amount of the matting particle in the formed high refractive index layer becomes from 10 to 1,000 mg/m², more preferably from 100 to 700 mg/m².

The particle size distribution of the matting particle is measured by a Coulter counter method, and the measured distribution is converted into a particle number distribution.

### [High Refractive Index Particle]

In order to elevate the refractive index of the high refractive layer, the layer preferably contains, in addition to the above-described matting particle, an inorganic filler comprising an oxide of at least one metal selected from titanium, zirconium, aluminum, indium, zinc, tin and antimony, and having an average particle diameter of 0.2 μm or less, preferably 0.1 μm or less, more preferably 0.06 μm or less.

Furthermore, in the high refractive index layer where a high refractive index matting agent is used to increase the difference in the refractive index from the matting particle, a silicon oxide is also preferably used so that the refractive index of the layer can be kept rather low. The preferred particle diameter is the same as that of the oxide particle for use in the low refractive index layer.

### [Inorganic Filler]

Specific examples of the inorganic filler for use in the high refractive index layer include TiO₂, ZrO₂, Al₂O₃, In₂O₃, ZnO, SnO₂, Sb₂O₃, ITO and SiO₂. Among these, TiO₂ and ZrO₂ are preferred from the standpoint of elevating the refractive index. The surface of the inorganic filler may be preferably subjected to a silane coupling treatment or a titanium coupling treatment, and a surface treating agent having a functional group capable of reacting with the binder species is preferably used on the filler surface.

The amount of the inorganic filler added is preferably from 10 to 90%, more preferably from 20 to 80%, still more preferably from 30 to 70%, based on the entire mass of the high refractive index layer.

Such as filler causes no scattering because the particle diameter is sufficiently smaller than the wavelength of light, and the dispersion obtained by dispersing the filler in the binder polymer behaves as an optically uniform substance.

The mixture of the binder and the inorganic fine particle in the high refractive index layer of the present invention preferably has a bulk refractive index of 1.48 to 2.00, more preferably from 1.50 to 1.80. The refractive index in this range can be obtained by appropriately selecting the kind of the binder and inorganic filler and the ratio of amounts thereof. The kind and ratio to be selected can be easily known by previously performing an experiment.

### [Hard Coat Layer]

The hard coat layer is provided, if desired, on the support surface for imparting physical strength to the antireflection film. In particular, the hard coat layer is preferably provided between the support and the high refractive index layer (or medium refractive index layer). When the above-described high refractive index particle or the like is incorporated into the hard coat layer, the layer can serve also as a high refractive index layer.

The hard coat layer is preferably formed by a crosslinking reaction or polymerization reaction of an ionizing radiation-curable resin. For example, the hard coat layer may be formed by coating a coating composition containing an ionizing radiation-curable polyfunctional monomer or oligomer on a support, and causing a crosslinking reaction or polymerization reaction of the polyfunctional monomer or oligomer.

Also, similarly to the high refractive index layer, a matting particle or an inorganic filler may be used in the same amount range in the hard coat layer.

The haze value of the thus-formed antireflection film of the present invention is from 3 to 70%, preferably from 4 to 60%, and the average reflectance at 450 to 650 nm is 3.0% or less, preferably 2.5% or less. When the optical antireflection film of the present invention has a haze value and an average reflectance in the above-described ranges, good antiglare and good antireflection property can be obtained without incurring deterioration of the transmitted image.

### [Surface State Improving Agent]

In the coating solution used for producing any layer on the support, a surface state improving agent of at least either fluorine type or silicone type is preferably added so as to improve the surface state failure (e.g., coating unevenness, drying unevenness, point defect).

The surface state improving agent preferably changes the surface tension of the coating solution by 1 mN/m or more. The term “changes the surface tension of the coating solution by 1 mN/m or more” as used herein means that the surface tension of the coating solution after addition of the surface state improving agent is changed by 1 mN/m or more as compared with the surface tension of the coating solution in which the surface state improving agent is not added, including the concentration process at the coating/drying. The surface state improving agent preferably has an effect of decreasing the surface tension of the coating solution by 1 mN/m or more, more preferably 2 mN/m or more, still more preferably 3 mN/m or more.

Preferred examples of the surface state improving agent of fluorine type include a fluoroaliphatic group-containing compound (sometimes simply referred to as a “fluorine-based surface state improving agent”). In particular, a copolymer of an acrylic or methacrylic resin containing a repeating unit corresponding to the monomer of the following formula (6) and a repeating unit corresponding to the monomer of the following formula (7), with a vinyl-based monomer copolymerizable therewith, is preferred.

As for such a monomer, those described in J. Brandrup, Polymer Handbook, 2nd ed., Chapter 2, pp. 1-483, Wiley Interscience (1975) are preferably used.

Specific examples thereof include a compound having one addition-polymerizable unsaturated bond selected from an acrylic acid, a methacrylic acid, acrylic acid esters, methacrylic acid esters, acrylamides, methacrylamides, an allyl compound, vinyl ethers and vinyl esters.

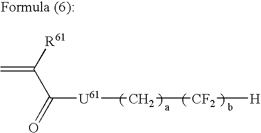

In formula (6), R⁶¹ represents a hydrogen atom, a halogen atom or a methyl group, preferably a hydrogen atom or a methyl group. U⁶¹ represents an oxygen atom, a sulfur atom or —N(R⁶²)—, preferably an oxygen atom or —N(R⁶²)—, more preferably an oxygen atom. R⁶² represents a hydrogen atom or an alkyl group having a carbon number of 1 to 8, preferably a hydrogen atom or an alkyl group having a carbon number of 1 to 4, more preferably a hydrogen atom or a methyl group. a represents an integer of 1 to 6, preferably 1 to 3, more preferably 1. b represents an integer of 1 to 18, preferably 4 to 12, more preferably 6 to 8.

In the fluorine-based surface state improving agent, two or more kinds of fluoroaliphatic group-containing monomers represented by formula (6) may be contained as the constituent component.

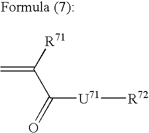

In formula (7), R⁷¹ represents a hydrogen atom, a halogen atom or a methyl group, preferably a hydrogen atom or a methyl group. U⁷¹ represents an oxygen atom, a sulfur atom or —N(R⁷³)—, preferably an oxygen atom or —N(R⁷³)—, more preferably an oxygen atom. R⁷³ represents a hydrogen atom or an alkyl group having a carbon number of 1 to 8, preferably a hydrogen atom or an alkyl group having a carbon number of 1 to 4, more preferably a hydrogen atom or a methyl group.

R⁷² represents a hydrogen atom, a substituted or unsubstituted, linear, branched or cyclic alkyl group having a carbon number of 1 to 20, an alkyl group containing a poly(alkyleneoxy) group, or a substituted or unsubstituted aromatic group (e.g., phenyl, naphthyl), preferably a linear, branched or cyclic alkyl group having a carbon number of 1 to 12, or an aromatic group having a total carbon number of 6 to 18, more preferably a linear, branched or cyclic alkyl group having a carbon number of 1 to 8.

The poly(alkyleneoxy) group is described below.

The poly(alkyleneoxy) group is a group having —(OR)— as the repeating unit, and examples thereof include —CH₂CH₂—, —CH₂CH₂CH₂—, —CH(CH₃)CH₂— and —CH(CH₃)CH(CH₃)—.

The oxyalkylene units (—OR— in above) in the poly(oxyalkylene) group may be the same as in poly(oxypropylene), or two or more kinds of oxyalkylenes differing from each other may be irregularly distributed. Also, the oxyalkylene unit may be a linear or branched oxypropylene or oxyethylene unit or may be present as a block of linear or branched oxypropylene unit or a block of oxyethylene unit.

The poly(oxyalkylene) chain may contain a chain linked through one or more linking bond (e.g., —CONH-Ph-NHCO—, —S—; Ph represents a phenylene group). In the case where the linking bond has three or more atomic valences, these provide means for obtaining a branched oxyalkylene unit. When this copolymer is used in the present invention, the molecular weight of the poly(oxyalkylene) group is suitably from 250 to 3,000.

The poly(oxyalkylene) acrylate or methacrylate can be produced by reacting a commercially available hydroxypoly(oxyalkylene) material, for example, a material available on the market under the trade name of “Pluronic” {produced by Asahi Denka Kogyo K.K.}, “Adeka Polyether” {produced by Asahi Denka Kogyo K.K.}, “Carbowax” {produced by Glico Products}, “Toriton” {produced by Rohm and Haas} or “P.E.G” {produced by Dai-ichi Kogyo Seiyaku Co., Ltd.}, with an acrylic acid, a methacrylic acid, an acryl chloride, a methacryl chloride, an acrylic anhydride or the like according to a known method. In addition, a poly(oxyalkylene) diacrylate or the like produced by a known method may also be used.

In the fluorine-based surface state improving agent for use in the present invention, the amount of the fluoroaliphatic group-containing monomer represented by formula (6) is preferably 50 mol % or more, more preferably from 70 to 100 mol %, still more preferably from 80 to 100 mol %, based on the amount of all monomers used for the formation of the fluorine-based surface state improving agent.

The mass average molecular weight of the fluorine-based surface state improving agent for use in the present invention is preferably from 3,000 to 100,000, more preferably from 6,000 to 80,000, still more preferably from 8,000 to 60,000. The mass average molecular weight as used herein means a molecular weight determined by differential refractometer detection with a solvent THF in a GPC analyzer using a column, “TSKgel GMHxL”, “TSKgel G4000HxL” or “TSKgel G2000HxL” {trade names, all produced by Tosoh Corp.}, and expressed in terms of polystyrene. The content is an area percentage of the peak in the above-described molecular weight range assuming that the area of peaks of the components having a molecular weight of 300 or more is 100%.

Furthermore, the fluorine-based surface state improving agent for use in the present invention is preferably added in an amount of 0.001 to 5 mass %, more preferably from 0.005 to 3 mass %, still more preferably from 0.01 to 1 mass %, based on the coating solution for the layer to which the surface state improving agent is added.

Specific structure examples of the fluorine-based surface state improving agent for use in the present invention are set forth below, but the present invention is not limited thereto. The numerals in each formula indicate a molar ratio of respective monomer components. Mw indicates a mass average molecular weight.

TABLE 10

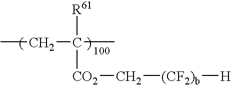

| | R⁶¹ | b | Mw |
|---|---|---|---|
| F-1 | H | 4 | 8000 |
| F-2 | H | 4 | 16000 |
| F-3 | H | 4 | 33000 |
| F-4 | CH₃ | 4 | 12000 |
| F-5 | CH₃ | 4 | 28000 |
| F-6 | H | 6 | 8000 |
| F-7 | H | 6 | 14000 |
| F-8 | H | 6 | 29000 |
| F-9 | CH₃ | 6 | 10000 |
| F-10 | CH₃ | 6 | 21000 |
| F-11 | H | 8 | 4000 |
| F-12 | H | 8 | 16000 |
| F-13 | H | 8 | 31000 |
| F-14 | CH₃ | 8 | 3000 |
| F-15 | CH₃ | 8 | 10000 |
| F-16 | CH₃ | 8 | 27000 |
| F-17 | H | 10 | 5000 |
| F-18 | H | 10 | 11000 |
| F-19 | CH₃ | 10 | 4500 |
| F-20 | CH₃ | 10 | 12000 |
| F-21 | H | 12 | 5000 |
| F-22 | H | 12 | 10000 |
| F-23 | CH₃ | 12 | 5500 |
| F-24 | CH₃ | 12 | 12000 |

TABLE 11

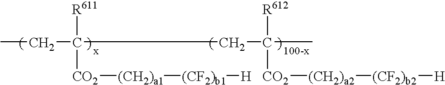

| | x | R⁶¹¹ | a1 | b1 | R⁶¹² | a2 | b2 | Mw |
|---|---|---|---|---|---|---|---|---|
| F-25 | 50 | H | 1 | 4 | CH₃ | 1 | 4 | 10000 |
| F-26 | 40 | H | 1 | 4 | H | 1 | 6 | 14000 |
| F-27 | 60 | H | 1 | 4 | CH₃ | 1 | 6 | 21000 |
| F-28 | 10 | H | 1 | 4 | H | 1 | 8 | 11000 |
| F-29 | 40 | H | 1 | 4 | H | 1 | 8 | 16000 |
| F-30 | 20 | H | 1 | 4 | CH₃ | 1 | 8 | 8000 |
| F-31 | 10 | CH₃ | 1 | 4 | CH₃ | 1 | 8 | 7000 |
| F-32 | 50 | H | 1 | 6 | CH₃ | 1 | 6 | 12000 |
| F-33 | 50 | H | 1 | 6 | CH₃ | 1 | 6 | 22000 |
| F-34 | 30 | H | 1 | 6 | CH₃ | 1 | 6 | 5000 |
| F-35 | 40 | CH₃ | 1 | 6 | H | 3 | 6 | 3000 |
| F-36 | 10 | H | 1 | 6 | H | 1 | 8 | 7000 |
| F-37 | 30 | H | 1 | 6 | H | 1 | 8 | 17000 |
| F-38 | 50 | H | 1 | 6 | H | 1 | 8 | 16000 |
| F-39 | 50 | CH₃ | 1 | 6 | H | 3 | 8 | 19000 |
| F-40 | 50 | H | 1 | 8 | CH₃ | 1 | 8 | 5000 |
| F-41 | 80 | H | 1 | 8 | CH₃ | 1 | 8 | 10000 |
| F-42 | 50 | CH₃ | 1 | 8 | H | 3 | 8 | 14000 |
| F-43 | 90 | H | 1 | 8 | CH₃ | 3 | 8 | 9000 |
| F-44 | 70 | H | 1 | 8 | H | 1 | 10 | 7000 |
| F-45 | 90 | H | 1 | 8 | H | 3 | 10 | 12000 |
| F-46 | 50 | H | 1 | 8 | H | 1 | 12 | 10000 |
| F-47 | 70 | H | 1 | 8 | CH₃ | 3 | 12 | 8000 |

TABLE 12

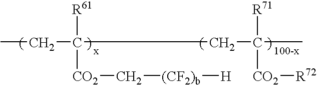

| | x | R⁶¹ | b | R⁷¹ | R⁷² | Mw |
|---|---|---|---|---|---|---|
| F-48 | 80 | H | 4 | CH₃ | CH₃ | 11000 |
| F-49 | 90 | H | 4 | H | C₄H₉(n) | 7000 |
| F-50 | 95 | H | 4 | H | C₆H₁₃(n) | 5000 |
| F-51 | 90 | CH₃ | 4 | H | CH₂CH(C₂H₅)C₄H₉(n) | 15000 |
| F-52 | 70 | H | 6 | CH₃ | C₂H₅ | 18000 |
| F-53 | 90 | H | 6 | CH₃ | 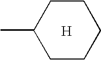 | 12000 |
| F-54 | 80 | H | 6 | H | C₄H₉(s) | 9000 |
| F-55 | 90 | H | 6 | H | C₁₂H₂₅(n) | 21000 |
| F-56 | 60 | CH₃ | 6 | H | CH₃ | 15000 |
| F-57 | 60 | H | 8 | H | CH₃ | 10000 |
| F-58 | 70 | H | 8 | H | C₂H₅ | 24000 |
| F-59 | 70 | H | 8 | H | C₄H₉(n) | 5000 |
| F-60 | 50 | H | 8 | H | C₄H₉(n) | 16000 |
| F-61 | 80 | H | 8 | CH₃ | C₄H₉(i) | 13000 |
| F-62 | 80 | H | 8 | CH₃ | C₄H₉(t) | 9000 |
| F-63 | 60 | H | 8 | H | 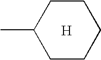 | 7000 |
| F-64 | 80 | H | 8 | H | CH₂CH(C₂H₅)C₄H₉(n) | 8000 |
| F-65 | 90 | H | 8 | H | C₁₂H₂₅(n) | 6000 |

TABLE 13

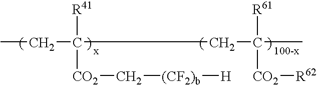

| | x | R⁴¹ | b | R⁶¹ | R⁶² | Mw |
|---|---|---|---|---|---|---|
| F-66 | 80 | CH₃ | 8 | CH₃ | C₄H₉(s) | 18000 |
| F-67 | 70 | CH₃ | 8 | CH₃ | CH₃ | 22000 |
| F-68 | 70 | H | 10 | CH₃ | H | 17000 |
| F-69 | 90 | H | 10 | H | H | 9000 |
| F-70 | 95 | H | 4 | CH₃ | —(CH₂CH₂O)₂—H | 18000 |
| F-71 | 80 | H | 4 | H | —(CH₂CH₂O)₂—CH₃ | 16000 |
| F-72 | 80 | H | 4 | H | —(C₃H₆O)₇—H | 24000 |
| F-73 | 70 | CH₃ | 4 | H | —(C₃H₆O)₁₃—H | 18000 |
| F-74 | 90 | H | 6 | H | —(CH₂CH₂O)₂—H | 21000 |
| F-75 | 90 | H | 6 | CH₃ | —(CH₂CH₂O)₈—H | 9000 |
| F-76 | 80 | H | 6 | H | —(CH₂CH₂O)₂—C₄H₉(n) | 12000 |
| F-77 | 80 | H | 6 | H | —(C₃H₆O)₇—H | 34000 |
| F-78 | 75 | F | 6 | H | —(C₃H₆O)₁₃—H | 11000 |
| F-79 | 85 | CH₃ | 6 | CH₃ | —(C₃H₆O)₂₀—H | 18000 |
| F-80 | 95 | CH₃ | 6 | CH₃ | —CH₂CH₂OH | 27000 |
| F-81 | 80 | H | 8 | CH₃ | —(CH₂CH₂O)₈—H | 12000 |
| F-82 | 95 | H | 8 | H | —(CH₂CH₂O)₉—CH₃ | 20000 |
| F-83 | 90 | H | 8 | H | —(C₃H₆O)₇—H | 8000 |

The surface state improving agent for use in the present invention is preferably used in a coating solution containing a ketone-based solvent (e.g., acetone, methyl ethyl ketone, methyl isobutyl ketone, cyclohexanone), an ester-based solvent (e.g., methyl acetate, butyl acetate), ethers (e.g., tetrahydrofuran, 1,4-dioxane), or an aromatic hydrocarbon-based solvent (e.g., toluene, xylene). In particular, a ketone-based solvent is preferred. Among the ketone-based solvents, methyl ethyl ketone, methyl isobutyl ketone and cyclohexanone are preferred.

The surface state improving agent sometimes worsens the adhesion at the interface between layers. Accordingly, the surface state improving agent is preferably not allowed to remain in the vicinity of the interface between layers by dissolving out the surface state improving agent present on the layer surface into a coating solution for forming a layer adjacent to the layer. For this purpose, the coating solution for the adjacent layer preferably contains a solvent capable of dissolving the surface state improving agent. This solvent is preferably the above-described ketone-based solvent.

In the coating solution for a layer formed on the support, the surface state improving agent is preferably added particularly to a coating solution for forming a hard coat layer, an antiglare hard coat layer, an antistatic layer, a high refractive index layer or a low refractive index layer, more preferably a coating solution for forming a hard coat layer or an antiglare hard coat layer.

The support for use in the antireflection film of the present invention is preferably a plastic film. Examples of the polymer forming a plastic film include a cellulose ester {e.g., triacetyl cellulose, diacetyl cellulose; as represented by TAC-TD80U and TD80UF produced by Fuji Photo Film Co., Ltd.}, a polyamide, a polycarbonate, a polyester (e.g., polyethylene terephthalate, polyethylene naphthalate), a polystyrene, a polyolefin, a norbornene-based resin {e.g., “Arton” (trade name), produced by JSR Corp.), and an amorphous polyolefin {e.g., “Zeonex” (trade name), produced by Zeon Corp.). Among these, triacetyl cellulose, polyethylene terephthalate and polyethylene naphthalate are preferred, and triacetyl cellulose is more preferred. The cellulose acylate film substantially free from a halogenated hydrocarbon such as dichloromethane and the production process thereof are described in JIII Journal of Technical Disclosure, No. 2001-1745 (Mar. 15, 2001) (hereinafter simply referred to as “Technical Disclosure No. 2001-1745”), and the cellulose acylates described therein are also preferably used in the present invention.

### [Saponification Treatment]

In the case of using the antireflection film of the present invention for a liquid display device, the antireflection film is disposed on the outermost surface of the display by providing a pressure-sensitive adhesive layer on one surface. In the case where the support is triacetyl cellulose, in view of the cost, the antireflection film of the present invention is preferably used directly as the protective film, because triacetyl cellulose is used as the protective film for protecting the polarizing film of a polarizing plate.

In the case where, as described above, the antireflection film of the present invention is disposed on the outermost surface of a display or is used directly as the protective film of a polarizing plate, the antireflection film after the formation of low refractive index layer on the support is preferably subjected to a saponification treatment for enhancing the adhesive property.

The saponification treatment is performed by a known method, for example, by dipping the antireflection film of the present invention in an alkali solution for an appropriate time period. After dipping in an alkali solution, the film is preferably well washed with water or dipped in a dilute acid to neutralize the alkali component and thereby prevent the alkali component from remaining in the film. By performing a saponification treatment, the support surface on the side opposite the surface having the outermost layer is hydrophilized.

The hydrophilized surface is effective particularly for improving the adhesive property to a polarizing film mainly comprising a polyvinyl alcohol. Furthermore, the hydrophilized surface hardly allows for attachment of dusts in the air and therefore, dusts scarcely intrude into the space between the polarizing film and the antireflection film at the bonding to a polarizing film, so that point defects due to dusts can be effectively prevented.

The saponification treatment is preferably performed such that the support surface on the side opposite the surface having the outermost layer has a contact angle with water of 400 or less, more preferably 30° or less, still more preferably 20° or less.

The specific method for the alkali saponification treatment can be selected from the following two methods (1) and (2). The method (1) is advantageous in that the treatment can be performed in the same step as that for a general-purpose triacetyl cellulose film, but since the antireflection layer of the antireflection film surface is also saponified, the surface may be alkali-hydrolyzed to deteriorate the film or if the solution for saponification treatment remains, this may cause a problem of staining. If the case is so, the method (2) is advantageous, though a special step for the treatment is necessary.

(1) After the formation of antireflection layer on the support, the film is dipped at least once in an alkali solution, whereby the back surface of the film is saponified.

(2) Before or after the formation of antireflection layer on the support, an alkali solution is coated on the antireflection film surface on the side opposite the surface where the antireflection layer is formed, and then the film is heated and washed with water and/or neutralized, whereby only the back surface of the film is saponified.

### [Method for Forming Coating Film]

The antireflection film of the present invention can be formed by the following method, but the present invention is not limited to this method.

First, a coating solution containing components for forming each layer is prepared.

The coating solution prepared is coated on a support by a dip coating method, an air knife coating method, a curtain coating method, a roller coating method, a wire bar coating method, a gravure coating method or an extrusion coating method (see, U.S. Pat. No. 2,681,294), then heated and dried. Out of these coating methods, when the coating solution is coated by a gravure coating method, a coating solution in a small coated amount as in each layer of the antireflection layer can be coated with high film thickness uniformity and this is preferred. As for the gravure coating method, a microgravure method is more preferred, because the film thickness uniformity is high.

Furthermore, a coating solution in a small coated amount can be coated with high film thickness uniformity also by using a die coating method. The die coating method is a pre-measuring system and therefore, is advantageous in that the control of the film thickness is relatively easy and the transpiration of the solvent in the coated part less occurs.

Two or more layers may be coated simultaneously. The simultaneous coating method is described in U.S. Pat. Nos. 2,761,791, 2,941,898, 3,508,947 and 3,526,528, and Yuji Harasaki, Coating Kogaku (Coating Engineering), page 253, Asakura Shoten (1973).

### <Polarizing Plate>

The polarizing plate mainly comprises a polarizing film and two protective films sandwiching the polarizing film from both sides. The antireflection film of the present invention is preferably used for at least one protective film out of two protective films sandwiching the polarizing film from both sides. By arranging the antireflection film of the present invention to serve also as a protective film, the production cost of the polarizing plate can be reduced. Furthermore, by using the antireflection film of the present invention as the outermost surface layer, a polarizing plate prevented from the projection of outside light or the like and assured of excellent properties such as scratch resistance and antifouling property can be obtained.

### [Polarizing Film]

As for the polarizing film, a known polarizing film or a polarizing film cut out from a lengthy polarizing film with the absorption axis of the polarizing film being neither parallel nor perpendicular to the longitudinal direction may be used. The lengthy polarizing film with the absorption axis of the polarizing film being neither parallel nor perpendicular to the longitudinal direction is produced by the following method.

This polarizing film is a polarizing film obtained by continuously feeding a polymer film and stretching the film while holding both edges of the film with holding means and applying a tension and can be produced by a stretching method of stretching the film at a stretching ratio of 1.1 to 20.0 at least in the film width direction, moving the holding devices at both edges of the film to create a difference in the travelling speed of 3% or less in the longitudinal direction, and bending the film travelling direction in the state of the film being held at both edges such that the angle made by the film travelling direction at the outlet in the step of holding both edges of the film and the substantial stretching direction of the film is inclined at 20 to 70°. Particularly, a polarizing film produced with an inclination angle of 45° is preferred in view of productivity.

The stretching method of a polymer film is described in detail in JP-A-2002-86554 (paragraphs [0020] to [0030]).

[Combination with Liquid Crystal Display Device]

In the case of using the antireflection film of the present invention as a surface protective film on one side of the polarizing film, the antireflection film can be preferably used for a transmissive, reflective or transflective liquid crystal display device in a mode such as twisted nematic (TN) mode, super-twisted nematic (STN) mode, vertical alignment (VA) mode, in-plane switching (IPS) mode and optically compensated bend cell (OCB) mode.

The VA-mode liquid crystal cell includes:

(1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625);

(2) a (MVA-mode) liquid crystal cell where the VA mode is modified to a multi-domain alignment for enlarging the viewing angle {described in SID97, Digest of Tech. Papers (preprints), 28, 845 (1997)};

(3) a (n-ASM-mode) liquid crystal cell where rod-like liquid crystalline molecules are oriented substantially in the vertical alignment at the time of not applying a voltage and oriented in the twisted multi-domain alignment at the time of applying a voltage {described in preprints of Nippon Ekisho Toronkai (Liquid Crystal Forum of Japan), 58-59 (1998)]; and

(4) a SURVAIVAL-mode liquid crystal cell (reported in LCD International 98).

For the application to a VA-mode liquid crystal cell, a polarizing plate produced by combining a biaxially stretched triacetyl cellulose film with the antireflection film of the present invention is preferably used. As for the production method of a biaxially stretched triacetyl cellulose film, the method described, for example, in JP-A-2001-249223 and JP-A-2003-170492 is preferably used.

The OCB-mode liquid crystal cell is a liquid crystal display device using a liquid crystal cell of bend alignment mode where rod-like liquid crystalline molecules are aligned substantially in the reverse direction (symmetrically) between the upper part and the lower part of the liquid crystal cell, and this is disclosed in U.S. Pat. Nos. 4,583,825 and 5,410,422. Since rod-like liquid crystalline molecules are aligned symmetrically between the upper part and the lower part of the liquid crystal cell, the liquid crystal cell of bend alignment mode has a self-optically compensating ability. For this reason, this liquid crystal mode is also called an OCB (optically compensatory bend) liquid crystal mode. The liquid crystal display device of bend alignment mode is advantageous in that the response speed is fast.

In the ECB-mode liquid crystal cell, rod-like liquid crystalline molecules are oriented substantially in the horizontal alignment at the time of not applying a voltage. This is most popularly used as a color TFT liquid crystal display device and is described in a large number of publications such as EL, PDP, LCD Display, Toray Research Center (2001).

Particularly, in the case of a TN-mode or IPS-mode liquid crystal display device, as described in JP-A-2001-100043 and the like, an optical compensation film having an effect of enlarging the viewing angle is preferably used for the surface on the side opposite the antireflection film of the present invention out of front and back two protective films of a polarizing film, because a polarizing plate having an antireflection effect and a viewing angle-enlarging effect with a thickness of one polarizing plate can be obtained.

### EXAMPLES

The present invention is described below in greater detail by referring to Examples, but the present invention is not limited thereto. Unless otherwise indicated, the “parts” and “%” are on the mass basis.

### <Antireflection Film>

### Example 1-1

### Preparation of Sol Solution a

In a reactor equipped with a stirrer and a reflux condenser, 120 parts of methyl ethyl ketone, 100 parts of acryloyloxypropyltrimethoxysilane “KBM-5103” {produced by Shin-Etsu Chemical Co., Ltd.} and 3 parts of diisopropoxyaluminum ethyl acetoacetate were added and mixed and after adding thereto 30 parts of ion-exchanged water, the mixture was allowed to react at 60° C. for 4 hours. Thereafter, the reaction mixture was cooled to room temperature to obtain Sol Solution a. The mass average molecular weight was 1,600 and out of the oligomer or greater polymer components, the component having a molecular weight of 1,000 to 20,000 occupied 100%. Also, the gas chromatography revealed that the raw material acryloyloxypropyltrimethoxysilane was not remaining at all. Sol Solution a was adjusted to a solid content concentration of 29% by methyl ethyl ketone.

### [Preparation of Coating Solution (HCL-1) for Hard Coat Layer]

2.0 Parts of polymerization initiator “Irgacure 184” {produced by Nippon Ciba-Geigy}, 0.06 parts of surface state improving agent {Compound (F-63)}, 10.0 parts of organosilane compound “KBM5103” {produced by Shin-Etsu Chemical Co., Ltd.} and, 38.5 parts of toluene were added to 50.0 parts of a pentaerythritol triacrylate and pentaerythritol tetraacrylate mixture “PETA” {produced by Nippon Kayaku Co., Ltd.} and stirred. The refractive index of the coating film obtained by coating and ultraviolet-curing this solution was 1.51.

To this solution, 1.7 parts of a 30% toluene liquid dispersion of crosslinked polystyrene particle “SX-350” {produced by Soken Kagaku K.K., refractive index: 1.60} having an average particle diameter of 3.5 μm after dispersion in a polytron dispersing machine at 10,000 rpm and 13.3 parts of a 30% toluene liquid dispersion of crosslinked acryl-styrene particle {produced by Soken Kagaku K.K., refractive index: 1.55} having an average particle diameter of 3.5 μm were added. After stirring, the resulting solution was filtered through a polypropylene-made filter having a pore size of 30 μm to prepare Coating Solution (HCL-1) for Antiglare Hard Coat Layer. The refractive index of the coating film from this coating solution was 1.51. The surface tension of the obtained Coating Solution (HLC-1) for Antiglare Hard Coat Layer was 32 mN/m.

### [Preparation of Coating Solution (LLL-1) for Low Refractive Index Layer]

87.0 Parts of a fluorine-containing copolymer {Compound (P-3) (mass average molecular weight: 35,000)}, 17.2 parts (5 parts as the solid content) of Sol Solution a, 5.0 parts of a dipentaerythritol pentaacrylate and dipentaerythritol hexaacrylate mixture “DPHA” {produced by Nippon Kayaku Co., Ltd.} and 3 parts of photoradical generator “Irgacure OXE01” {produced by Ciba Specialty Chemicals Corp.) were dissolved in 200 parts of methyl ethyl ketone. The resulting solution was diluted with cyclohexanone and methyl ethyl ketone to adjust the solid content concentration of the entire coating composition to 6% and the ratio of cyclohexane and methyl ethyl ketone to 20/80, thereby producing Coating Solution (LLL-1) for Low Refractive Index Layer.

### [Production of Antireflection Film (101)]

### [Production of Hard Coat Layer (HC-1)]

Coating Solution (HCL-1) for Hard Coat Layer was coated on a triacetyl cellulose film “TAC-TD80U” {produced by Fuji Photo Film Co., Ltd.} having a thickness of 80 μm and a width of 1,340 mm by a microgravure coating method under the condition of transportation speed of 30 m/min and after drying at 60° C. for 150 seconds, irradiated with an ultraviolet ray at an illumination intensity of 400 mW/cm² and an irradiation dose of 150 mJ/cm² by using “Air-Cooled Metal Halide Lamp” (manufactured by Eyegraphics Co., Ltd.) of 160 W/cm under nitrogen purging (oxygen concentration: 0.5% or less), thereby curing the coated layer to form a hard coat layer having a thickness of 5.5 μm and having an antiglare hard coat layer. In this way, Hard Coat Layer (HC-1) was obtained.

### [Formation of Low Refractive Index Layer (LL1-1)]

On the thus-obtained Hard Coat Layer (HC-1), Low Refractive Index Layer (LL1-1) was formed by a microgravure coating method using Coating Solution (LLL-1) for Low Refractive Index Layer under the control to give a low refractive index layer thickness of 95 nm. In this way, Antireflection Film Sample (101) was produced.

The curing conditions are shown below.

(1) Drying: 80° C.-120 seconds

(2) Heat treatment before irradiation: 95° C.-5 minutes

(3) UV Curing:

90° C.-1 minute, an illumination intensity of 120 mW/cm² and an irradiation dose of 240 mJ/cm² by using Air-Cooled Metal Halide Lamp (manufactured by Eyegraphics Co., Ltd.) of 240 W/cm under nitrogen purging to give an atmosphere having an oxygen concentration of 0.01 vol % or less

(4) Heat treatment after irradiation: 30° C.-5 minutes

### Examples 1-2 to 1-5 and Comparative Examples 1-1 to 1-4

Low Refractive Index Layers (LL1-2) to (LL1-9) were formed according to

Antireflection Film Sample (101) except for changing the conditions of pre-heat treatment, UV curing and after-heat treatment as shown in Table 14 in Example 1-1, whereby Antireflection Film Samples (102) to (109) were produced.

### [Saponification Treatment of Antireflection Film]

Antireflection Film Samples (101) to (109) obtained as above each was subjected to the following saponification treatment.

An aqueous 1.5 mol/liter sodium hydroxide solution was prepared and kept at 55° C. Separately, an aqueous 0.005 mol/liter dilute sulfuric acid solution was prepared and kept at 35° C.

The produced antireflection film was dipped in the aqueous sodium hydroxide solution for 2 minutes and then dipped in water to thoroughly wash out the aqueous sodium hydroxide solution. Subsequently, the film was dipped in the aqueous dilute sulfuric acid solution for 1 minute and then dipped in water to thoroughly wash out the aqueous dilute sulfuric acid solution. Finally, the sample was well dried at 120° C. In this way, a saponified antireflection film was produced.

### [Evaluation of Hard Antireflection Film]

The film obtained was evaluated on the following items.

### (Evaluation 1) Average Reflectance

The back surface of the antireflection film was subjected to a roughening treatment and then to a light absorption treatment with black ink (to have a transmittance of less than 10% at 380 to 780 nm). The spectral reflectance at an incident angle of 5° in the wavelength region of 380 to 780 nm was measured by using a spectrophotometer {manufactured by JASCO Corporation}. The results are shown by the average reflectance at 450 to 650 nm.

### (Evaluation 2) Surface Segregation Degree of Silicon Atom

Using each antireflection film, the photoelectron spectra of Si₂ₚ and C₁ₛ on the outermost surface were measured by “ESCA-3400” manufactured by Shimadzu Corporation (vacuum degree: 1×10⁻⁵ Pa, X-ray source: target Mg, voltage: 12 kV, current: 20 mA). The signal intensity ratio Si₂ₚ/C₁ₛ thereof is defined as Si₍ₐ₎ on the outermost surface.

The low refractive index layer was etched by the associated ion etching device (ion gun, voltage: 2 kV, current 20 mA) of “ESCA-3400”, the photoelectron spectra of a lower layer at a depth corresponding to 80% of the thickness of the low refractive index from the surface were measured, and the intensity ratio Si₂ₚ/C₁ₛ was calculated. This value is defined as Si(b).

A preliminary test of gradually shaving down the low refractive index layer surface under various etching conditions was performed in advance and based on the etching conditions necessary for reaching a deeper portion, the condition of giving a depth of 80% from the surface was determined and the spectra were measured.

The Si₍ₐ₎/Si_{(b)} value was calculated and the surface segregation degree of silicon atom was evaluated. A larger value reveals that a greater amount of silicone is present on the surface.

### (Evaluation 3) Surface Free Energy

The contact angles with pure water and methylene iodide were measured under the conditions of 25° C. and 60% after moisture conditioning of the antireflection film for 1 hour, and the surface free energy was calculated.

### (Evaluation 4) Marker Wipability

A pre-rubbing test was performed by using a rubbing tester under the following conditions.

Environmental conditions of evaluation: 25° C. and 60% RH

### Rubbing Material:

“Bencot” (trade name) {produced by Asahi Kasei Corp.} was wound around a rubbing tip (1 cm×1 cm) of a tester coming into contact with the sample and fixed by a band to resist movement. The “Bencot” was impregnated with 3 mL of isopropyl alcohol and rubbed back and forth under the following conditions.

Moving distance (one way): 13 cm
Rubbing speed: 13 cm/sec
Load: 500 g/cm²
Contact area of tip: 1 cm×1 cm
Number of rubbings: 30 reciprocations

After the pre-rubbing test, a circle with a diameter of 5 mm was written on the film in three turns with a pen tip (fine) of a black marker, “Macky Gokuboso” (trade name) {produced by ZEBRA Co.}, under the conditions of 25° C. and 60% RH and after 5 seconds, wiped off with a 10-ply folded and bundled “Bencot” (trade name) {produced by Asahi Kasei Corp.} by moving back and forth the bundle 20 times under a load enough to put a dent on the “Bencot” bundle. The writing and wiping were repeated under the above-described conditions until the marker stain could not be eliminated by the wiping. The number of repetitions where the marker stain could be wiped off was determined. This test was repeated four times and the average of these tests was rated on the following 5-stage scale.

⊚: Could be wiped off 15 times or more

◯: Could be wiped off from 10 times to less than 15 times.

ΔA Could be wiped off from several times to less than 10 times.

X: Could be wiped off once.

XX: Could not be wiped off even once.

### (Evaluation 5) Evaluation of Scratch Resistance

A rubbing test was performed by using a rubbing tester under the following conditions.

Environmental conditions of evaluation: 25° C. and 60% RH

### Rubbing Material:

A steel wool (No. 0000, manufactured by Nippon Steel Wool K.K.) was wound around the rubbing tip (1 cm×1 cm) of the tester coming into contact with the sample and fixed by a band to resist movement. Thereafter, the steel wool was rubbed back and force under the following conditions.

Moving distance (one way): 13 cm
Rubbing rate: 13 cm/sec
Load: 500 g/cm²
Contact area of tip: 1 cm×1 cm
Number of rubbings: 10 reciprocations

An oily black ink was painted on the back side of the rubbed sample and observed by the reflected light with an eye, and the abrasion on the rubbed portion was evaluated according to the following criteria.

◯: Scratches were not observed at all even by very careful observation.

◯ΔFaint scratches were slightly observed by very careful observation.

Δ: Faint scratches were observed.

ΔX: Scratches of medium degree were observed.

X: Scratches were observed at the first glance.

The evaluation results are shown in Table 14.

TABLE 14

| | Antireflection Film | | | | | | | | | |
|---|---|---|---|---|---|---|---|---|---|---|
| | | | | | | Evaluation of Antireflection Film | | | | |
| | | Low Refractive Index Layer | | | | | | Surface | | |
| | | | Processing Conditions | | | | | Free | | |
| | Sample | | Pre-Heat | | After-Heat | Reflectance | | Energy | Marker | Scratch |
| | No. | No. | Treatment | UV Curing | Treatment | (%) | Si₍ₐ₎/Si_{(b)} | (mN/m) | Wipability | Resistance |
| Example 1-1 | 101 | LL1-1 | 95° C.-5 min | 90° C.-1 min | 30° C.-5 min | 1.99 | 8.0 | 21 | ⊚ | ◯ |
| Example 1-2 | 102 | LL1-2 | 30° C.-5 min | 90° C.-1 min | 30° C.-5 min | 1.99 | 5.5 | 25 | ◯ | ◯ |
| Example 1-3 | 103 | LL1-3 | 130° C.-5 min | 90° C.-1 min | 30° C.-5 min | 1.99 | 7.0 | 22 | ⊚ | ◯Δ |
| Comparative | 104 | LL1-4 | 210° C.-5 min | 90° C.-1 min | 30° C.-5 min | 2.20 | 3.0 | 30 | XX | X |
| Example 1-1 | | | | | | | | | | |
| Comparative | 105 | LL1-5 | 30° C.-5 min | 18° C.-1 min | 30° C.-5 min | 1.99 | 3.5 | 27 | Δ | Δ |
| Example 1-2 | | | | | | | | | | |
| Comparative | 106 | LL1-6 | 30° C.-5 min | 210° C.-1 min | 30° C.-5 min | 2.05 | 3.5 | 27 | Δ | Δ |
| Example 1-3 | | | | | | | | | | |
| Example 1-4 | 107 | LL1-7 | 30° C.-5 min | 90° C.-1 min | 95° C.-5 min | 1.99 | 5.8 | 24 | ◯ | ◯ |
| Example 1-5 | 108 | LL1-8 | 30° C.-5 min | 90° C.-1 min | 130° C.-5 min | 1.99 | 6.0 | 23 | ⊚ | ◯ |
| Comparative | 109 | LL1-9 | 30° C.-5 min | 90° C.-1 min | 210° C.-5 min | 2.05 | 4.5 | 26 | X | Δ |
| Example 1-4 | | | | | | | | | | |

The results shown in Table 14 reveal the followings.

In Samples 101 to 103 and 107 to 108 where the Si₍ₐ₎/Si_{(b)} value is within the range of the present invention, desired results are satisfactorily obtained with respect to both the marker wipability and the scratch resistance. Also, in Samples 101 and 103 where the heat treatment before irradiation is performed before the UV curing, the Si(a/Si(b) value becomes large as compared with Sample 102 and the marker wipability is improved. Furthermore, in Samples 107 and 108 where the heat treatment after irradiation is performed after the UV curing, the same effect is obtained, though the effect is smaller than that in the case of heat treatment before irradiation.

### Examples 2-1 to 2-9 and Comparative Example 2-1

### Preparation of Silica Liquid Dispersion A

28 Parts of acryloyloxypropyltrimethoxysilane “KBM-5103” {produced by Shin-Etsu Chemical Co., Ltd.}, 2 parts of tridecafluorooctyltrimethoxysilane {produced by GE Toshiba Silicones Co., Ltd.} and 1.5 parts of diisopropoxyaluminum ethyl acetate were added and mixed to 500 parts of a hollow silica fine particle sol (isopropyl alcohol silica sol, produced according to Preparation Example 4 of JP-A-2002-79616 by changing the size, average particle diameter: 40 nm, shell thickness: 6 nm, silica concentration: 20 mass %, refractive index of silica particle: 1.30) and after adding thereto 9 parts of ion-exchanged water, the mixture was allowed to react at 60° C. for 8 hours. Thereafter, the reaction mixture was cooled to room temperature and 1.8 parts of acetylacetone was added thereto. While adding cyclohexanone to 500 g of the obtained liquid dispersion to keep constant the silica content, the solvent was displaced by reduced-pressure distillation at a pressure of 20 kPa. No foreign matter was generated in the liquid dispersion and the viscosity when the solid content concentration was adjusted to 25% with cyclohexanone was 10 mPa·s. The amount of residual isopropyl alcohol in Liquid Dispersion A obtained was analyzed by gas chromatography and found to be 1.0%.

### [Preparation of Coating Solutions (LLL-2) to (LLL-11) for Low Refractive Index Layer]

Coating Solutions (LLL-2) to (LLL-11) for Low Refractive Index Layer were prepared in the same manner as Coating Solution (LLL-1) for Low Refractive Index Layer except that in the preparation of (LLL-1), the composition was changed as shown in Table 15 below.

TABLE 15

| Coating Solution for Low Refractive Index Layer | | | | | | | | | | |
|---|---|---|---|---|---|---|---|---|---|---|
| | Fluorine-Containing | | Photopolymerizable | | | | Photopolymerization | | | |
| | Polysiloxane Polymer | | Polysiloxane | | | | Initiator | | Fine Particle | |
| | | Amount | | Amount | DPHA | Sol a | | Amount | | Amount |
| No. | Kind | (parts) | Kind | (parts) | (parts) | (parts) | Kind | (parts) | Kind | (parts) |

| | | | | | | | | | | | |
|---|---|---|---|---|---|---|---|---|---|---|---|
| Invention | LLL-1 | P-3* | 87 | — | — | 5 | 5 | OXE01* | 3 | — | — |
| Invention | LLL-2 | PP-5* | 87 | — | — | 5 | 5 | OXE01* | 3 | — | — |
| Comparison | LLL-3 | Poym 1* | 87 | — | — | 5 | 5 | OXE01* | 3 | — | — |
| Invention | LLL-4 | Poym 1* | 85 | RMS33* | 2 | 5 | 5 | OXE01* | 3 | — | — |
| Invention | LLL-5 | P-3* | 48 | RMS33* | 1 | 5 | 14 | OXE01* | 2 | MEK-ST* | 30 |
| Invention | LLL-6 | P-3* | 49 | RMS33* | 1 | 5 | 14 | OXE01* | 2 | MEK-ST-L* | 30 |
| Invention | LLL-7 | P-3* | 49 | RMS33* | 1 | 5 | 5 | OXE01* | 2 | Liquid | 39 |
| | | | | | | | | | | Dispersion | |
| | | | | | | | | | | A* | |
| Invention | LLL-8 | P-3* | 49 | RMS33* | 1 | 5 | 5 | 184* | 2 | Liquid | 39 |
| | | | | | | | | | | Dispersion | |
| | | | | | | | | | | A* | |
| Invention | LLL-9 | P-3* | 49 | RMS33* | 1 | 5 | 5 | 907* | 2 | Liquid | 39 |
| | | | | | | | | | | Dispersion | |
| | | | | | | | | | | A* | |
| Invention | LLL-10 | P-3* | 49 | RMS33* | 1 | 5 | 5 | 369* | 2 | Liquid | 39 |
| | | | | | | | | | | Dispersion | |
| | | | | | | | | | | A* | |
| Invention | LLL-11 | P-3* | 49 | RMS33* | 1 | 5 | 5 | KIP* | 2 | Liquid | 39 |
| | | | | | | | | | | Dispersion | |
| | | | | | | | | | | A* | |

The contents of the compounds used in Table 15 are shown below. In the Table, the “parts” indicates “parts by mass of the solid content” in all cases.

### Fluorine-Containing Siloxane Polymer:

P-3*: Compound P-3.

PP-5*: Compound PP-5.

Polym 1*: Fluorine-Containing Copolymer P-3 described in JP-A-2004-45462 differing from P-3 of the present invention in not containing a silicone moiety.

### Polymerizable Silicone:

RMS33*: “RMS-33”, produced by Gelest.

DPHA: “DPHA” as a photopolymerizable compound; a mixture of pentaerythritol triacrylate and pentaerythritol tetraacrylate, produced by Nippon Kayaku Co., Ltd.

### Photopolymerization Initiator:

OXE01*: “Irgacure OXE01”, produced by Ciba Specialty Chemicals Corp., molecular weight: 451.

184*: “Irgacure 184”, produced by Ciba Specialty Chemicals Corp., molecular weight: 204.

907*: “Irgacure 907”, produced by Ciba Specialty Chemicals Corp., molecular weight: 279.

369*: “Irgacure 369”, produced by Ciba Specialty Chemicals Corp., molecular weight: 367.

KIP*: “Esacure KIP150”, produced by Fratelli Lamberti; oligo(2-hydroxy-2-methyl-1-(4-(1-methylvinyl)phenyl)propane), n=from 4 to 6, average molecular weight: about 1,000.

MEK-ST*: “MEK-ST”, produced by Nissan Chemicals Industries, Ltd.; a dispersion of fine silica particle, solvent: methyl ethyl ketone (MEK), average particle size: 15 nm.

MEK-ST-L*: “MEK-ST-L”, produced by Nissan Chemicals Industries, Ltd.; a dispersion of fine silica particle, solvent: NEK, average particle size: 45 nm.

### Liquid Dispersion A:

Silica Liquid Dispersion A.

### [Production of Antireflection Films (201) to (210)]

On Hard Coat Layer (HC-1) obtained in the same manner as in Example 1-1, Low refractive Index Layers (LL2-1) to (LL11-1) each was formed by coating and curing each of Coating Solutions (LLL-2) to (LLL-11) for Low Refractive Index Layer under the same conditions as in Antireflection Film Sample (101) of Example 1-1 and then subjected to a saponification treatment in the same manner as in Example 1-1 to produce Antireflection Film Samples (201) to (210). Evaluations of the obtained antireflection film samples were performed according to Example 1. The layer construction and evaluation results obtained of each antireflection film sample are shown in Table 16.

TABLE 16

| | Antireflection Film | | | | | | | |
|---|---|---|---|---|---|---|---|---|
| | | Layer Construction | | Evaluation of Antireflection Film | | | | |
| | Sample | Hard Coat | Low Refractive | | | Surface Free | Marker | Scratch |
| | No. | Layer No. | Index Layer No. | Reflectance (%) | Si₍ₐ₎/Si_{(b)} | Energy (mN/m) | Wipability | Resistance |
| Example 1-1 | 101 | HC-1 | LL1-1 | 1.99 | 8.0 | 21 | ⊚ | ◯ |
| Example 2-1 | 201 | HC-1 | LL2-1 | 2.00 | 8.1 | 21 | ⊚ | ◯ |
| Comparative | 202 | HC-1 | LL3-1 | 2.00 | — | 38 | XX | ◯Δ |
| Example 2-1 | | | | | | | | |
| Example 2-2 | 203 | HC-1 | LL4-1 | 1.99 | 8.0 | 26 | Δ | ◯Δ |
| Example 2-3 | 204 | HC-1 | LL5-1 | 2.04 | 5.0 | 24 | ◯ | ◯ |
| Example 2-4 | 205 | HC-1 | LL6-1 | 2.04 | 7.0 | 22 | ⊚ | ◯ |
| Example 2-5 | 206 | HC-1 | LL7-1 | 1.61 | 7.0 | 22 | ⊚ | ◯ |
| Example 2-6 | 207 | HC-1 | LL8-1 | 1.61 | 5.5 | 25 | Δ | Δ |
| Example 2-7 | 208 | HC-1 | LL9-1 | 1.61 | 5.0 | 24 | Δ | ◯ |
| Example 2-8 | 209 | HC-1 | LL10-1 | 1.61 | 7.0 | 22 | ⊚ | ◯ |
| Example 2-9 | 210 | HC-1 | LL11-1 | 1.61 | 7.0 | 22 | ⊚ | ◯ |

The results shown in Table 16 reveal the followings.

When the polymer for use in the present invention containing a polysiloxane in the polymer body, the Si₍ₐ₎/Si_{(b)} of sample becomes large and the marker wipability and scratch resistance are improved. Also by using a hollow fine particle, the refractive index can be reduced while maintaining the scratch resistance-marker wipability. Furthermore, when a photopolymerization initiator satisfying the molecular weight range of the present invention is used, the marker wipability and scratch resistance are improved.

### Example 3-1

A multilayer antireflection film described below was produced.

### [Preparation of Coating Solution (HCL-2) for Hard Coat Layer]

The following composition was charged into a mixing tank and stirred to prepare a coating solution for hard coat layer. 270.0 parts of poly(glycidyl methacrylate) having a mass average molecular weight or 15,000, 730.0 parts of methyl ethyl ketone, 500.0 parts of cyclohexanone, 25.0 parts by mass of a photo-cationic polymerization initiator (Rhodosil 2074), 50.0 parts of photopolymerization initiator “Irgacure 184” {produced by Ciba Specialty Chemicals Corp.} and 1.0 part of a surface state improving agent {Compound (F-63)} were added to and mixed with 750.0 parts of trimethylolpropane triacrylate “TMPTA” {produced by Nippon Kayaku Co., Ltd.}. The resulting mixed solution was filtered through a polypropylene-made filter having a pore size of 0.4 μm to prepare Coating Solution (HCL-2) for Hard Coat Layer.

### [Preparation of Liquid Dispersion of Titanium Dioxide Fine Particle]

The titanium dioxide fine particle used was titanium dioxide fine particle “MPT-129C” {produced by Ishihara Sangyo Kaisha, Ltd.; TiO₂:CO₃O₄:Al₂O₃:ZrO₂=90.5:3.0:4.0:0.5 (by mass)} containing cobalt and being surface-treated by using aluminum hydroxide and zirconium hydroxide

41.1 Parts of a dispersant shown below (Chem. 11) and 701.8 parts of cyclohexanone were added to 257.1 parts of the particle above, and these were dispersed in a Dyno mill to prepare a liquid dispersion of titanium dioxide having a mass average diameter of 70 nm.

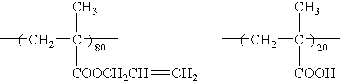

### [Preparation of Coating Solution (MLL-1) for Medium Refractive Index Layer]

68.0 Parts of a dipentaerythritol pentaacrylate/dipentaerythritol hexaacrylate mixture “DPHA” {produced by Nippon Kayaku Co., Ltd.}, 3.6 parts of photopolymerization initiator “Irgacure 907” {produced by Ciba Specialty Chemicals Corp.}, 1.2 parts of photosensitizer “Kayacure DETX” {produced by Nippon Kayaku Co., Ltd.}, 279.6 parts of methyl ethyl ketone and 1,049.0 parts of cyclohexanone were added to 99.1 parts of the liquid dispersion of titanium dioxide prepared above and after well stirring, the resulting solution was filtered through a polypropylene-made filter having a pore size of 0.4 μm to prepare Coating Solution (MLL-1) for Medium Refractive Index Layer.

### [Preparation of Coating Solution (HLL-1) for High Refractive Index Layer]

40.0 Parts of a dipentaerythritol pentaacrylate/dipentaerythritol hexaacrylate mixture “DPHA” {produced by Nippon Kayaku Co., Ltd.}, 3.3 parts of photopolymerization initiator “Irgacure 907” {produced by Ciba Specialty Chemicals Corp.}, 1.1 parts of photosensitizer “Kayacure DETX” {produced by Nippon Kayaku Co., Ltd.}, 526.2 parts of methyl ethyl ketone and 459.6 parts of cyclohexanone were added to 469.8 parts the liquid dispersion of titanium dioxide prepared above and after stirring, the resulting solution was filtered through a polypropylene-made filter having a pore size of 0.4 μm to prepare Coating Solution (HLL-1) for High Refractive Index Layer.

### [Production of Antireflection Film (301)]

Coating Solution (HCL-2) for Hard Coat Layer was coated on a 80 μm-thick triacetyl cellulose film “TAC-TD80UF” {produced by Fuji Photo Film Co., Ltd.} by using a gravure coater and after drying at 100° C., irradiated with an ultraviolet ray at an illumination intensity of 400 mW/cm² and an irradiation dose of 300 mJ/cm² by using “Air-Cooled Metal Halide Lamp” {manufactured by Eyegraphics Co., Ltd.} of 160 W/cm under nitrogen purging to give an atmosphere having an oxygen concentration or 1.0 vol % or less, thereby curing the coated layer to form Hard Coat Layer (HC-2).

Subsequently, Coating Solution (MLL-1) for Medium Refractive Index Layer, Coating Solution (HLL-1) for High Refractive Index Layer and Coating Solution (LLL-1) for Low Refractive Index Layer were continuously coated on Hard Coat Layer (HC-2) by using a gravure coater having three coating stations.

The drying conditions of the medium refractive index layer were 90° C. and 30 seconds, and the ultraviolet curing conditions were an illumination intensity of 400 mW/cm² and an irradiation dose of 400 mJ/cm² by using “Air-Cooled Metal Halide Lamp” {manufactured by Eyegraphics Co., Ltd.} of 180 W/cm under nitrogen purging to give an atmosphere having an oxygen concentration or 1.0 vol % or less. The refractive index of Medium Refractive Index Layer (ML-1) after curing was 1.630 and the film thickness thereof was 67 nm.

The drying conditions of the high refractive index layer were 90° C. and 30 seconds, and the ultraviolet curing conditions were an illumination intensity of 600 mW/cm² and an irradiation dose of 400 mJ/cm² by using “Air-Cooled Metal Halide Lamp” {manufactured by Eyegraphics Co., Ltd.} of 240 W/cm under nitrogen purging to give an atmosphere having an oxygen concentration or 1.0 vol % or less. The refractive index of High Refractive Index Layer (FL-1) after curing was 1.905 and the film thickness thereof was 107 nm.

The curing conditions of the low refractive index layer are shown below.

(1) Drying: 80° C.-120 seconds

(2) Heat treatment before irradiation: 95° C.-5 minutes

(3) UV Curing:

90° C.-1 minute, an illumination intensity of 600 mW/cm² and an irradiation dose of 600 mJ/cm² by using Air-Cooled Metal Halide Lamp (manufactured by Eyegraphics Co., Ltd.) of 240 W/cm under nitrogen purging to give an atmosphere having an oxygen concentration of 0.01 vol % or less

(4) Heat treatment after irradiation: 30° C.-5 minutes

The refractive index of Low Refractive Index Layer (LL1-10) after curing was 1.44 and the film thickness thereof was 85 nm.

### Examples 3-2 to 3-11

Low Refractive Index Layers (LL2-2) to (LL11-2) were formed in the same manner as in Example 3-1 except for using Coating Solutions (LLL-2) to (LLL-11) for Low Refractive Index Layer, respectively, in place of Coating Solution (LLL-1) for Low Refractive Index Layer in Example 3-1, whereby Antireflection Film Samples (302) to (311) were produced. The layer constructions of antireflection film samples obtained are shown together in Table 17 below.

TABLE 17

| | Antireflection Film | | | | |
|---|---|---|---|---|---|
| | | Layer Construction | | | |
| | | | Medium | High | Low |
| | | | Refractive | Refractive | Refractive |
| | Sample | Hard Coat | Index | Index | Index |
| | No. | Layer No. | Layer No. | Layer No. | Layer No. |
| Example 3-1 | 301 | HC-2 | ML-1 | HL-1 | LL1-10 |
| Example 3-2 | 302 | HC-2 | ML-1 | HL-1 | LL2-2 |
| Comparative | 303 | HC-2 | ML-1 | HL-1 | LL3-2 |
| Example 3-1 | | | | | |
| Example 3-3 | 304 | HC-2 | ML-1 | HL-1 | LL4-2 |
| Example 3-4 | 305 | HC-2 | ML-1 | HL-1 | LL5-2 |
| Example 3-5 | 306 | HC-2 | ML-1 | HL-1 | LL6-2 |
| Example 3-6 | 307 | HC-2 | ML-1 | HL-1 | LL7-2 |
| Example 3-7 | 308 | HC-2 | ML-1 | HL-1 | LL8-2 |
| Example 3-8 | 309 | HC-2 | ML-1 | HL-1 | LL9-2 |
| Example 3-9 | 310 | HC-2 | ML-1 | HL-1 | LL10-2 |
| Example 3-10 | 311 | HC-2 | ML-1 | HL-1 | LL11-2 |

Evaluations of Antireflection Film Samples (301) to (311) obtained were performed according to Example 1, as a result, when a medium refractive index layer and a high refractive index layer were provided, the reflectance was greatly decreased in all samples. Also, in Samples (301) to (311) where the curing conditions were the same as those in Example 1-1, almost the same Si₍ₐ₎/Si_{(b)} as that of the corresponding sample in Table 16 was obtained. It was found that according to the present invention, an antireflection film assured of low reflectance and excellent in the marker wipability scratch resistance can be obtained.

### Example 4

### Preparation of Coating Solution (HCL-3) for Hard Coat Layer

100 Parts of “Desolite Z-7404” {zirconia fine particle-containing hard coat composition, produced by JSR Corp.}, 31 parts of “DPHA” {UV-Curable resin, produced by Nippon Kayaku Co., Ltd.}, 10 parts of “KBM-5103” {silane coupling agent, produced by Shin-Etsu Chemical Co., Ltd.}, 8.9 parts of “KE-P150” {1.5-μm silica particle, produced by Nippon Shokubai Co., Ltd.}, 3.4 parts of “MXS-300” {3-μm crosslinked PMMA particle, produced by The Soken Chemical & Engineering Co., Ltd.}, 29 parts of MEK, 13 parts of MIBK and 0.05 parts of a surface state improving agent {Compound (F-63)} were charged into a mixing tank and stirred to prepare Coating Solution (HCL-3) for Hard Coat Layer.

### [Production of Antireflection Film (401)]

A triacetyl cellulose film “TAC-TD80U” {produced by Fuji Photo Film Co., Ltd.} in a roll form was unrolled as the support, and Coating Solution (HCL-3) for Hard Coat Layer was coated thereon by using a doctor blade and a microgravure roll having a diameter of 50 mm and having a gravure pattern with a line number of 135 lines/inch and a depth of 60 μm under the conditions such that the transportation speed was 10 m/min, and after drying at 60° C. for 150 seconds, irradiated with an ultraviolet ray at an illumination intensity of 400 mW/cm² and an irradiation dose of 250 mJ/cm² by using “Air-Cooled Metal Halide Lamp” (manufactured by Eyegraphics Co., Ltd.) of 160 W/cm under nitrogen purging, thereby curing the coated layer to form Hard Coat Layer (HC-3). The resulting film was taken up. The rotation number of the gravure roll was controlled so that the coated layer after curing could have a thickness of 4.0 μm. As for the surface roughness of Hard Coat Layer (HC-3) thus obtained, the centerline average roughness (Ra) was 0.02 μm, the root-mean-square roughness (RMS) was 0.03 μm, and the n-point average roughness (Rz) was 0.25 um. Here, Ra, RMS and Rz each was measured by a scanning probe microscope system, “SPI3800” {manufactured by Seiko Instruments Inc.}.

Low Refractive Index Layer (LL1-11) was provided on Hard Coat Layer (HC-3) under the same conditions as in Example 1-1 by using Coating Solution (LLL-1) for Low Refractive Index Layer used in Example 1-1, thereby producing Antireflection Film Sample (401).

### [Saponification Treatment of Antireflection Film]

Antireflection Film Sample (401) obtained as above was then subjected to the following saponification treatment.

An aqueous 1.5 mol/liter sodium hydroxide solution was prepared and kept at 55° C. Separately, an aqueous 0.005 mol/liter dilute sulfuric acid solution was prepared and kept at 35° C.

Antireflection Film Sample (401) produced was dipped in the aqueous sodium hydroxide solution for 2 minutes and then dipped in water to thoroughly wash out the aqueous sodium hydroxide solution. Subsequently, the sample was dipped in the aqueous dilute sulfuric acid solution for 1 minute and then dipped in water to thoroughly wash out the aqueous dilute sulfuric acid solution. Finally, the sample was thoroughly dried at 120° C. In this way, a saponified antireflection film was produced.

### Example 14

### Production of Polarizing Plate with Antireflection Film

A polarizing film was produced by adsorbing iodine to a stretched polyvinyl alcohol film. Antireflection Film Sample (401) after saponification was laminated on one side of the polarizing film by using a polyvinyl alcohol-based adhesive such that the support side (triacetyl cellulose) of the antireflection film came to the polarizing film side. Also, a viewing angle enlarging film, “Wide View Film SA” {produced by Fuji Photo Film Co., Ltd.}, having an optically anisotropic layer in which the disc plane of the discotic structural unit is inclined with respect to the support plane and the angle made by the disc plane of the discotic structural unit and the support plane is changed in the depth direction of the optically anisotropic layer, was subjected to a saponification treatment and then laminated on the other side of the polarizing film by using a polyvinyl alcohol-based adhesive. In this way, Polarizing Plate (401P) with Antireflection Film was produced.

Evaluations of Polarizing Plate (401P) with Antireflection Film were performed according to Example 1, as a result, the polarizing plate with antireflection film obtained was found to ensure low reflection and be excellent in the marker wipability and scratch resistance.

### Example 5

### Preparation of Coating Solution (HCL-4) for Hard Coat Layer

10 Parts of cyclohexanone, 85 parts of partially caprolactone-modified polyfunctional acrylate “DPCA-20” {produced by Nippon Kayaku Co., Ltd.}, 10 parts of “KBM-5103” {silane coupling agent, produced by Shin-Etsu Chemical Co., Ltd.}, 5 parts of photopolymerization initiator “Irgacure 184” {produced by Ciba Specialty Chemicals Corp.}, and 0.04 parts of surface state improving agent{Compound (F-63)} were added to 90 parts of MEK and after stirring, the resulting solution was filtered through a polypropylene-made filter having a pore size of 0.4 μm to prepare Coating Solution (HCL-4) for Hard Coat Layer.

### [Production/Evaluation of Antireflection Film]

Coating Solution (HCL-4) for Hard Coat Layer was coated and cured on a triacetyl cellulose film “TAC-TD80U” {produced by Fuji Photo Film Co., Ltd.} as the support according to Example 3-1. At this time, the rotation number of the gravure roll was controlled so that Hard Coat Layer (HC-4) after curing could have a thickness of 4.5 μm.

Low Refractive Index Layer (LL1-12) was provided on Hard Coat Layer (HC-4) under the same conditions as in Example 1-1 by using Coating Solution (LLL-1) for Low Refractive Index Layer used in Example 1-1, thereby producing Antireflection Film Sample (501). Subsequently, Antireflection Film Sample (501) was subjected to a saponification treatment.

Evaluations of Antireflection Film Sample (501) obtained were performed according to Example 1, as a result, the antireflection film obtained was found to ensure low reflection and be excellent in the marker wipability and scratch resistance.

### Example 6

### Preparation of Coating Solution (LLL-12) for Low Refractive Index Layer

48.0 Parts of a fluorine-containing siloxane polymer {Compound (P-23) (mass average molecular weight: 50,000)}, 17.2 parts (5 parts as the solid content) of Sol Solution a, 5.0 parts of a polyfunctional epoxy compound {Compound (A-1)}, 2 parts of photoradical generator “Irgacure 369” {produced by Ciba Specialty Chemicals Corp.} and 1 part of photo-cationic polymerization initiator “UVI-6990 {produced by Union Carbide Japan} were dissolved in 200 parts of methyl ethyl ketone. Furthermore, 150 parts of Silica Liquid Dispersion A (liquid dispersion of surface-treated hollow silica, solid content concentration: 26%) prepared in Example 2 was added. The resulting solution was diluted with cyclohexanone and methyl ethyl ketone so that the entire coating solution could finally have a solid content concentration of 6% and the ratio of cyclohexane to methyl ethyl ketone could be 20/80. In this way, Coating Solution (LLL-12) for Low Refractive Index Layer was prepared.

### Preparation of Coating Solution (LLL-13) for Low Refractive Index Layer

47.0 Parts of a fluorine-containing siloxane polymer {Compound (PP-36) (mass average molecular weight: 35,000)}, 17.2 parts (5 parts as the solid content) of Sol Solution a, 5.0 parts of a polyfunctional epoxy compound {Compound (A-1)}, epoxy-modified dimethylsiloxane compound “X22-163C” {produced by Shin-Etsu Chemical Co., Ltd.}, 1.5 parts of photoradical generator “Irgacure 369” {produced by Ciba Specialty Chemicals Corp.} and 1.5 part of photo-cationic polymerization initiator “UVI-6990 {produced by Union Carbide Japan} were dissolved in 200 parts of methyl ethyl ketone. Furthermore, 150 parts of Silica Liquid Dispersion A (liquid dispersion of surface-treated hollow silica, solid content concentration: 26%) prepared in Example 2 was added. The resulting solution was diluted with cyclohexanone and methyl ethyl ketone so that the entire coating solution could finally have a solid content concentration of 6% and the ratio of cyclohexane to methyl ethyl ketone could be 20/80. In this way, Coating Solution (LLL-13) for Low Refractive Index Layer was prepared.

### [Production of Antireflection Films (601) to (605)]

On Hard Coat Layer (HC-1) produced in the same manner as in Example 1-1, Coating Solutions (LLL-12) and (LLL-13) each was coated and cured by employing the layer construction and curing conditions shown in Table 18 under control to give a low refractive index layer thickness of 95 nm. Here, pre-heat treatment is conducted by purging with nitrogen so that the oxygen concentration becomes 0.1% or less. As for the coating speed and UV irradiation dose, the coating and curing were performed according to the formation of Low Refractive Index Layer (LL1-1) of Example 1. The thus-obtained films each was subjected to a saponification treatment in the same manner as in Example 1-1 to produce Antireflection Film Samples (601) and (605). Evaluations of the obtained antireflection film samples were performed in the same manner as in Example 1. The layer construction and evaluation results obtained of each antireflection film sample are shown in Table 18.

TABLE 18

| | Antireflection Film | | | | | | | | | |
|---|---|---|---|---|---|---|---|---|---|---|
| | | | | | | Evaluation of Antireflection Film | | | | |
| | | Low Refractive Index Layer | | | | | | Surface | | |
| | | | Processing Conditions | | | | | Free | | |
| | Sample | | Pre-Heat | | After-Heat | Reflectance | | Energy | Marker | Scratch |
| | No. | No. | Treatment | UV Curing | Treatment | (%) | Si₍ₐ₎/Si_{(b)} | (mN/m) | Wipability | Resistance |
| Example 6-1 | 601 | LL12-1 | 30° C.-5 min | 90° C.-1 min | 30° C.-5 min | 1.62 | 5.5 | 25 | ◯ | ◯Δ |
| Example 6-2 | 602 | LL12-2 | 95° C.-5 min | 90° C.-1 min | 30° C.-5 min | 1.62 | 7.8 | 22 | ⊚ | ◯ |
| Example 6-3 | 603 | LL12-3 | 95° C.-5 min | 90° C.-1 min | 95° C.-5 min | 1.62 | 8.1 | 21 | ⊚ | ◯ |
| Comparative | 604 | LL12-4 | 30° C.-5 min | 18° C.-1 min | 30° C.-5 min | 1.62 | 3.4 | 29 | XX | X |
| Example 6-1 | | | | | | | | | | |
| Example 6-4 | 605 | LL13-1 | 95° C.-5 min | 90° C.-1 min | 95° C.-5 min | 1.62 | 7.8 | 22 | ⊚ | ◯ |

As seen from the results in Table 18, even when a photo-cationic polymerization-type compound was used, a large Si(a/Si(b) value was obtained by virtue of heating before and after UV irradiation and the improvement effect was achieved on both marker wipability and scratch resistance.

### INDUSTRIAL APPLICABILITY

The antireflection film of the present invention is producible in a high productivity and inexpensively and assured of satisfactory antireflection performance, scratch resistance and antifouling property. Also, according to the present invention, a method for producing an antireflection film satisfying the above-described performances is provided.

Furthermore, a polarizing plate comprising the antireflection film of the present invention is provided. The image display device of the present invention comprising such an antireflection film or polarizing plate is assured of excellent visibility as well as excellent scratch resistance and antifouling property by virtue of disposing the antireflection film on the outermost surface.

The entire disclosure of each and every foreign patent application from which the benefit of foreign priority has been claimed in the present application is incorporated herein by reference, as if fully set forth.

1. An antireflection film comprising:
a support; and
at least one low refractive index layer including a first low refractive index layer, the first low refractive index layer being located most distant from the support,
wherein the first low refractive index layer comprises: a resin curable upon irradiation with ionizing radiation; and a compound having a polysiloxane partial structure, and
wherein the ratio Si₍ₐ₎/Si_{(b)} of a photoelectron spectral intensity {Si₍ₐ₎} of silicon atom on the outermost surface of the first low refractive index layer to a photoelectron spectral intensity {Si_{(b)}} of silicon atom in a deeper position at a depth corresponding to 80% of a thickness of the first low refractive index layer from the outermost surface is 5.0 or more.

2. The antireflection film as claimed in claim 1,
wherein the compound having a polysiloxane partial structure is represented by formula (1): 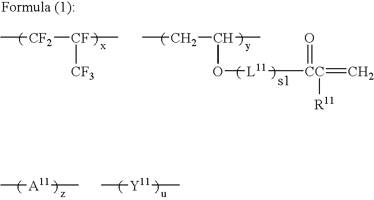
{wherein L¹¹ represents a linking group having a carbon number of 1 to 10, s1 represents 0 or 1, R¹¹ represents a hydrogen atom or a methyl group, A¹¹ represents a repeating unit having a hydroxyl group in its side chain, Y¹¹ represents a constituent component containing a polysiloxane structure in its main chain, x, y and z each represents mol % of respective repeating units based on all repeating units excluding Y¹¹ and each represents a value satisfying 30≦x≦60, 0≦y≦70 and 0≦z≦50, provided that x+y+z=100 (mol %), and u represents mass % of the constituent component Y¹¹ in the copolymer and satisfies 0.01≦u≦20}.

3. The antireflection film as claimed in claim 1,
wherein the compound having a polysiloxane partial structure is represented by formula (2): 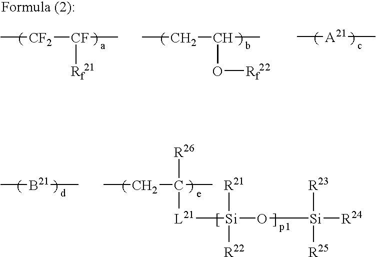
{wherein R_{f}²¹ represents a perfluoroalkyl group having a carbon number of 1 to 5, R_{f}²² represents a fluorine-containing alkyl group having a linear, branched or alicyclic structure having a carbon number of 1 to 30, which may have an ether bond, A²¹ represents a constituent unit having a reactive group capable of participating in a crosslinking reaction, B²¹ represents an arbitrary constituent component, R²¹ and R²², which may be the same or different, each represents an alkyl group or an aryl group, p1 represents an integer of 10 to 500, R²³ to R²⁵ each independently represents a substituted or unsubstituted monovalent organic group or a hydrogen atom, R²⁶ represents a hydrogen atom or a methyl group, L²¹ represents an arbitrary linking group having a carbon number of 1 to 20 or a singe bond, a to d each represents a molar fraction (%) of respective constituent components excluding the polymerization unit containing a polysiloxane and each represents a value satisfying 10≦a+b≦55, 10≦a≦55, 0≦b≦45, 10≦c≦50 and 0≦d≦40, and e represents a mass fraction (%) of the polymerization unit containing a polysiloxane based on the entire mass of other components and satisfies the relationship of 0.01≦e≦20}.

4. The antireflection film as claimed in any one of claim 1, which has a surface free energy on the outermost surface of 25 mN/m or less.

5. The antireflection film as claimed in claim 1, further comprising:
at least one layer lower than the first low refractive index layer,
wherein at least one of said at least one layer lower and the first low refractive index layer comprises at least one of a hydrolysate of an organosilane represented by formula (3) and a partial condensate thereof, the organosilane being produced in the presence of at least one of an acid catalyst and a metal chelate compound:
(R³⁰)ₘ₁Si(X³¹)₄₋ₘ₁ Formula (3)
(wherein R³⁰ represents a substituted or unsubstituted alkyl group or a substituted or unsubstituted aryl group, X³¹ represents a hydroxyl group or a hydrolyzable group, and m1 represents an integer of 1 to 3).

6. The antireflection film as claimed in claim 1,
wherein at least one of said at least low refractive index layer comprises an inorganic fine particle having a refractive index of 1.15 to 1.40.

7. The antireflection film as claimed in claim 1,
wherein at least one of said at least low refractive index layer comprises a photopolymerization initiator having a molecular weight of 250 or more.

8. The antireflection film as claimed in claim 1, further comprising
at least one thin film layer between the first low refractive index layer and the support,
wherein the thin film layer comprises a surface state improving agent.

9. A method for producing an antireflection film comprising a support and at least one low refractive index layer including a first low refractive index layer, the first low refractive index layer being located most distant from the support,
wherein the method comprises:
coating a coating composition for the first low refractive index layer comprising a resin curable upon irradiation with ionizing radiation and a compound having a polysiloxane partial structure or a fluoroalkyl group on a support directly or via at least one layer; and
curing the composition by combining irradiation of ionizing radiation and a heat treatment before, simultaneous with or after the irradiation so that the ratio Si₍ₐ₎/Si_{(b)} of a photoelectron spectral intensity {Si₍ₐ₎} of silicon atom on the outermost surface of the first low refractive index layer of the antireflection film to a photoelectron spectral intensity {Si_{(b)}} of silicon atom in a deeper portion at a depth corresponding to 80% of a thickness of the first low refractive index layer from the outermost surface can be 5.0 or more.

10. A polarizing plate comprising, on at least one side thereof, the antireflection film claimed in claim 1

11. An image display device comprising the antireflection film claimed in claim 1

12. A polarizing plate comprising, on at least one side thereof, the antireflection film obtained by the production method of an antireflection film claimed in claim 9.

13. An image display device comprising the antireflection film obtained by the production method of an antireflection film claimed in claim 9.

14. An image display device comprising the polarizing plate claimed in claim 10

15. An image display device comprising the polarizing plate claimed in claim 12.
